(19) United States
(12) Patent Application Publication
(10) Pub. No.: US 2025/0083142 A1
(43) Pub. Date: Mar. 13, 2025

(54) MULTIPLEXED NUCLEIC ACID AMPLIFICATION TEST ON SEMICONDUCTOR SUBSTRATE

(71) Applicant: TEXAS INSTRUMENTS INCORPORATED, Dallas, TX (US)

(72) Inventors: Sebastian MEIER, Muenchen (DE); Ernst MUELLNER, Muenchen (DE)

(21) Appl. No.: 18/428,825

(22) Filed: Jan. 31, 2024

Related U.S. Application Data
(60) Provisional application No. 63/581,388, filed on Sep. 8, 2023.

(51) Int. Cl. B01L 3/00; G01N 27/22

(52) U.S. Cl. CPC B01L 3/502715; G01N 27/227; B01L 2300/0645; B01L 2300/0663; B01L 2300/1805

(57) ABSTRACT

Example packaged integrated circuit (IC) sensors comprise a semiconductor substrate; a back end of line (BEOL) structure on the semiconductor substrate, the BEOL structure including multiple microfluidic channels, each microfluidic channel including a flow control device configured to selectively permit and restrict flow of fluids; multiple fluid sensors including first and second fluid sensors in the BEOL structure; a main reaction reservoir on the BEOL structure configured to store a reagent, in which the reagent is operable to replicate a nucleic strand in a biological sample to cause a pH change, and the first fluid sensor is exposed in the main reaction reservoir; an auxiliary reservoir on the BEOL structure and coupled to the main reaction reservoir via a microfluid channel of the multiple microfluidic channels, in which the second fluid sensor is exposed in the auxiliary reaction reservoir; and a controller coupled to the first and second fluid sensors.

### CROSS-REFERENCE TO RELATED APPLICATIONS

The present application claims priority to U.S. Provisional Patent Application No. 63/581,388, which was filed Sep. 8, 2023, is titled “MULTIPLEXED NUCLEIC ACID AMPLIFICATION TEST ON SILICON,” and is hereby incorporated herein by reference in its entirety.

### BACKGROUND

A fluid sensor can detect properties of a fluid by generating an electrical signal representing the presence of a specific substance, such as ions, in the fluid. The electrical signal can indicate the presence and/or quantity of the substance in the fluid. Fluid sensors can have various applications. For example, a fluid sensor can detect the activity of acidic ions (e.g., hydrogen ions) in a fluid to support a pH measurement of the fluid. As another example, a fluid sensor can detect changes in the concentration of particular ionic species to support detection or monitoring of a chemical reaction. As another example, electrochemical fluid sensors can measure electrical potentials, currents, and impedance of a fluid. Fluid sensors can support various chemical and biomedical analyses, such as mass spectrometry, electrophoresis, deoxyribonucleic acid (DNA) analysis, etc.

### SUMMARY

Example packaged integrated circuit (IC) sensors comprise a semiconductor substrate; a back end of line (BEOL) structure on the semiconductor substrate, the BEOL structure including multiple microfluidic channels, each microfluidic channel including a flow control device configured to selectively permit and restrict flow of fluids; multiple fluid sensors including first and second fluid sensors in the BEOL structure; a main reaction reservoir on the BEOL structure configured to store a reagent, in which the reagent is operable to replicate a nucleic strand in a biological sample to cause a pH change, and the first fluid sensor is exposed in the main reaction reservoir; an auxiliary reservoir on the BEOL structure and coupled to the main reaction reservoir via a microfluid channel of the multiple microfluidic channels, in which the second fluid sensor is exposed in the auxiliary reaction reservoir; and a controller coupled to the first and second fluid sensors.

In examples, a method comprises: providing a fluid containing a biological sample to a main reaction reservoir of a packaged integrated circuit (IC) sensor, the biological sample including a nucleic strand, and the main reaction reservoir stores a first reagent; allowing the fluid to flow from the main reaction reservoir to a first detection reservoir and a second detection reservoir of the packaged IC sensor, in which the first detection reservoir stores a second reagent to replicate nucleic strands of a first detection target, and the second detection reservoir stores a third reagent to replicate nucleic strands of a second detection target; replicating the nucleic strand in the main reaction reservoir using the first reagent; providing first and second portions of the replicated nucleic strands to the first and second detection reservoirs, respectively, by pumping; replicating the first portion of the replicated nucleic strands in the first detection reservoir using the second reagent; comparing pH levels of the first and second portions of the biological sample in the first and second detection reservoirs to a pH level of a reference reservoir of the packaged IC sensor; and based on the comparisons, determining whether the biological sample contains the first detection target.

### BRIEF DESCRIPTION OF THE DRAWINGS

FIG. 1 is a schematic of an example fluid analytic system.

FIG. 2A and FIG. 2B are schematics of an example fluid sensor.

FIG. 3A and FIG. 3B are schematics illustrating example interface circuits of a fluid sensor.

FIG. 4 is a schematic illustrating an example integrated circuit fluid sensor.

FIGS. 5A, 5B, 5C and 6 are schematics illustrating example mechanisms to provide fluid to the example fluid sensor of FIG. 4.

FIG. 7A and FIG. 7B include graphs representing example outputs of the fluid sensor of FIG. 4 in measuring a diffusion time.

FIG. 8 is a schematic illustrating a plan view of an example integrated circuit fluid sensor that supports diffusion time measurement of different fluids.

FIG. 9 includes graphs representing example outputs of the fluid sensor of FIG. 8.

FIG. 10 is a schematic illustrating an example fluid sensor including a reference electrode.

FIG. 11 is a schematic illustrating an example fluid sensor including an integrated electrode in a fluidic structure.

FIG. 12 is a schematic illustrating an example fluid sensor including an integrated electrode external to a fluidic structure.

FIG. 13 is a schematic illustrating an example fluid sensor to support differential sensing.

FIGS. 14A, 14B, and 14C are schematics illustrating example operations of the fluid sensor of FIG. 13 in performing differential sensing.

FIG. 15 includes graphs representing example outputs of the fluid sensor of FIG. 13.

FIGS. 16 and 17 are schematics illustrating example integrated circuit fluid sensors.

FIGS. 18A, 18B, 19A, and 19B are schematics illustrating example integrated circuit fluid sensors having a reservoir.

FIGS. 20A, 20B, and 20C are schematics illustrating example operations of the fluid sensor of FIG. 18.

FIG. 21 is a schematic illustrating an example fluid sensor including multiple sensor terminals in a fluid cavity.

FIG. 22 includes graphs representing example outputs of the fluid sensor of FIG. 21.

FIGS. 23 and 24 are schematics illustrating example fluid sensors including multiple sensor terminals in a fluid cavity.

FIGS. 25, 26A, 26B, 26C, 27, and 28 are schematics illustrating techniques to selectively restrict the flow of particles in a fluid cavity.

FIGS. 29, 30, 31A, 31B 31C, 31D, 31E, 31F, and 32 are schematics illustrating example fluid sensors including multiple openings extending to a fluid cavity.

FIGS. 33A, 33B, 33C, and 34 are schematics of a fluid sensor including a valve.

FIGS. 35, 36, 37, 38, 39, and 40 are schematics illustrating example valves that can be part of the fluid sensor of FIGS. 33 and 34 and their operations.

FIG. 41 is a schematic of an example fluid sensor configured as a mixer.

FIGS. 42A, 42B, and 42C are schematics illustrating example operations of fluid sensor of FIG. 41.

FIGS. 43A, 43B, 43C, 43D, 43E, and 43F are schematics of an example fluid sensor configured as a mixer.

FIG. 44 includes schematics of example fluid sensors to measure liquid junction potential.

FIGS. 45A and 45B are schematics of example fluid sensors to reduce liquid junction potentials in the fluid measurement.

FIGS. 46A and 46B are schematics of example fluid sensors configured as liquid junction battery.

FIGS. 47, 48A, 48B, 48C, 48D, 48E, 48F, 49A, 49B, 49C, 49D, and 49E illustrate example methods of fabricating an integrated circuit fluid sensor.

FIG. 50 is a block diagram of an example fluid sensor device.

FIG. 51A and FIG. 51B are flow diagrams illustrating example methods for performing a fluid sensor test.

FIGS. 52, 53, 54, 55, 56, 57, and 58 are schematics of example fluid sensor devices performing a fluid sensor test.

FIG. 59 is a flow diagram illustrating an example method for manufacturing a fluid sensor.

FIGS. 60, 61, 62, 63, 64, and 65 are process flow diagrams depicting an example fluid sensor manufacturing process.

FIGS. 66, 67, 68, 69, 70, 71, 72, and 73 are schematics of example sensor devices including example heating and cooling structures.

FIGS. 74, 75A-75B, 76A-76B, and 77 are schematics of example sensor devices including electrodes configured to control pH levels of fluids in the sensor devices.

### DETAILED DESCRIPTION

Fluid sensor devices are useful in performing a variety of chemical and biomedical analyses, such as mass spectrometry, electrophoresis, and deoxyribonucleic acid (DNA) analysis. For example, fluid sensor devices can be useful in the clinical, laboratory, or home setting to identify a pathogen infecting a patient. Current fluid sensing technology, however, has multiple drawbacks that limit its usefulness. First, fluid sensors are able to test for only one pathogen at a time. Thus, diagnosing an ill patient who may be suffering from any of a variety of pathogenic infections can be a time-consuming process. Second, fluid sensors are not portable. For instance, fluid sensors that rely on optical technology to sense the presence of pathogens cannot readily be incorporated into small, lightweight, portable devices that can easily be distributed commercially on a wide scale to clinics, hospitals, and homes. Third, fluid sensors are slow to indicate test results, because rapid test results require precise and fast alteration of test sample temperatures, and fluid sensors-especially portable fluid sensors-do not include technology that is able to rapidly and precisely change temperatures in this manner.

This disclosure describes various example fluid sensor devices that solve the technical challenges described above. In particular, example fluid sensor devices include a main reservoir, multiple detection reservoirs, and a reference reservoir. Each of the reservoirs includes a pH sensor (e.g., an ion-sensitive field effect transistor (ISFET)) and may include an electrode. Each of the detection reservoirs and the reference reservoir is fluidically coupled to the main reservoir by one or more microfluidic channels, and each such microfluidic channel is configured (e.g., by valves and/or pumps) to provide fluid between the reservoirs to which that microfluidic channel is coupled.

During operation, a biological sample (e.g., taken from an ill patient) is provided to the main reservoir. In some examples, the biological sample can be pre-processed after taken from the ill patient prior to being provided to the main reservoir. The main reservoir includes a reagent which, in combination with temperature adjustments introduced by one or more heating elements, causes nucleic strands of the pathogen in the biological sample to be replicated rapidly. The biological sample is then provided to the detection reservoirs and the reference reservoir by way of the microfluidic channels. Each of the detection reservoirs and the reference reservoir includes a different reagent. The reagent in the reference reservoir is a pH buffer, meaning that the biological sample that is stored in the reference reservoir maintains a constant pH (e.g., a pH of approximately 8). The reagents in the detection reservoirs facilitate the replication of target nucleic acids/nucleic strands belonging to certain detection targets (e.g., microbes, pathogens, etc.). For example, a first detection reservoir may store a reagent that replicates nucleic strands of an influenza virus, if that virus is present in the biological sample. Similarly, a second detection reservoir may store a different reagent that replicates nucleic strands of a coronavirus, if that virus is present in the biological sample. Thus, when the biological sample is provided to the various detection reservoirs, one of the detection reservoirs will replicate the nucleic strands of the pathogen that is present in the biological sample, while the remaining detection reservoirs will not replicate any nucleic strands. The replication of nucleic strands causes a change in pH of the sample. Thus, by comparing the pH level of the biological sample stored in each detection reservoir to the pH level of the biological sample in the reference reservoir, the detection reservoir storing the biological sample with a pH that differs from the pH of the sample in the reference reservoir by more than a threshold amount is identified as corresponding to the pathogen with which the patient is infected.

For example, if the pH of the biological sample in the detection reservoir storing the reagent for the influenza virus is sufficiently different from the pH of the sample in the reference reservoir, this means that the nucleic strands in that detection reservoir were successfully replicated to a significant degree, meaning that the biological sample provided by the patient contains the influenza virus. The patient may thus be diagnosed with the influenza virus. The structure of the fluid sensor device facilitates simultaneously testing for numerous different pathogens. Further, the structure of the fluid sensor device can fit in a single integrated circuit (IC) package, facilitating portability and the wide and rapid distribution of the fluid sensor device to clinics, hospitals, and homes. In addition, the heating elements in the fluid sensor device enable the biological samples to be heated and cooled rapidly and precisely, thus facilitating the rapid replication of pathogens present in the biological samples. In this manner, the example fluid sensor devices described herein mitigate the technical challenges described above.

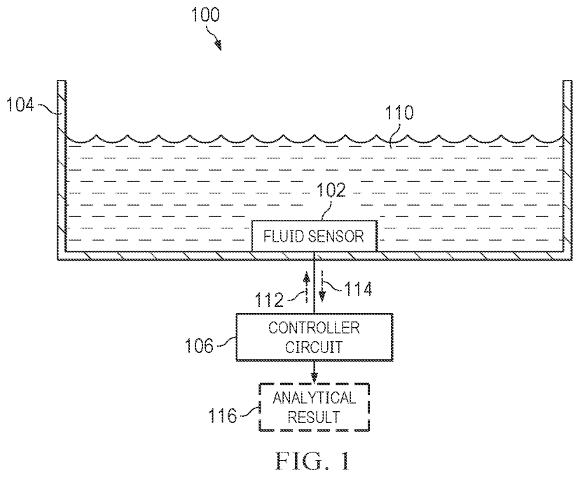

FIG. 1 is a schematic of an example fluid analytic system 100. Fluid analytic system 100 can include a fluid sensor 102, a container 104, and a control circuit 106. Container 104 can hold a fluid 110 to be analyzed by fluid analytic system 100. Fluid 110 can include an aqueous electrolyte solution of positive and negative ions. Fluid sensor 102 can be positioned in container 104 and interface with fluid 110. Controller circuit 106 can transmit a control signal 112 to fluid sensor 102. Responsive to control signal 112, fluid sensor 102 can sense a particular type of ions (e.g., Hydrogen ions) in fluid 110, and generate a sensor signal 114 representing, for example, a pH measurement of fluid 110. Fluid sensor 102 can provide sensor signal 114 to controller circuit 106, which can generate an analytical result 116 based on processing signal 108. Analytical result 116 can represent a result of a chemical and/or biochemical analysis, such as pH measurement, mass spectrometry, electrophoresis, and DNA analysis.

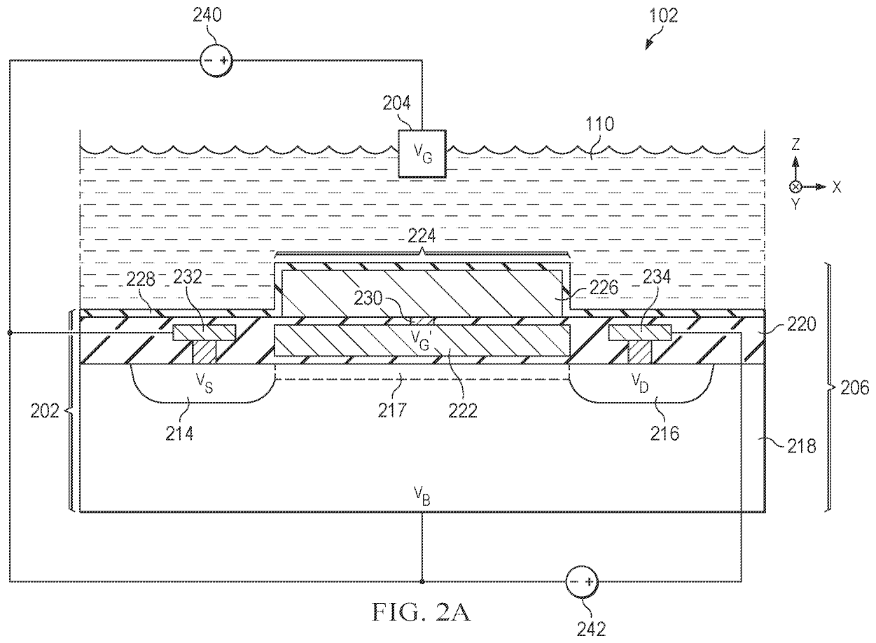

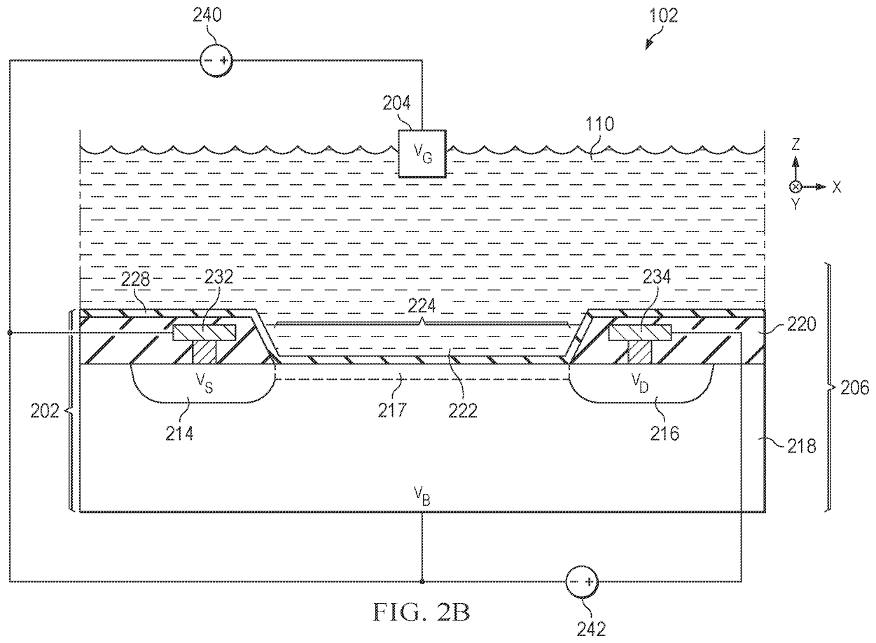

FIG. 2A is a schematic illustrating a cross-sectional view of fluid sensor 102. Fluid sensor 102 can include a semiconductor die 202. In some examples, fluid sensor 102 can also include a reference electrode 204. In some examples, an electrode in a fluid sensor can be made of Platinum or other noble metals. Also a reference electrode, such as reference electrode 204, can be a discrete silver-silver chloride metal wire inside of a Potassium Chloride (KCl) reservoir (not shown in FIG. 2A), and the KCl solution is connected to fluid 110 via a liquid junction.

In FIG. 2A, semiconductor die 202 can include an extended-gate ion-sensitive field effect transistor (EG-ISFET) 206, which includes current terminals 214 (e.g., a source terminal) and 216 (e.g., a drain terminal) separated by a channel region 217 in a substrate 218, a dielectric layer 220 on substrate 218, and a floating gate terminal 222 in dielectric layer 220 and separated from substrate 218. Fluid sensor 102 also includes a sensor terminal 224 on dielectric layer 220. Sensor terminal 224 can include an electrode 226 covered with an insulation layer 228. Examples of insulation layer 228 can include various silicon-based and metal-based oxides and nitride, such as silicon oxide (SiO₂), silicon nitride (Si₃N₄), aluminum oxide (Al₂O₃), and tantalum pentoxide (Ta₂O₅), Hafnium oxide (HfO₂), Zirconium dioxide (ZrO₂), Yttrium oxide (Y₂O₃), Zinc Oxide (ZnO), Tin Oxide (SnO₂), Manganese Dioxide (MnO₂), and Gallium Oxide (Ga₂O₃). Another example of insulation layer 228 can be Graphene. These materials can be formed by various processes, such as sputter deposition, vapor deposition (e.g., chemical vapor deposition), oxidation from a metal deposited by physical vapor deposition (e.g., TiO2 from Ti) either wet chemically or in an oven with oxygen, atomic layer deposition, etc.

Gate terminal 222 is submerged in fluid 110, and insulation layer 228 can provide a sensing surface. Reference electrode 204 can also be partially or fully submerged in fluid 110. Electrode 226 can be coupled to gate terminal 222 via an interconnect 230, and drain and current terminals 216 and 214 each can be coupled to respective interconnects 232 and 234. Interconnects 230, 232, and 234 can be part of a metallization structure encapsulated (or surrounded) by dielectric layer 220, and can be part of a back end of line (BEOL) structure. In FIG. 2B, semiconductor die 202 can also include an open-gate ion-sensitive field effect transistor (OG-ISFET), where fluid is separated from channel region 217 by insulation layer 228. With OG-ISFET, a region of insulation layer 228 directly above channel region 217 can be sensor terminal 224.

In examples, transistor 206 may have a planar 2D semiconductor surface similar to a metal oxide semiconductor field effect transistor (MOSFET). In some examples, transistor 206 may include a non-planar field effect transistor, such as fin field effect transistors or nanowire field effect transistors.

Reference electrode 204, source terminal 214, drain terminal 216, and substrate 218 can be coupled to voltage sources 240 and 242 to set their electrical potentials. For example, the source terminal 214 can be set to a potential V_{S}, the drain terminal 216 can be set to a potential V_{D}, and substrate 218 can be set to a potential V_{B}. Also, reference electrode 204 can be set to a potential V_{G}, and the potential of gate terminal 222 can be based on V_{G} The gate-substrate potential difference between the gate terminal 222 and substrate 218 can be V_{FG}. V_{FG} and V_{G} can be related based on the following Equation:

$${V}_{FG} = a + b \times {V}_{G} \qquad ( Equation 1 )$$

In Equation 1 above, a is a constant (for simplification omitted in the following equations), and b can be a function of various capacitances, including the capacitances between floating gate terminal 222 and fluid 110, and between floating gate terminal 222 and other metals (e.g., interconnects 232, 230, 234, etc.), as described below.

A current channel can form between drain terminal 216 and source terminal 214 if the gate-substrate-source potential difference, V_{FG}−V_{S}, exceeds the threshold voltage V_{TH} of ISFET 206. The amount of current that flows between drain terminal 216 and source terminal 214, I_{DS}, can be a function of V_{FG}(PH)−V_{S}−V_{TH} and the voltage difference V_{DS} between drain terminal 216 and source terminal 214.

Fluid sensor 102 can provide a pH measurement and generate a signal that reflects the activity of hydrogen ions in fluid 110 based on I_{DS}. According to the site binding model, depending on their activity, hydrogen ions (H⁺) in fluid 110 accumulate at the dielectric surface in the so-called electric double layer, and dominates the surface potential at the interface. The surface charge is capacitively coupled into the floating gate. The floating gate voltage V_{FG} hence is a function directly proportional to surface potential, which in turn is asymptotic to the electrode potential, i.e., in relative terms ΔV_{FG} is proportional to ΔV_{Surf}=AVG. Since I_{DS} can vary with V_{FG}, it can provide a measurement of the pH of fluid 110.

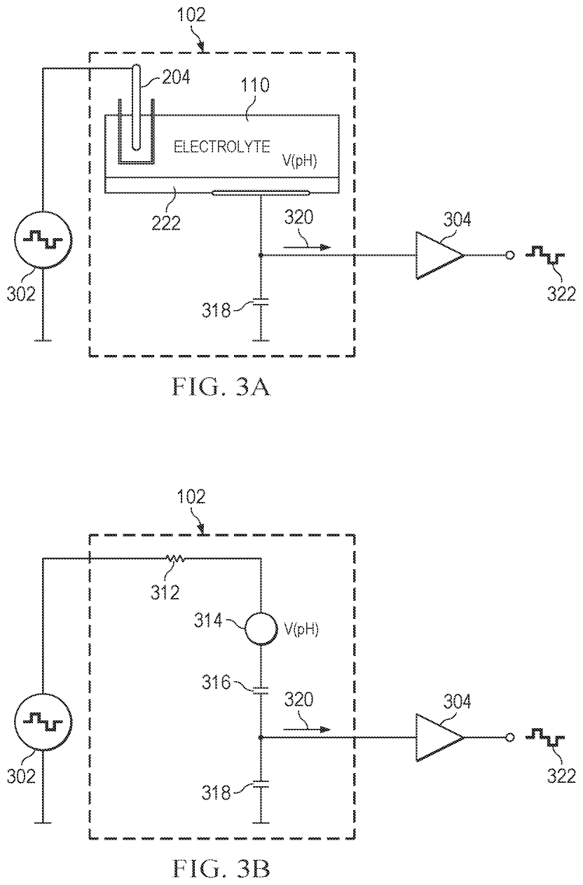

FIG. 3A and FIG. 3B illustrate example interface circuits of fluid sensor 102. Referring to FIGS. 3A and 3B, reference electrode 204 of fluid sensor 102 can be driven by a signal generator 302, and drain terminal 216 can be coupled to a voltage buffer 304. Signal generator 302 and voltage buffer 304 can be part of controller circuit 106, and can be implemented in semiconductor substrate 218 or external to semiconductor substrate 218. Referring to FIG. 3B, fluid 110 can be represented by a series connection of resistor 312, a variable voltage source 314, and a capacitive divider including capacitors 316 and 318. Resistor 312 can represent the resistance of reference electrode 204. Variable voltage source 314 can represent the surface potential V_{Surf} which is a function of the pH of fluid 110.

The relationship between a change in V_{Surf} (ΔV_{Surf}) and a change in the pH of fluid 110 (ΔpH) can be based on the Nernst equation as follows:

$$Δ {V}_{Surf} = RT / F \times Δ pH \qquad ( Equation 2 )$$

In Equation 2, R represents the universal gas constant, F represents the Faraday constant, and T represents temperature in kelvins, and RT/F can measure the pH sensitivity(S) of the fluid sensor. At standard state 1 mol/L for solutes, 1 atm for gases, T=298.15 K, i.e., 25° C. or 77° F., the sensitivity S can be at −0.05916. Equation 2 can be generalized as follows:

$$Δ {V}_{Surf} = Δ {V}_{G} + S \times Δ pH \qquad ( Equation 3 )$$

Capacitor 316 can represent a capacitance between fluid 110 and gate terminal 222 including capacitances contributed by fluid 110 and sensor terminal 224. Capacitor 318 can represent a parasitic capacitance between floating gate terminal 222 and secondary circuit elements in proximity to floating gate terminal 222, such as an analog floating gate or a metal-insulator-metal capacitor to control the floating gate potential V_{FG}.

Signal generator 302 can provide a sequence of voltage step signals, e.g., V_{G}±Vₛₜₑₚ to reference electrode 204. Voltage steps can be applied to verify proper electrical coupling between signal generator 302 and floating gate terminal 222. Responsive to the step voltage signal V_{G}, channel region 217 can conduct a step in I_{DS} according to the step voltage signal V_{G}. Step signal 320 can be represented by dividing a voltage V_{FG}−V_{S}−V_{TH} between capacitors 316 and 318, and voltage buffer 304 can provide a signal 322 as a buffered version of signal 320. Signal 322 can represent a sensed electrical potential V (pH) and can a pH measurement of fluid 110. Signal generator 302 can provide the step voltage signal V_{G}+Vₛₜₑₚ repeatedly between sampling intervals, and voltage buffer 304 can receive signal 320 and provide buffered signal 322 continuously. A change in the amplitude of signal 322 can reflect a change in the pH of fluid 110. A change in the amplitude of the fraction between step voltage amplitude Vₛₜₑₚ at 302 and the step function response ΔVₛₜₑₚ at 322 indicates an anomaly such as an air bubble covering a fraction of the capacitor 316.

One example application of fluid sensor to support the study of microfluidics, which can include analysis and manipulation of a fluid in a cavity having dimensions at the microscale, from 0.01 to hundreds of micrometers. When the fluid is at the microscale, surface effects as well as diffusion and laminar flow play an important role. The study of Electrokinetics describes the electrical properties of fluids, which also depend on the confinement scale. Microfluidics studies how these behaviors change, and how they can be worked around, or exploited for new uses. Microfluidics can have various applications, such as molecular and cell biology research, genetics, the study of fluid dynamics, and microfluidic mixing.

In microfluidics, one mechanism of fluid transport is by diffusion, where particles (e.g., ions) have a net flux down a concentration gradient. The distance by which a fluid is transported by diffusion can be related to the square root of the transport time of the fluid. Another mechanism of fluid transport is by convection, which can occur at a higher speed than diffusion. The relatively slow speed of fluid transport by diffusion can support additional applications, such as pH measurement with or without a reference electrode.

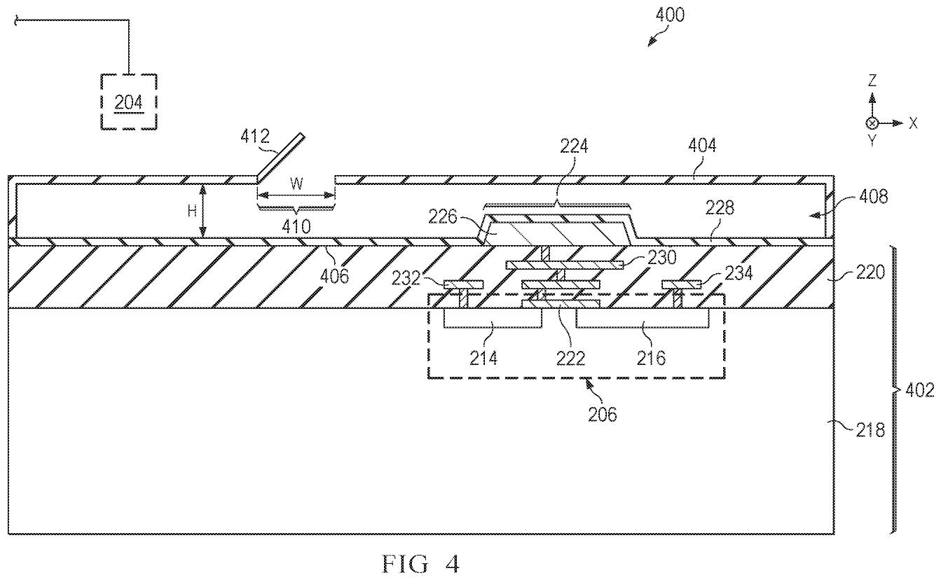

FIG. 4 is a schematic illustrating a cross-sectional view of an example microfluidic sensor. Referring to FIG. 4, microfluidic sensor 400 can be an integrated circuit including a semiconductor die 402 and a fluidic structure 404 on semiconductor die 402. Semiconductor die 402 includes semiconductor substrate 218, dielectric layer 220 on semiconductor substrate 218, and a metallization structure including interconnects 230, 232, and 234 encapsulated in/surrounded by dielectric layer 220. In FIG. 4, semiconductor die 402 also includes an ISFET (e.g., ISFET 206). In FIG. 4 and subsequent figures, each ISFET can be an EG-ISFET or an OG-ISFET. Semiconductor die 402 may include other circuits, such as controller circuit 106 of FIG. 1 and signal generator 302 and voltage buffer 304 of FIG. 3. Microfluidic sensor 400 also includes sensor terminal 224 on a sensing side 406 of dielectric layer 220, where sensor terminal 224 includes electrode 226 covered by insulation layer 228, which can cover other parts of sensing side 406 abutting electrode 226. The electrodes of a microfluidic sensor can be made of noble metals such as Platinum, Palladium, or Gold, as well as other metals or metal alloys such as Titanium Nitride (TiN), Tantalum Nitride (TaN), Ta, Tungsten (W), or Aluminum Silicon Titanium (AlSiTi). In some examples, microfluidic sensor 400 also includes reference electrode 204.

Also, fluidic structure 404 is on sensing side 406 of dielectric layer 220, and can enclose a fluid cavity 408 around sensor terminal 224. Fluidic structure 404 can be within a footprint of semiconductor die 402. In some examples, fluidic structure 404 can be made of a rigid silicon-based material, such as Silicon Oxide (SiO₂), Silicon Nitride (Si₂N₃), etc. In some examples, fluidic structure 404 can be made of or include other materials, such as polymers like SU-8 or Polyimide, Al₂O₃, etc. In the example of FIG. 4, fluidic structure 404 can include an opening 410. Fluid cavity 408 can be configured as a microfluidic cavity/channel with a height (labelled H in FIG. 4) at the microscale, such as at 0.01 to hundreds of micrometers. The width of opening 410 (labelled W in FIG. 4) can also be at microscale. In some examples, part of fluid cavity 408 can have a height/width at the nanoscale, such as at tens to hundreds of nanometers. In some examples, fluid sensor 400 can include a control device 412 that can enable or disable the flow of fluid through opening 410 into cavity 408, or otherwise vary the rate of flow of fluid through opening 410 into cavity 408. As to be described below, microfluidic sensor 400 can include a valve in cavity 408 as control device 412.

In some examples, fluidic structure 404 can be part of a restriction structure to restrict/delay the flow of fluid from external of fluid sensor 400 to sensor terminal 224. The microscale dimensions of opening 410 and fluid cavity 408 can restrict the flow of the fluid from external of fluid cavity 408 to sensor terminal 224. When the sensor is dry and no fluid is present in fluid cavity 408, a first fluid may enter fluid cavity 408 through opening 410 by capillary action. With a first fluid present in fluid cavity 408, a second fluid can enter fluid cavity 408 through opening 410, and propagate within fluid cavity 408 to sensor terminal 224, by microfluidic diffusion.

In some examples, fluid cavity 408 may initially contain a dry substance, such as a salt, which at least partially dissolves to form a buffer solution, and can receive deionized water to form a buffer solution in the cavity. Fluid 110 can then enter fluid cavity 408 through opening 410 via a microfluidic diffusion into the buffer solution. Inside fluid cavity 408, fluid 110 can propagate to sensor terminal 224 via another microfluidic diffusion.

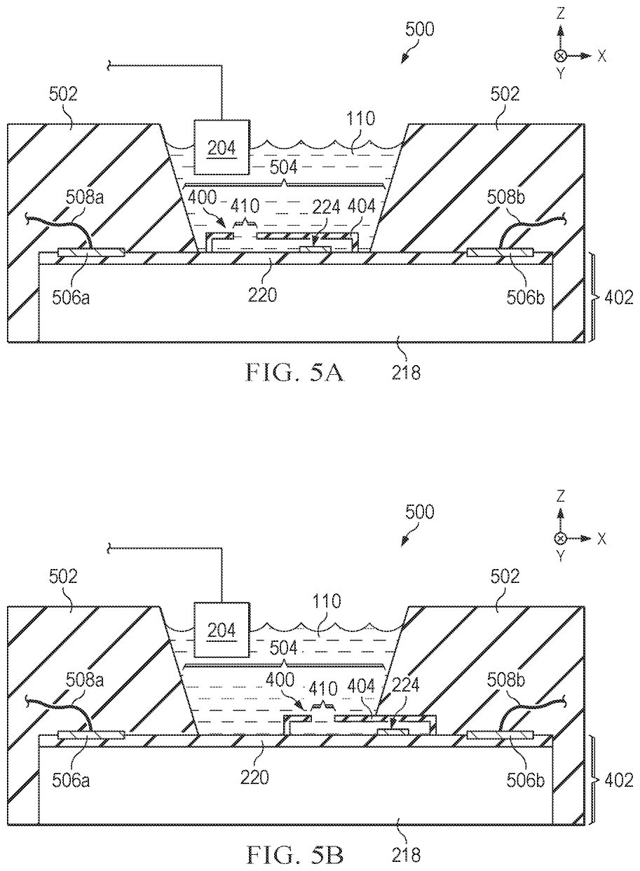

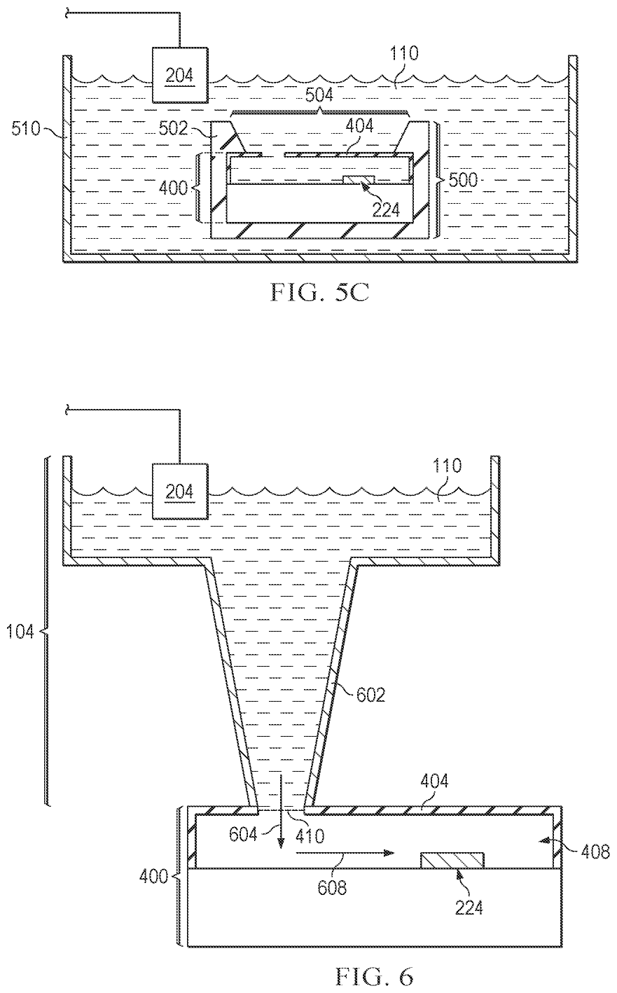

FIG. 5A, FIG. 5B, FIG. 5C and FIG. 6 illustrate example mechanisms of providing a fluid to microfluidic sensor 400 for sensing. FIG. 5A, FIG. 5B, FIG. 5C and FIG. 6 each is a schematic illustrating a cross-sectional view of a sensor system including microfluidic sensor 400. Referring to FIG. 5A, FIG. 5B, and FIG. 5C microfluidic sensor 400 can be part of a packaged integrated circuit 500 including package 502 abutting semiconductor die 402 and insulation layer 220. Package 502 can include a macroscopic opening 504 that exposes microfluidic sensor 400 (and opening 410), and opening 504 can hold a fluid, such as fluid 110, and microfluidic sensor 400 (and opening 410) can be submerged in fluid 110. A sensor system including packaged integrated circuit 500 can also include reference electrode 204 in contact with fluid 110 to set its electrical potential. Packaged integrated circuit 500 can also include interconnects, such as bond pads 506a/b and bond wires 508a/b, to support transmission of signals between microfluidic sensor 400 and an external system. In some examples, as shown in FIG. 5B, a first part of microfluidic sensor 400 can be embedded in package 502, and a second part of microfluidic sensor 400 including opening 410 can be exposed in opening 504. Also, referring to FIG. 5C, the entire packaged integrated circuit 500 can be submerged into a container 510 holding fluid 110. Packaged integrated circuit 500 can include wireless communication circuitry (not shown in FIG. 5C) to support wireless transmission of signals between microfluidic sensor 400 and an external system.

Also, referring to FIG. 6, fluid container 104 may include at least one port 602, which may include a microfluidic channel. In some examples, fluid container 104 may be part of a flow cell. Opening 410 of microfluidic sensor 400 can interface with and receive fluid 110 via conduit 602. Fluid 110 can then enter fluid cavity 408 through opening 410 via a microfluidic diffusion 604 into the buffer solution. Inside fluid cavity 408, fluid 110 can propagate to sensor terminal 224 via microfluidic diffusion 608.

Having a restriction structure including a microfluidic cavity integrated as an integrated circuit can provide various advantages. Specifically, as to be described later, fluidic structure 404 can be fabricated as part of wafer fabrication process or a packaging process of semiconductor die 402. The cleanliness, yield and quality control of wafer manufacturing process outperforms subsequent processes such as the packaging or housing process, which typically only partly takes place in a cleanroom, or at least in a clean room of lower class than a wafer fabrication cleanroom. When fluidic structure 404 is part of wafer fabrication, the dimensions of the overall sensor IC and IC package can be small. The small fluidic structure can reduce the overall size and footprint of the fluid sensor, especially compared with a case where the fluid sensor includes a discrete fluid container. This allows the fluid sensor to be deployed in various environments, such as on or within a patient's body. Further, because of the fluidic structure has a small footprint, it is more likely that the entire fluid cavity can have the same ambient condition (e.g., same temperature, same humidity, pressure, surface roughness, etc.), which can reduce measurement error caused by subjecting the fluid to non-uniform ambient conditions at different locations (e.g., at opening 410 and at sensor terminal 224) within the fluid cavity.

Further, as to be described later, having a fluid cavity integrated in an integrated circuit allows implementation of additional techniques to further improve the robustness of the fluid sensor and to support additional applications. For example, the inner surface of fluid cavity 408 can be covered with the same insulation layer 228 to provide a uniform wetting surface. This can reduce measurement error caused by difference in hydrophilic nature or Zeta potential difference due to the fluid being measured/sensed is in contact with two different wetting surfaces. Also, multiple sensor terminals and ISFETs can be implemented within the fluid cavity to provide differential sensing. Because those ISFETs are fabricated monolithically as part of the same semiconductor die, they can provide better matching, and such arrangements can reduce errors in the differential sensing caused by mismatches between ISFETs. Various circuits that interface with the ISFETs, such as signal generators and voltage buffers, can also be integrated with the ISFETs monolithically. This can improve matching and reduce the susceptibility of signal transmission to noise. Further, additional devices, such as valve and filter, can be implemented in the fluid cavity, at the opening, or otherwise as part of the restriction structure to control the flow of fluid and to further refine the selection of ions/particles to be measured by the fluid sensor, to support additional applications.

In some examples, fluidic structure 404 can also be fabricated as part of the packaging process, and the packaging process can be improved using various packaging techniques, such as wafer-to-wafer bonding or other heterogeneous integration methods, which can reduce mismatches among the fluid sensors and the cost of manufacturing of the fluid sensors. Accordingly, in some examples, fluidic structure 404 being fabricated as part of the packaging process can provide similar advantages as wafer fabrication.

In some examples, microfluidic sensor 400 can be used to measure a time of diffusion of a second fluid, which diffuses into fluid cavity 408, mixing and ultimately replacing the first fluid which occupies cavity 408 before the second fluid is introduced. Specifically, when the second fluid arrives at the sensor terminal 224, microfluidic sensor 400 can provide a signal representing the detection of local activity of ions (e.g., H+ ions), which can depend on the activity of all ionic species present in the first and second fluids, as well as their respective dissociation constants Kᵢ. Because it takes time for the fluid to propagate to sensor terminal 224 via diffusion, the signal provided by microfluidic sensor 400 can be used to measure a total time of, for example, the two fluids being fully mixed, full diffusion of ions of the second fluid into fluid cavity 408, and/or full diffusion of the ions of the first fluid out of fluid cavity 408.

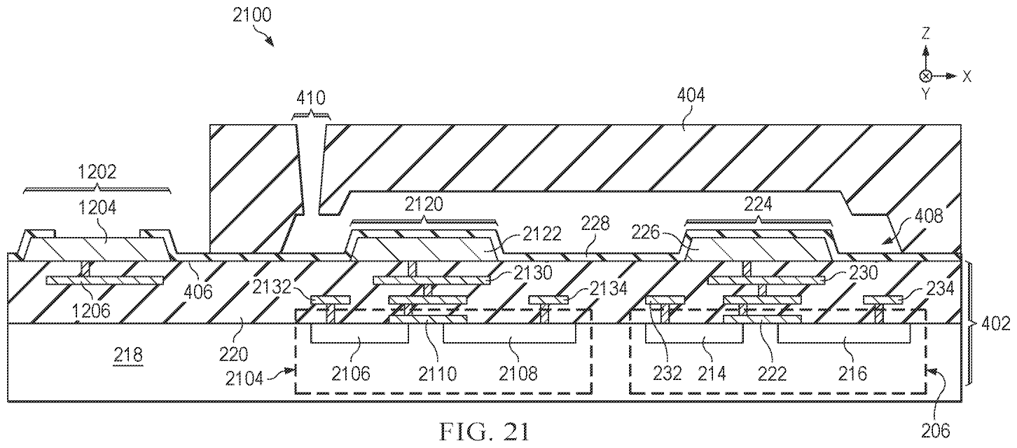

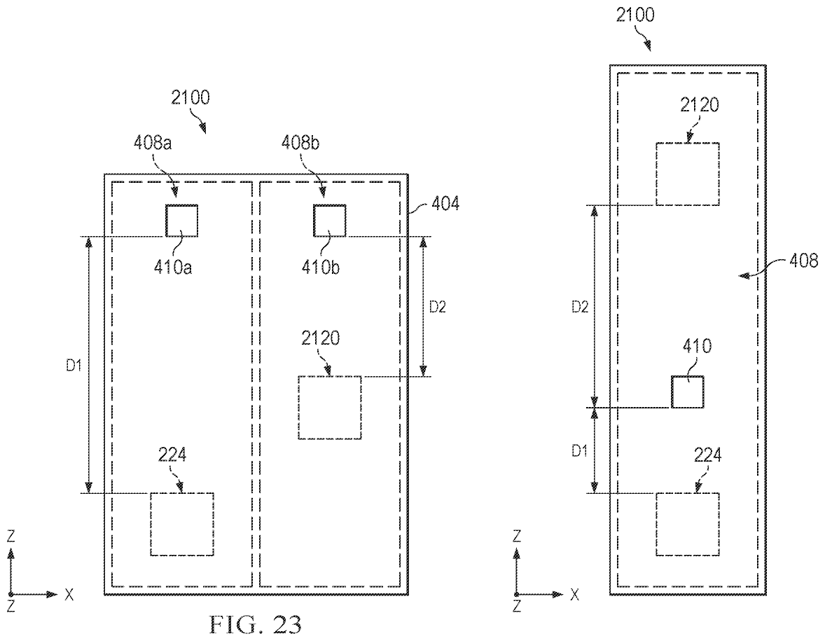

In case of a significantly larger reservoir of the second fluid being provided to fluid sensor 400 (e.g., as shown in FIGS. 5A-5C and FIG. 6), the first fluid can be fully replaced by the second fluid at a certain time. A change of H+ ion activity indicates that the diffusion front of the second fluid has reached sensor terminal 224. Once the H+ ion activity is no longer changing, an equilibrium such as full mixing or out-diffusion of first fluid is reached. This measurement in turn can support analytical measurements, since the mixing behavior described before depends on ionic species and the gradient of their respective activity formed between first and second fluid. As to be described below in FIGS. 21 and 23, a fluidic sensor can include multiple sensing elements (e.g., sensor terminals 224) along the diffusion path in fluid cavity 408 which allows further insight. Specifically, even for a matching pH of both fluids locally along the diffusion boundary, the pH can still vary to counter-balance charge accumulation due to the different free diffusion constants of the ions which are diffusing due to a non-zero activity gradient. In certain examples, this arrangement can be used to measure concentration of ionic species other than H+ ions, such as Potassium ions (K+), Sodium ions (Na+), or Chloride ions (Cl−).

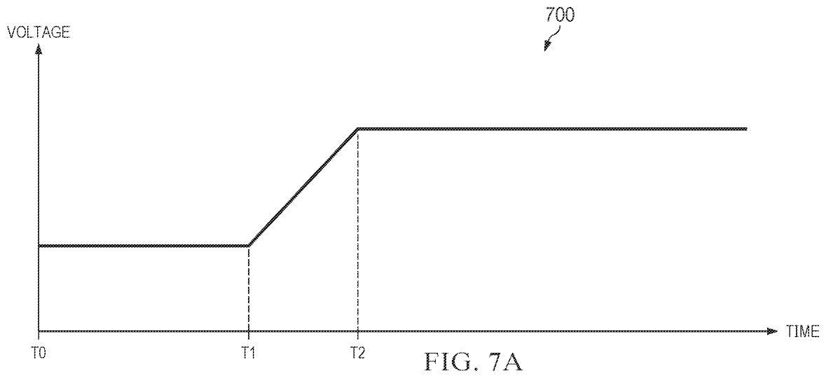

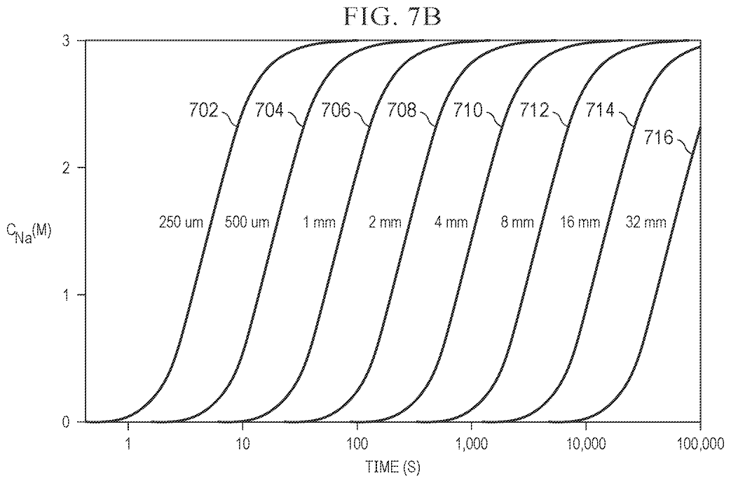

FIG. 7A and FIG. 7B illustrates example graphs representing time-series variations of the outputs of microfluidic sensor 400 in measuring a diffusion time. The outputs can represent changes in the concentration of an ion (e.g., hydrogen ion) as a result of diffusion. FIG. 7A illustrates an example graph 700. Referring to FIG. 7A, a fluid may be introduced at opening 410 of microfluidic sensor 400 at time T0. A first batch of ions of the fluid may diffuse across opening 410 and fluid cavity 408 and reach sensor terminal 224 at time T1, which causes a sensed electrical potential (voltage) of microfluidic sensor 400 to rise at T1. The diffusion time can be the time difference of T1−T0. As more ions arrive at sensor terminal 224 through diffusion, the sensed electrical potential of microfluidic sensor 400 may continue to rise. The sensed electrical potential of microfluidic sensor 400 can stop rising at T2 when a thermodynamic equilibrium state is reached.

Also, FIG. 7B illustrates example graphs 702 through 716 representing variations of Sodium concentration at sensor terminal 224 with respect to time for different channel lengths, where the channel length represents a distance between opening 410 and sensor terminal 224. In FIG. 7B, the vertical axis is mole concentration of Sodium (labelled C_{Na}), and the horizontal axis is time. The molar concentration of Sodium can be represented by the sensed electrical potential of microfluidic sensor 400. Referring to FIG. 7B, as the channel length increases, the time of diffusion from opening 410 to sensor terminal 224 also increases, the time for the molar concentration at sensor terminal 224 to increase to a particular level also increases. For example, referring to graph 702, for a channel length of 250 micrometers (um), it takes about 5 seconds for the molar concentration to reach 1 M. Also, referring to graph 716, for a channel length of 32 millimeters (mm), it takes about 50000 seconds for the molar concentration to reach 1 M.

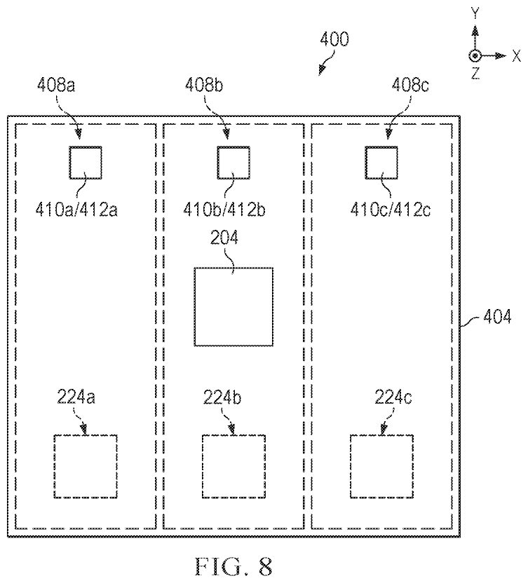

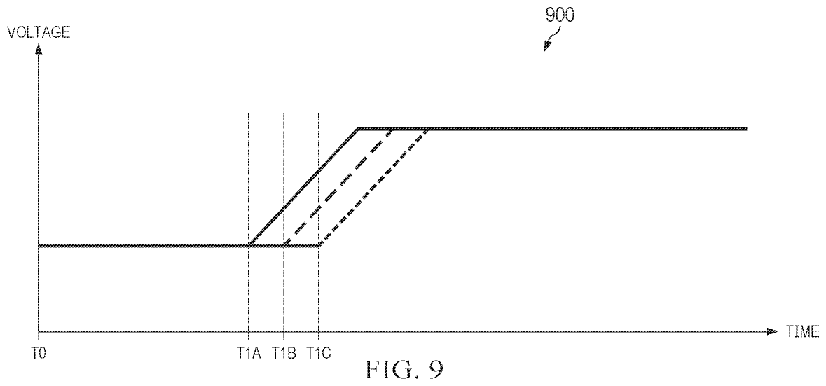

In some examples, microfluidic sensor 400 can measure different diffusion times for different fluids. As described above, microfluidic sensor 400 can rely on microfluidic diffusion to receive a fluid from an external environment, and to transport the fluid within fluid cavity 408. Different ions/particles may have different diffusion time due to, for example, their different molecular masses, or other properties that affect the rate of diffusion. FIG. 8 illustrates a plan view of an example of microfluidic sensor 400 that supports diffusion time measurement of different fluids. Referring to FIG. 8, microfluidic sensor 400 includes separate fluid cavities 408a, 408b, and 408c enclosed by fluidic structure 404. Fluid cavity 408a can enclose a sensor terminal 224a, fluid cavity 408b can enclose a sensor terminal 224b, and fluid cavity 408c can enclose a sensor terminal 224c. Sensor terminals 224a, 224b, and 224c, and the ISFETs coupled to the sensor terminals, are in the same semiconductor die 402 and are part of a monolithic integrated circuit. Fluidic structure 404 also includes an opening 410a that extends to fluid cavity 408a, an opening 410b that extends to cavity fluid 408b, and an opening 410c that extends to fluid cavity 408c. Microfluidic sensor 400 can also include reference electrode 204 over fluidic structure 404 (e.g., along the z-axis).

In some examples, microfluidic sensor 400 can include additional sensor structures integrated in fluid cavities 408a-c and in close proximity to sensor terminals 224a-c. Such sensor structures can support various electrochemical measurement techniques such as impedance spectroscopy and amperometric measurements such as cyclovoltammetry.

In some examples, microfluidic sensor 400 can receive different fluids sequentially. For example, microfluidic sensor 400 can be part of packaged integrated circuit 500 of FIG. 5A and FIG. 5B, or can be in container 510. Different fluid can be introduced to opening 504 or container 510 at different times. Microfluidic sensor 400 can include a control device 412a at opening 410a (or between opening 410a and sensor terminal 224a), a control device 412b at opening 410b (or between opening 410b and sensor terminal 224b), and a control device 412c at opening 410c. When a first fluid is in opening 504/container 510, control device 412a can be opened and control devices 412b and 412c can be closed to allow the first fluid to enter fluid cavity 408a and to prevent the first fluid from entering fluid cavities 408b and 408c. Also, when a second fluid is in opening 504/container 510, control device 412b can be opened and control devices 412a and 412c can be closed to allow the second fluid to enter fluid cavity 408b and to prevent the second fluid from entering fluid cavities 408a and 408c. Further, when a third fluid is in opening 504/container 510, control device 412c can be opened and control devices 412a and 412b can be closed to allow the third fluid to enter fluid cavity 408c and to prevent the third fluid from entering fluid cavities 408a and 408b.

In other examples, the fluid cavity openings 408a, 408b, and 408c can each be coupled to a different port of FIG. 6, and each container can hold a different fluid. For example, fluid cavity opening 408a can be coupled to a port 602a to receive the first fluid, fluid cavity opening 408b can be coupled to a port 602b to receive the second fluid, and fluid cavity opening 408c can be coupled to a port 602c to receive the third fluid. Fluid cavities 408a, 408b, and 408c can receive the respective fluids at the same time.

FIG. 9 illustrates a graph 900 representing a time-series variation of the outputs of microfluidic sensor 400 of FIG. 8 in measuring diffusion times of different fluids. Referring to graph 900, a first fluid, a second fluid, and a third fluid can be applied to the respective openings 410a, 410b, and 410c at time T0 via multiple ports 602a, 602b, 602c, as described above. Because of the different diffusion properties of the fluids, the sensed electrical potential at sensor terminal 224a can starts rising at time TIA, the sensed electrical potential at sensor terminal 224b starts rising at time T1B, and the sensed electrical potential at sensor terminal 224c starts rising at time TIC. The diffusion time of the first fluid can be represented by the difference of T1AT0, the diffusion time of the second fluid can be represented by the difference of T1B−T0, and the diffusion time of the third fluid can be represented by the difference of T1C−T0. As explained above, because fluidic structure 404 can have a small footprint, the diffusion of the different fluids in fluid cavities 408a, 408b, and 408c can be subject to the same conditions (e.g., same temperature, humidity, and pressure, as well as unchanged flow path cross section and surface), which can reduce the effect of ambient condition variation on the diffusion measurement. Further, because the sensor terminals and the ISFETs are part of a monolithic integrated circuits, the mismatches among the sensor terminals and the ISFETs can be reduced, which can reduce the effect of circuit mismatches on the diffusion measurement. Accordingly, the outputs of microfluidic sensor 400 can reflect the actual diffusion properties of the fluids being tested. All these can improve the robustness and measurement accuracy of microfluidic sensor 400.

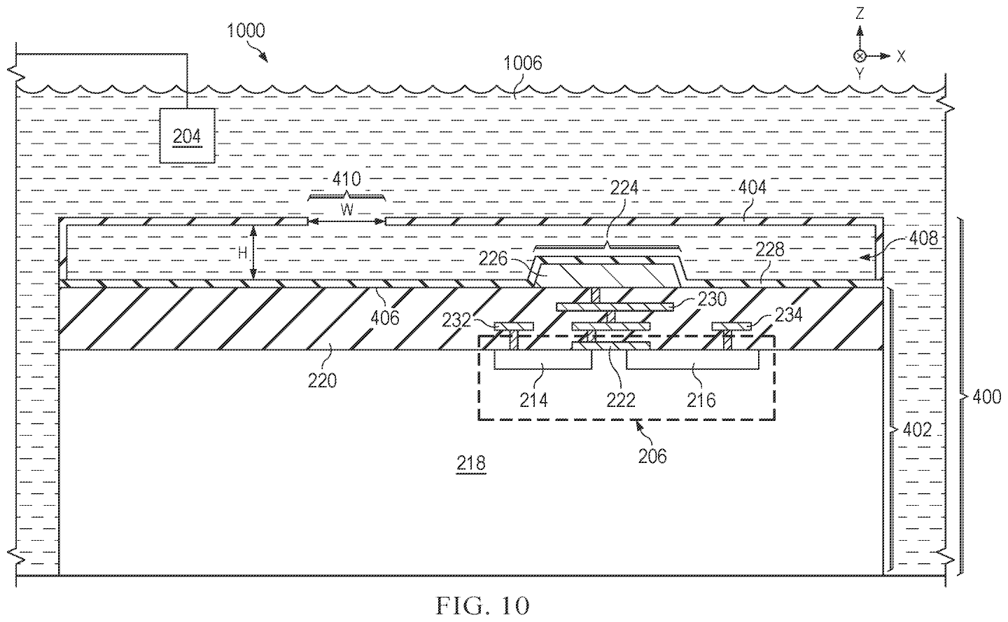

In some examples, microfluidic sensor 400 can be configured to provide a pH measurement of a fluid. FIG. 10 is a schematic illustrating a cross-section of an example microfluidic sensor 1000 including components of microfluidic sensor 400 of FIG. 4. Referring to FIG. 10, microfluidic sensor 1000 can include an integrated circuit having various components of microfluidic sensor 400, such as fluidic structure 404 on semiconductor die 402, the fluidic structure 404 enclosing fluid cavity 408 and including opening 410, and sensor terminal 224 coupled to ISFET 206. Fluid sensor 1000 can also include reference electrode 204. Both the integrated circuit and reference electrode 204 can be submerged/exposed to a same fluid 1006, and fluid 1006 can enter fluid cavity 408 and be in contact with sensor terminal 224. Reference electrode 204 can be driven by a signal generator (e.g., signal generator 302) to a known electrical potential. As explained in FIG. 3A and FIG. 3B, if the electrical potential of the reference electrode is known, the sensed electrical potential of ISFET 206 can provide a measurement of the surface potential at the interface between sensor terminal 224 and fluid 1006, and the surface potential measurement can indicate a concentration (or activity) of the hydrogen ion, which can provide a pH measurement. In FIG. 10, reference electrode 204 is illustrated as a discrete component separate from semiconductor die 402. As to be described below, reference 204 can be replaced with an electrode integrated in semiconductor die 402 as part of the package or the wafer fabrication.

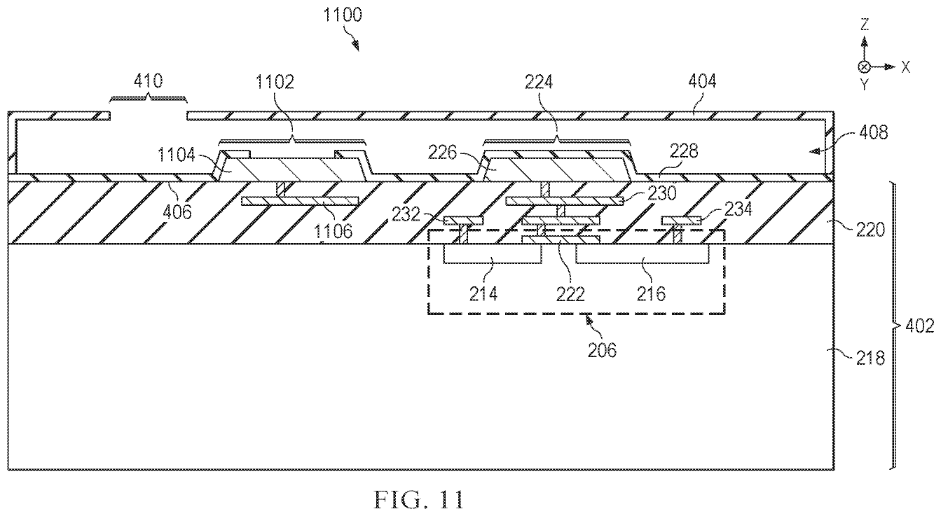

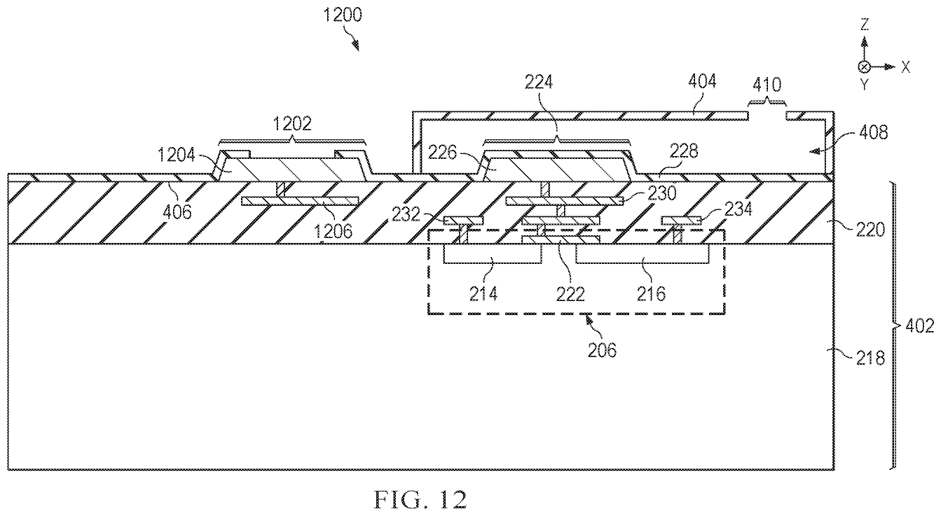

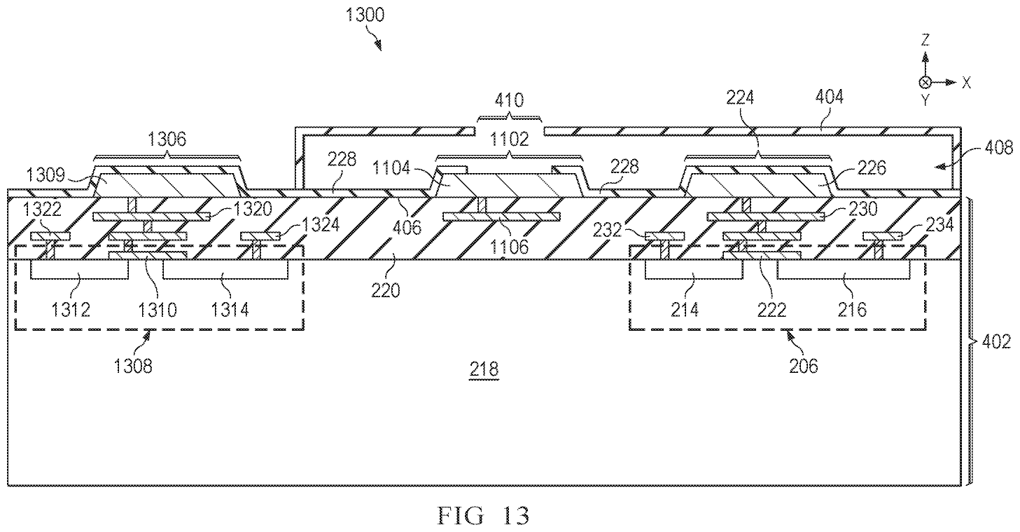

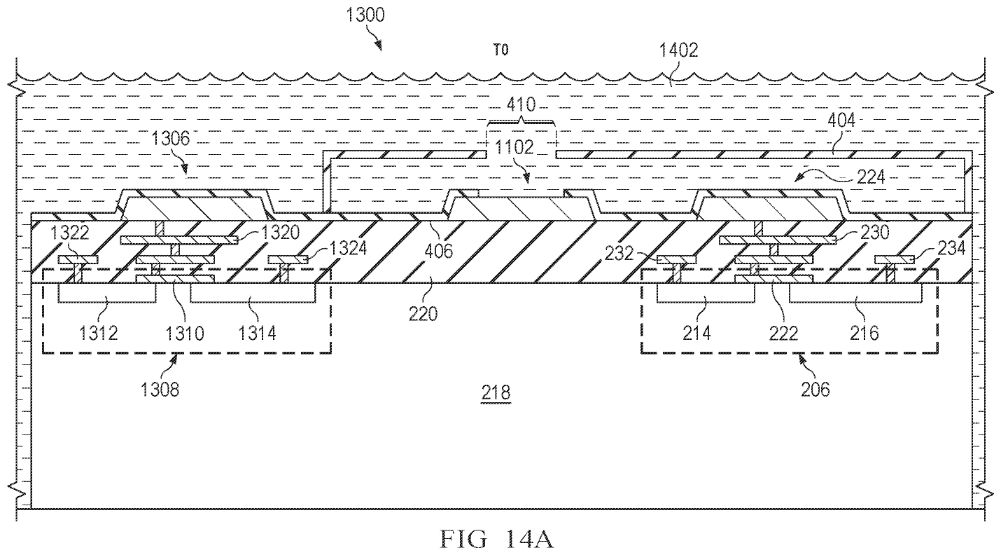

FIG. 11 and FIG. 12 illustrate examples of microfluidic sensors having integrated reference electrodes to provide pH measurements. Referring to FIG. 11 and FIG. 12, each of microfluidic sensors 1100 and 1200 can be an integrated circuit having various components of microfluidic sensor 400, such as fluidic structure 404 on semiconductor die 402, the fluidic structure 404 enclosing fluid cavity 408 and including opening 410, and sensor terminal 224 coupled to ISFET 206. In addition, microfluidic sensor 1100 can include a voltage terminal 1102, and microfluidic sensor 1200 can include a voltage terminal 1202. Voltage terminals 1102 and 1202 can be formed on sensing side 406 of dielectric layer 220 as part of the integrated circuit. Voltage terminal 1102 can include an electrode 1104 partially covered by insulation layer 228, and voltage terminal 1202 can include an electrode 1204 partially covered by insulation layer 228. In some examples, voltage terminals 1102 and 1202 can be reference electrodes integrated with semiconductor die 402, and can replace a discrete reference electrode 204. In some examples, electrodes 1104 and 1204 can be coated with or made of Platinum or another noble or electrochemically stable metal, if configured for differential sensing as shown later. In some examples, electrodes 1104 and 1204 or they can be configured as a reference electrode, and these electrodes can be made of a metal with a certain stable redox potential with regards to the fluids under test. For example, for solutions with a stable chlorine content, electrodes 1104 and 1204 can include silver and coated with a silver chloride layer. As another example, electrodes 1104 and 1204 can include copper and coated with a copper sulfate layer. In some examples, electrodes 1104 and 1204 can be part of an aqueous reference electrode. Electrodes 1104 and 1204 can be coupled to, respectively, interconnects 1106 and interconnect 1206 in dielectric layer 220, where interconnects 1106 and 1206 can be part of the metallization structure including interconnects 230, 232, and 234. In FIG. 11, voltage terminal 1102 can be enclosed in fluidic structure 404 with sensor terminal 224, and in FIG. 12, voltage terminal 1202 can be external to fluidic structure 404. In some examples, voltage terminal 1202 can be in another cavity separate from (and disconnected from) cavity 408.

In some examples, voltage terminals 1102 and 1202 can be coupled to a signal source (e.g., signal source 302) via respective metal interconnects 1106 and 1206. Responsive to a signal from the signal source, voltage terminals 1102 and 1202 can set the electrical potentials of a fluid in fluid cavity 408 and of gate terminal 224. The signal source can be implemented in semiconductor die 402 or as an external component. In some examples, voltage terminals 1102 and 1202 can be configured as reference electrode 1002 to provide a precise electrical potential. By integrating the reference electrode into the integrated circuit, the size of the microfluidic sensor can be further reduced.

FIG. 13 illustrates another example of microfluidic sensors that can also provide pH measurements. Referring to FIG. 13, a microfluidic sensor 1300 can be an integrated circuit having various components of microfluidic sensors 1100/1200, such as fluidic structure 404 on semiconductor die 402, the fluidic structure 404 enclosing fluid cavity 408 and including opening 410, and sensor terminal 224 coupled to ISFET 206. In the example of FIG. 13, microfluidic sensor 1300 also includes voltage terminal 1102 in fluid cavity 408, while in other examples, microfluidic sensor 1300 can include voltage terminal 1202 external to fluid cavity 408.

Also, microfluidic sensor 1300 includes a sensor terminal 1306 external to fluid cavity 408, and an ISFET 1308 in semiconductor die 402. Sensor terminal 1306 can be on sensing side 406 and includes an electrode 1309 covered by insulation layer 228. ISFET 1308 includes a gate 1310 and source and drain terminals 1312 and 1314. Electrode 1309 can be made of Platinum. Microfluidic sensor 1300 includes an interconnect 1320 coupled between gate 1310 and electrode 1309, an interconnect 1322 coupled to source terminal 1312, and an interconnect 1324 coupled to drain terminal 1314. Interconnects 1320, 1322, and 1324 can be part of a metallization structure in dielectric layer 220 including interconnects 1106, 230, 232, and 234.

ISFETs 206 and 1308 can perform a differential sensing operation to provide a pH measurement of a fluid. With differential sensing, ISFETs 206 and 1308 can output an electrical potential difference representing a pH difference between a first fluid to be measured and a second fluid having a known pH value. Because the electrical potential provided by voltage terminal 1102 can be cancelled in the electrical potential difference, the electrical potential provided by voltage terminal 1102 needs not be precisely controlled or known. Further, because ISFETs 206 and 1308 are fabricated as part of a monolithic integrated circuit, mismatches between the ISFETs can be reduced. All these can relax the implementation and control of voltage terminal 1102 without degrading the pH measurement accuracy.

In some examples, sensor terminal 1102 of FIG. 13 is less than 250 micrometers (um) from opening 410 if it is in fluid cavity 408, and less than 0.5 mm from the opening if external to fluid cavity 408. Sensor terminal 224 can be more than 1 mm from opening 410.

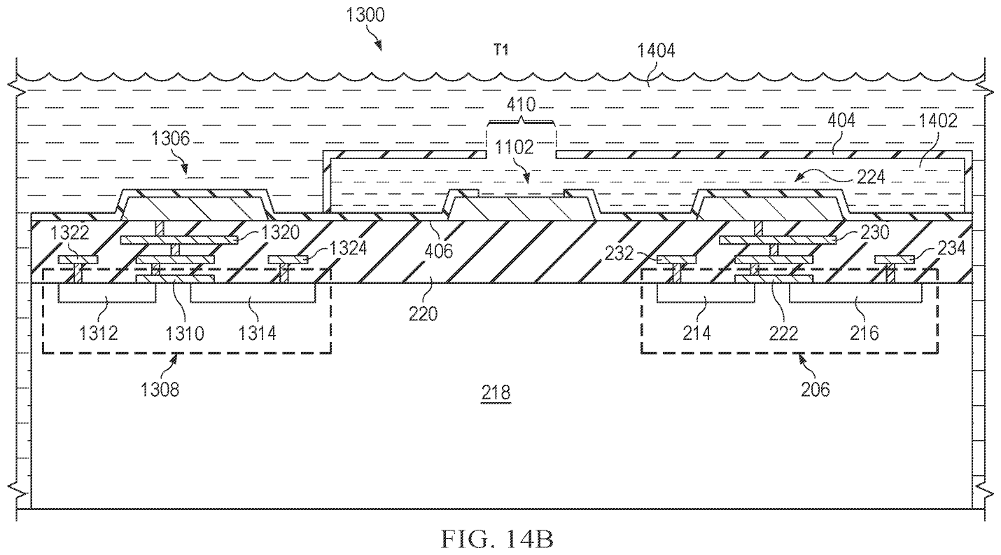

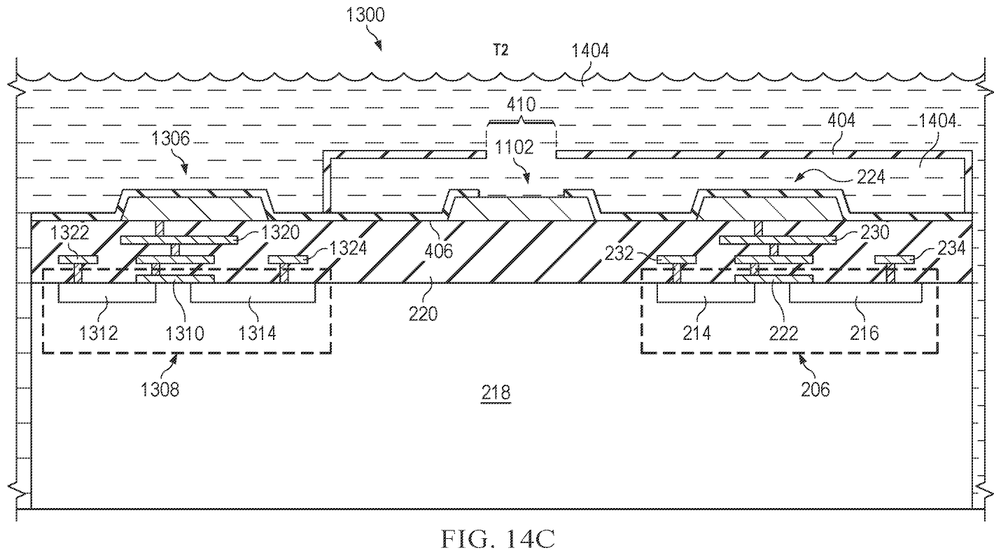

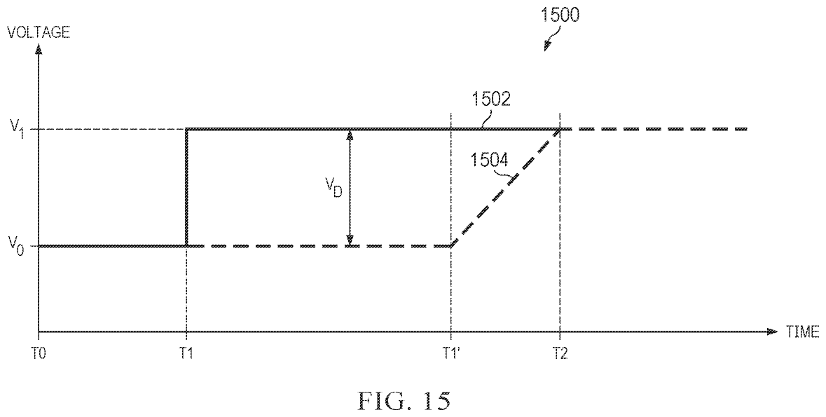

FIGS. 14A, 14B, and 14C illustrate an example sequence of operations of microfluidic sensor 1300 in performing differential sensing, and FIG. 15 illustrates graphs 1502 and 1504 representing the variations of the respective outputs of ISFETs 206 and 1308 with time. Microfluidic sensor 1300 can be positioned in a fluid container, such as fluid containers 104 and 510 and an IC package having an opening (e.g., package 502).

Referring to FIG. 14A, at time T0, the fluid container may carry a fluid 1402, and sensing side 406 of microfluidic sensor 1300 can be exposed to fluid 1402. Fluid 1402 can be a reference fluid or reference buffer of a known pH_{Ref}. Fluid 1402 can be a pH buffer of high ionic strength and can have a relatively high concentration of K+ and Cl− ions. Fluid 1402 comes into contact with sensor terminal 1306. Also, fluid 1402 can enter fluid cavity 408 via opening 410 and come into contact with sensor terminal 224. Because sensor terminals 224 and 1306 are both exposed to the same fluid 1402, ISFETs 206 and 1308 can provide a voltage of V₀, which can include a first component representing an electrical potential of voltage terminal 1102 (V_{G}), and a second component representing the pH-dependent surface potential of the sensor terminals 224 and 1306, as follows:

$${V}_{0} = b \times ( {V}_{G} + V ( {pH}_{0} ) ) = b \times ( {V}_{G} + S {pH}_{0} ) \qquad ( Equation 4 )$$

In Equation 4, b represents the capacitive divider ratio between a capacitance between voltage terminal 1102 and a sensor terminal (e.g., sensor terminals 224 or 1306) across fluid 1402. V(pH₀) represents the surface potential at sensor terminals 224 and 1306 when in contact with fluid 1402 having a pH value of pH₀.

Referring to FIG. 14B, at time T1, fluid 1402 in the fluid container can be replaced with a fluid 1404 for which the pH is to be measured. Fluid 1402 in fluid container 104 can be replaced by convection, or by other means faster than microfluidic diffusion. Sensor terminal 1306, which is external to fluidic structure 404, can be exposed to fluid 1404 at time T1. Accordingly, ISFET 1308 can provide a voltage of V₁, which can include the same electrical potential of voltage terminal 1102 (V_{G}), and a new pH-dependent surface potential of the sensor terminal 1306, as follows:

$${V}_{1} = b \times ( {V}_{G} + V ( {pH}_{1} ) + {V}_{LJP} ) \approx b \times ( {V}_{G} + S \times {pH}_{1} ) \qquad ( Equation 5 )$$

The values of b and V_{G} in Equation 5 are equal to those of Equation 4, while V (pH₁) represents the surface potential at sensor terminal 1306 when in contact with fluid 1404 having a pH value of pH₁. An additional term V_{LJP} can arise due to a liquid junction potential forming across the diffusion zone, at the liquid boundary or liquid junction between the two fluids. Across the boundary of two pH buffers, the liquid junction potential is very small and hence neglected. This is especially the case if the first fluid has a much greater ionic strength than the other fluid, and the first fluid's ionic species of opposite charge have roughly identical mobility, such as is the case for a highly concentrated (e.g., 3M or 4M) solution of KCl. Moving on with the assumption of negligible V_{LJP}≈0 mV according to Equation 5, the differential sensing output, which can be represented by the voltage difference V_{D} between voltages V₀ and V₁, can be represented as follows:

$${V}_{D} = {V}_{1} - {V}_{0} = b \times S \times ( {pH}_{1} - {pH}_{0} ) \qquad ( Equation 6 )$$

Assuming that pH₀ is known, the value of pH₁ can be determined from Equation 6. Also, as shown in Equation 6, the electrical potential of voltage terminal 1102 (V_{G}) is cancelled out in the differential sensing output. Therefore, V_{G} needs not be precisely controlled or known to determine pH₁. Accordingly, the implementation and control of voltage terminal 1102 can be relaxed without degrading the pH measurement accuracy, if a pH-independent voltage reference (or a substantially pH-independent voltage reference) can be provided by the measured electrical potential at ISFET 206.

Referring to FIG. 14C and FIG. 15, between time T1 and T1′, fluid 1404 may enter fluid cavity 408 via microfluidic diffusion across opening 410, and propagate to sensor terminal 224 via microfluidic diffusion within fluid cavity 408. The duration between T1 and T1′ can be based on the distance between opening 410 and sensor terminal 224 (represented by channel length of FIG. 7). At time T1′, the ions of fluid 1404 start to arrive at sensor terminal 224, and the sensed electrical potential of ISFET 206 starts to rise. At time T2, an equilibrium state is reached, and ISFET 206 and ISFET 1308 can sense the same electrical potential V₁. If the first fluid 1402 is buffered around its pH₀, then significant pH change can be delayed until the buffer capacity of 1402 is overcome. Various techniques are described to minimize (or at least reduce) the liquid junction potential component can be minimized (or at least reduced), and to maximize (or at least increase) the diffusion time T1′-T1 to ensure that the electrical potential measured by ISFET 206 is at V₀ when the differential sensing is performed. All these can ensure (or increase the likelihood of) the measured electrical potential at ISFET 206 providing a stable and pH-independent voltage reference for differential sensing.

In some examples, the first fluid can be a reference buffer, containing a highly concentrated solution where ionic strength is defined by KCl added to a pH buffer solution. As to be described below, the mixing of the KCl with the fluid to be measured can eliminate/reduce the liquid junction potential component. The pH buffer solution can be a single weak electrolyte (weak acid or base) or a relatively strong titrant (strong acid or base, respectively). For example, an acetate buffer is constructed by titration of an acetic acid (weak acid) solution with sodium hydroxide, Tris, or sodium acetate (strong bases), to a pH₀ at the pKᵢ of the weak acid ion species i, with pKᵢ related to the dissociation constant Kᵢ as pKᵢ=−log₁₀ Kᵢ. High buffer capacity is achieved by a high concentration of the buffering species. High buffer capacity can maximize (or at least increase) the diffusion time T1′−T1, which can provide pH-independent voltage reference. To prevent the buffer solution from diffusing out of fluid cavity 408 during the long diffusion time, control device 412 can be closed during intervals when no voltage reference is required, e.g., during idle phases when no measurement is conducted by the IC. Selection of buffer chemistry and pH₀ is driven by the application.

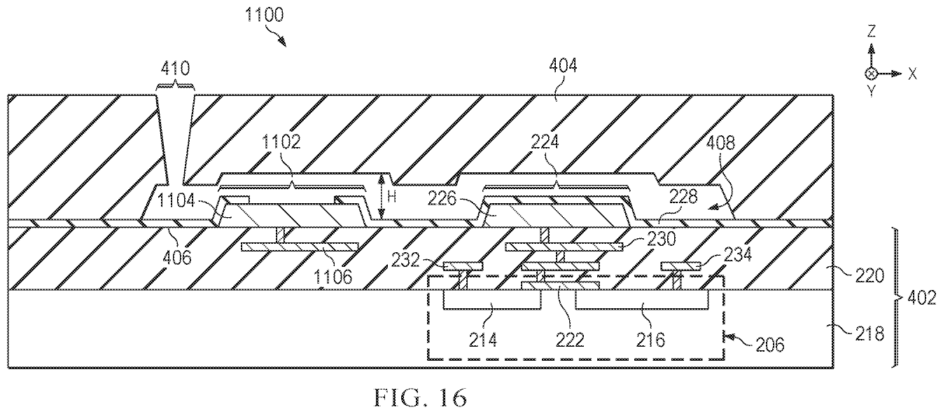

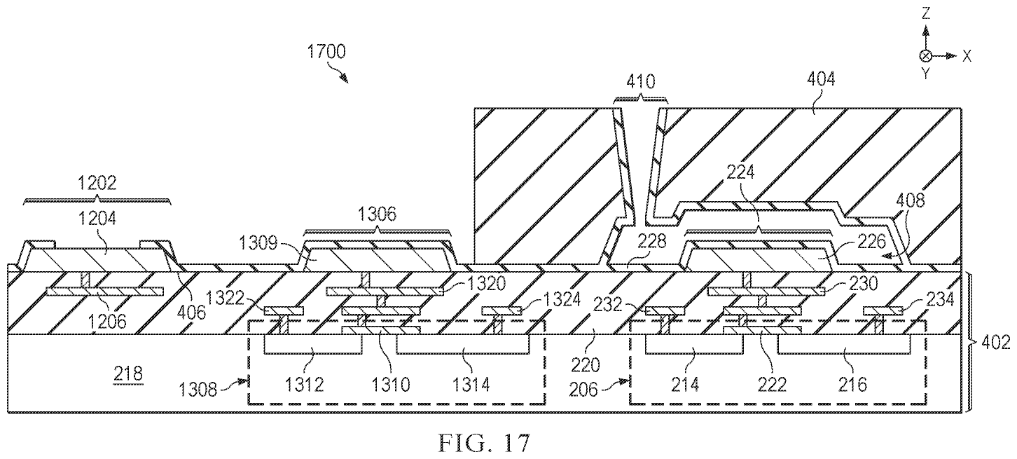

FIG. 16 and FIG. 17 are schematics illustrating examples of fluidic structure 404. FIG. 16 illustrates an example of fluidic structure 404 of microfluidic sensor 1100 of FIG. 11, and FIG. 17 illustrates an example of fluidic structure 404 of microfluidic sensor 1300 with voltage terminal 1202 external to fluidic structure 404.

Referring to FIG. 16, fluidic structure 404 can include an insulation material, such as Silicon Dioxide (SiO₂), Silicon Nitride (Si₃N₄), etc. Additional examples of insulation material can include Aluminum Oxide (Al₂O₃), Titanium Oxide (TiO₂), Tantalum pentoxide (Ta₂O₅), Silicon oxynitride (SiON), etc., and the insulation material can be doped with certain atoms such as Phosphorus and Boron (e.g., Borophosphosilicate glass (BPSG). In some examples, the insulation material can enclose a metal, such as Platinum and/or Titanium. In some examples, fluidic structure 404 can be formed on semiconductor die 402 as a passivation layer. In some examples, fluidic structure 404 can include a dielectric structure formed on another semiconductor die/wafer, and then transferred over onto semiconductor die 402. The height and thickness of fluidic structure 404 can define the height (H) of fluid cavity 408. The height and/or thickness of fluidic structure 404 may also vary to accommodate various internal structures in fluid cavity 408, such as sensor terminal 224 and voltage terminal 1102. In some examples, fluidic structure 404 can be planarized (e.g., by a chemical-mechanical polishing (CMP) operation) to include a planar surface. The planarization of fluidic structure 404 can improve the mechanical robustness of fluidic structure 404 and facilitate uniform flow of fluid across the planar surface. The planarization can also facilitate sealing in subsequent packaging steps. For example, in a case where fluidic structure 404 interfaces with a package, the planar surface can facilitate sealing of the interface with an elastomer like an o-ring.

Also, referring to FIG. 17, in some examples, the internal surface of fluid cavity 408 the sidewalls of opening 410, and sensing side 406 can be covered with the same insulation layer 228. Such arrangements can provide a uniform wetting surface. This can reduce measurement error caused by Zeta potential difference due to the fluid being measured/sensed is in contact with two different wetting surfaces. For the rest of the figures, illustration of insulation layer 228 covering the internal surface of fluid cavity 408 the sidewalls of opening 410 are omitted for brevity. In some examples, not shown here, the outer surface of fluid cavity may also be covered with insulation layer 228. In other examples, the outer surface intentionally is of different, e.g., hydrophobic material, so that fluid may be guided into the cavity more easily.

As explained above, after being exposed to a reference fluid, microfluidic sensor 1300 can perform differential sensing by restricting/delaying the diffusion of a new fluid into fluid cavity 408, so that two sensor terminals can be in contact with different fluids at the same time. Differential sensing can be performed prior to the new fluid reaching sensor terminal 224, such as between times T1 and T1′ of FIG. 15.

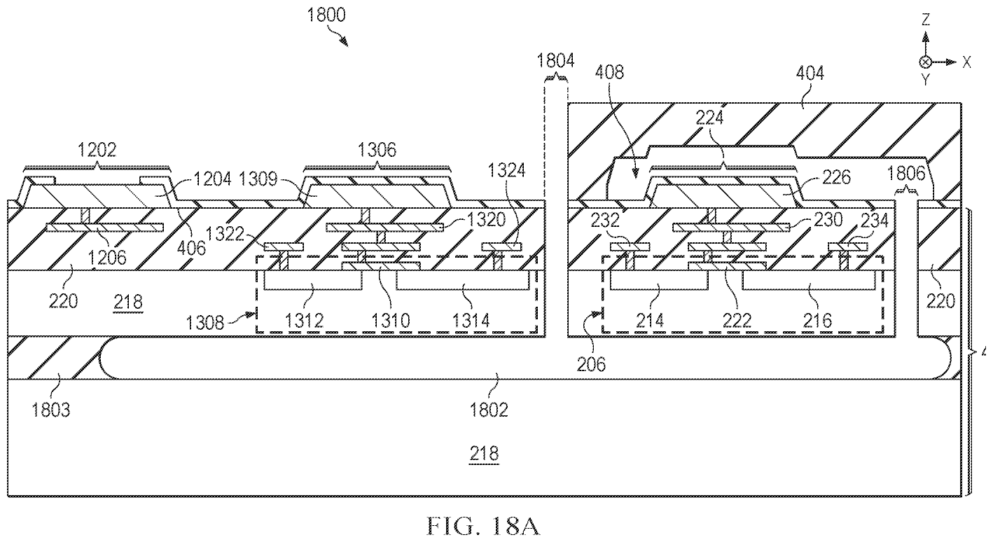

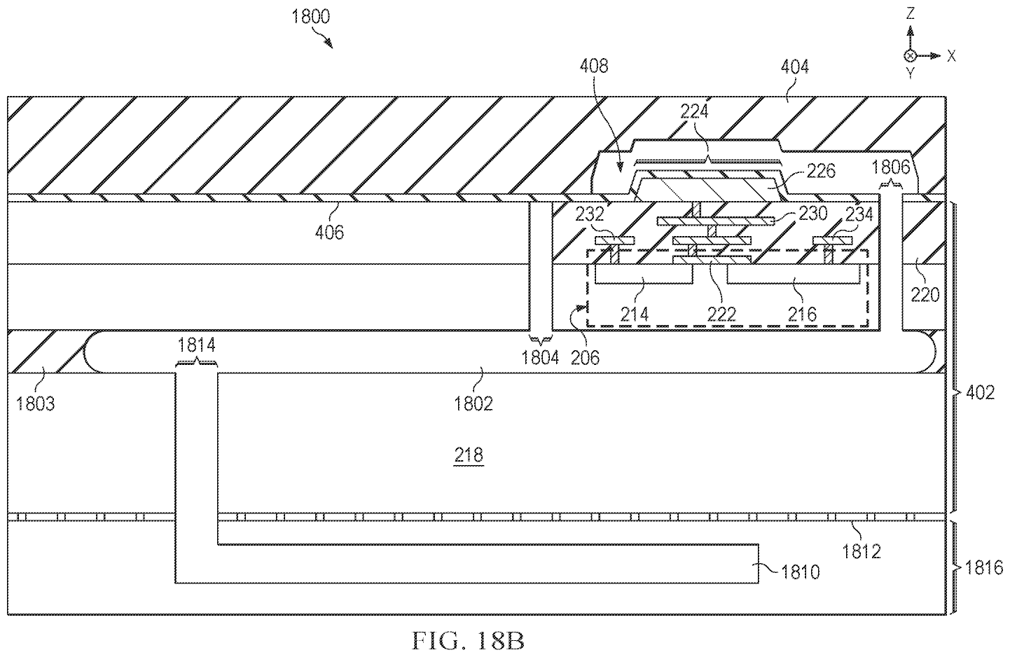

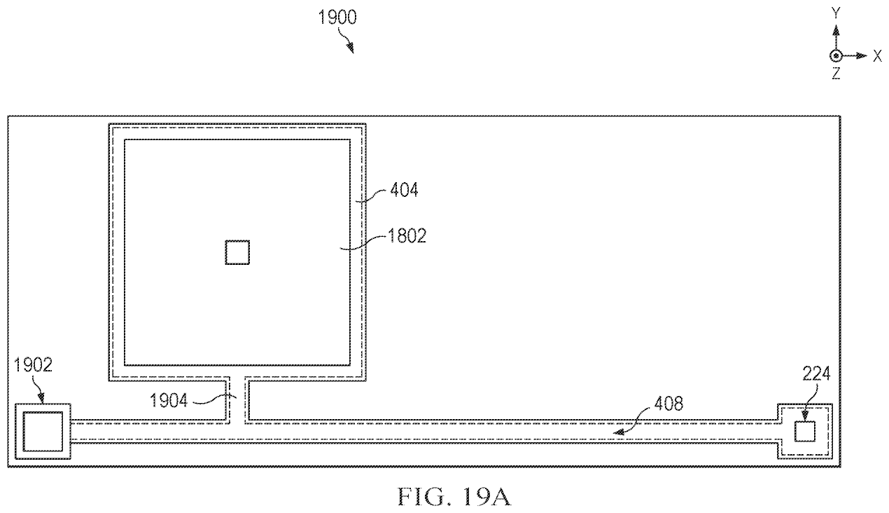

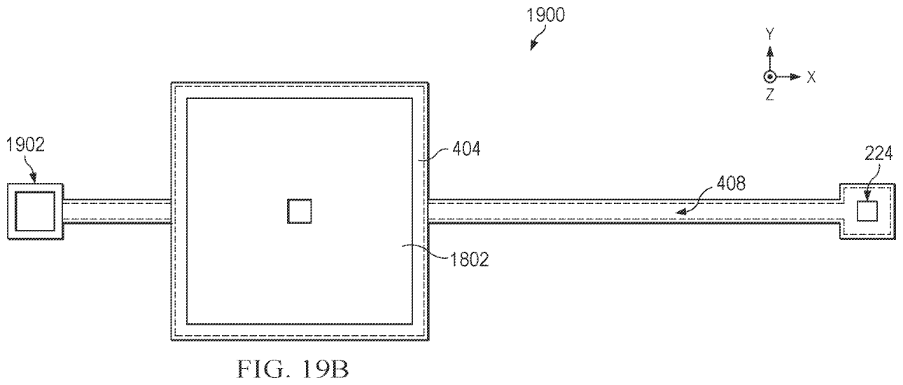

As explained above, one way to increase the diffusion time is to include a buffer solution having a high buffer strength in fluid cavity 408, and have the fluid diffuse/mix with the buffer solution. Another way to increase the diffusion time is by including an additional fluid cavity (e.g., a reservoir) between the opening and the sensor terminal to further delay the flow of the fluid to the sensor terminal. FIG. 18A, FIG. 18B, FIG. 19A, and FIG. 19B are schematics illustrating example microfluidic sensors that can further restrict/delay the diffusion of fluid into fluid cavity 408. FIG. 18A and FIG. 18B illustrate cross-sectional views of examples of microfluidic sensor 1800. FIG. 19A and FIG. 19B illustrate cross-sectional views of examples of microfluidic sensor 1900.

Referring to FIG. 18A, microfluidic sensor 1800 can be part of an integrated circuit having various components of microfluidic sensors of FIGS. 4-17, such as fluidic structure 404 on semiconductor die 402, the fluidic structure 404 enclosing fluid cavity 408, and sensor terminal 224 coupled to ISFET 206 and enclosed in fluid cavity 408. Microfluidic sensor 1800 also includes sensor terminal 1306 and voltage terminal 1202 on sensing side 406 of dielectric layer 220 and external to fluidic structure 404.

In addition, each of microfluidic sensors 1800 and 1900 includes a fluid cavity 1802 coupled to fluid cavity 408. Fluid cavity 1802 can be configured to provide an additional reservoir or buffer to store the reference fluid. By providing an additional reservoir or buffer, the time of diffusion of the new fluid into cavity 408 and reaching sensor terminal 224 can be further extended, which can provide more time to the ISFETs to perform the differential sensing.

In some examples, as shown in FIG. 18A, fluid cavity 1802 can be in substrate 218. For example, substrate 218 can be a silicon-insulator-silicon substrate and include an insulation layer 1803 (e.g., a layer of Silicon Dioxide) in substrate 218. Fluid cavity 1802 can be in insulation layer 1803 and below cavity 408, so that fluid cavities 408 and 1802 form a vertical stack. Microfluidic sensor 1800 also includes openings 1804 and 1806 on sensing side 406 through substrate 218 to fluid cavity 1802. Opening 1804 can be external to fluidic structure 404 to couple between fluid cavity 1802 and the exterior of fluidic structure 404, and opening 1806 can be below fluidic structure 404 to couple between fluid cavities 408 and 1802. A fluid can enter fluid cavity 1802 via opening 1804, and flow into cavity 408 via opening 1806.

In some examples, as shown in FIG. 18B, microfluidic sensor 1800 can include an additional reservoir 1810 on a side 1812 of semiconductor die 402 opposite from the sensing side 406. Semiconductor die 402 also includes an opening 1814 that extends between fluid cavity 1802 and 1810 through side 1812. In some examples, sensing side 406 can be a front side of semiconductor die 402, side 1812 can be a back side of semiconductor die 402. Microfluidic sensor can include a glass wafer 1816 (or a glass structure) enclosing reservoir 1810 mounted on side 1812, which can provide a planar surface for mounting glass wafer 1816.

In some examples, as shown in FIG. 19A, fluid cavity 1802 can be positioned laterally relative to cavity 408 on sensing side 406 of dielectric layer 220, and both fluid cavities 408 and 1802 can be enclosed by fluidic structure 404. In the example of FIG. 19, fluidic structure 404 can include an opening 1902 over a first end of fluid cavity 408, and a fluid conduit structure (or a connection structure) 1904 coupled between fluid cavities 1802 and 408. Sensor terminal 224 can be on a second end of fluid cavity 408 opposite to the first end, and fluid conduit structure 1904 can be between opening 1902 and sensor terminal 224 to delay the flow of fluid to sensor terminal 224. In some examples, as shown in FIG. 19B, fluid cavity 1802 can be directly between opening 1902 and sensor terminal 224. In some examples, fluid cavity 1802, openings 1804, 1806, and 1902, and fluid conduit structure 1904 can have dimensions at the microscale, so that the fluid can move into fluid cavity 1802 and cavity 408 by microfluidic diffusion.

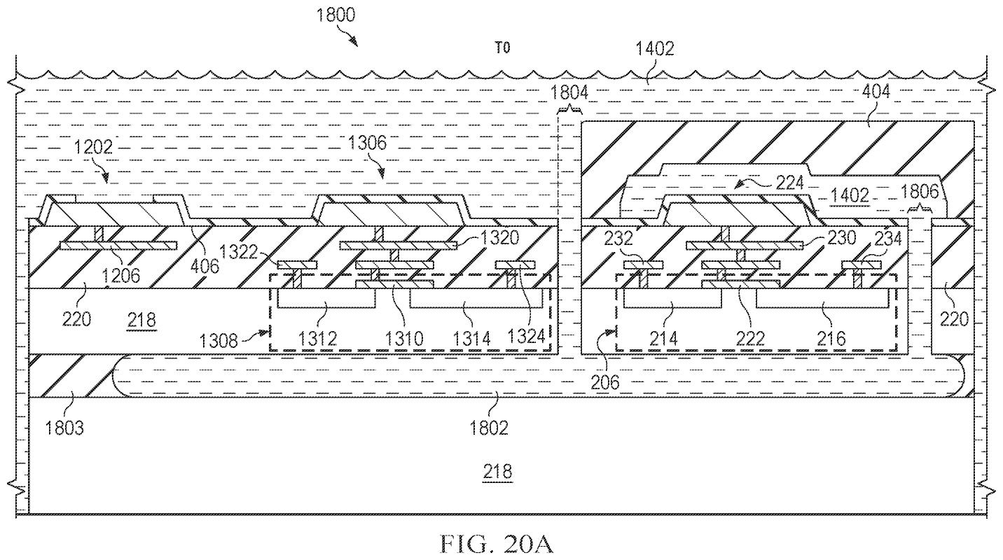

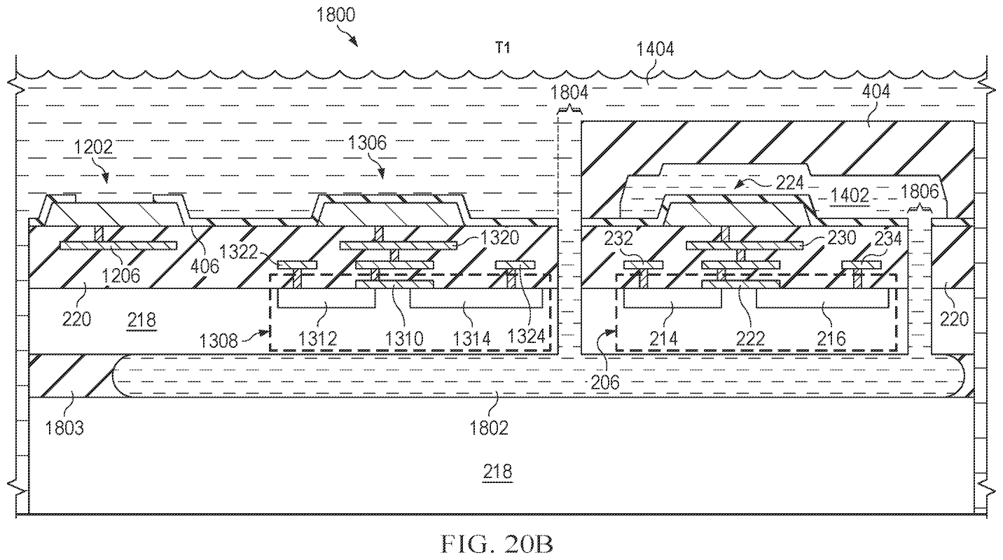

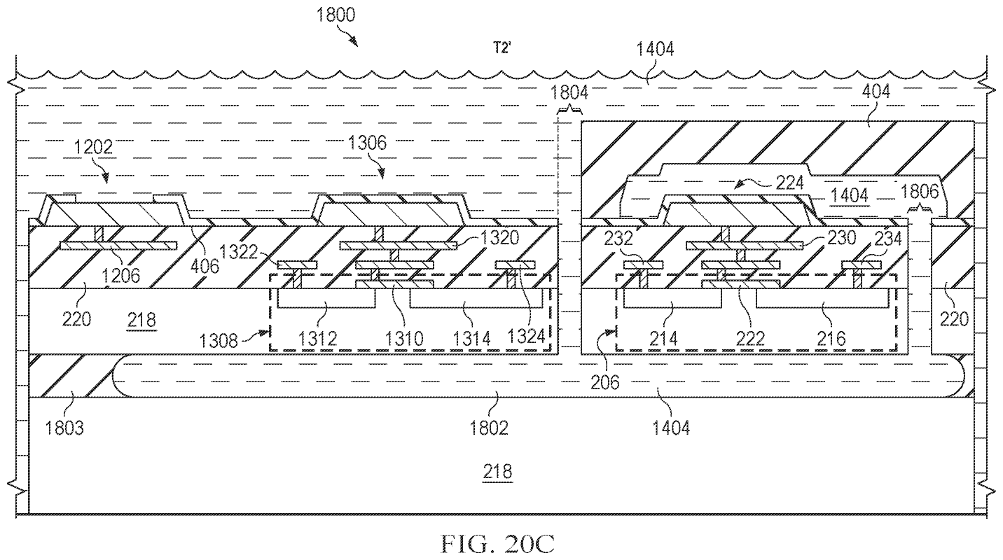

FIGS. 20A, 20B, and 20C illustrate an example sequence of operations of microfluidic sensor 1800 in performing differential sensing. Microfluidic sensor 1800 can be positioned in a fluid container, such as fluid container 104. Referring to FIG. 20A, at time T0, fluid container 104 may carry reference fluid 1402 with known pH, and fluid cavities 1802 and 408 are both filled with fluid 1402. Referring to FIG. 20B, at time T1, fluid 1402 in fluid container 104 can be replaced with new fluid 1404 for which the pH is to be measured. Sensor terminal 1306 comes into contact with new fluid 1404. But at that time both fluid cavities 1802 and 408 are still filled with fluid 1402. Accordingly, fluidic structure 404 and fluid cavity 1802 can stop new fluid 1404 from reaching sensor terminal 224 at time T1. New fluid 1404 can start diffusing into fluid cavity 1802 via opening 1804 and from fluid cavity 1802 to fluid cavity 408 via opening 1806. Referring to FIG. 20C, at time T2′, which can be much later than time T2 of FIG. 15, new fluid 1404 reaches cavity 408 and comes into contact with sensor terminal 224. The time difference between T1 and T2′ can be provided to ISFETs 206 and 1308 to perform the differential sensing.

In addition to pH measurement, a microfluidic sensor having an integrated microfluidic cavity (e.g., fluid cavity 408) can perform other operations involving microfluidic diffusion, such as detecting/measuring multiple types of ions in a fluid, mixing of fluids, measuring the strength of a buffer solution, separation of ions, etc.

FIG. 21 is a schematic illustrating an example microfluidic sensor 2100 that can detect/measure activities of a mixture of fluids. Referring to FIG. 21, microfluidic sensor 2100 can be an integrated circuit having various aforementioned components of a microfluidic sensor, such as fluidic structure 404 on semiconductor die 402, with the fluidic structure 404 enclosing fluid cavity 408 and including opening 410. Microfluidic sensor 2100 also includes sensor terminal 224 in fluid cavity 408, and ISFET 206 coupled to sensor terminal 224. In some examples, microfluidic sensor 2100 can include voltage terminal 1202 on sensing side 406 and external to fluidic structure 404. In some examples, microfluidic sensor 2100 may also include a reference electrode (e.g., reference electrode 1002) separated from semiconductor die 402.

In addition to ISFET 206, microfluidic sensor 2100 also includes an ISFET 2104 in semiconductor die 402. ISFET 2104 includes current terminals 2106 (e.g., a source terminal) and 2108 (e.g., a drain terminal), and a gate terminal 2110 in dielectric layer 220 and separated from substrate 218. Microfluidic sensor 2100 includes a sensor terminal 2120 on dielectric layer 220 and in fluid cavity 408. Sensor terminal 2120 can include an electrode 2122 covered with insulation layer 228. Electrode 2122 can be made of Platinum (or other noble metals) and can be coupled to gate terminal 2110 via an interconnect 2130, and drain and current terminals 2106 and 2108 each can be coupled to respective interconnects 2132 and 2134. Interconnects 2130, 2132, and 2134 can be part of a metallization structure including interconnects 230, 232, and 234 and encapsulated (or surrounded) by dielectric layer 220. In some examples, microfluidic sensor 2100 can include more than two sensor terminals in fluid cavity 408, and more than two ISFETs coupled to the respective sensor terminals.

In some examples, microfluidic sensor 2100 can support the aforementioned differential sensing operation, where sensor terminal 2120 is much closer to opening 410 than sensor terminal 224 and can sense a change in the electrical potential due to change of fluid than sensor terminal 224. Accordingly, sensor terminal 2120 can provide similar function as sensor terminal 1306 of FIG. 13. Also, in some examples, microfluidic sensor 2100 enables more precise detection/measurement of mixing dynamics of different fluids by providing sensor terminals at different diffusion distances from opening 410. As described above, the mixing of fluids can depend on multiple variables, such as ionic strength and pH difference, difference of concentration (activity) and mobilities of ionic species, and buffer capacity. For example, in microfluidic sensor 2100, sensor terminal 2120 is closer to opening 410 than sensor terminal 224. Such arrangement creates a shorter diffusion distance between opening 410 and sensor terminal 2120 than between opening 410. Each ISFET having a corresponding sensor terminal at a certain spatial location in fluid cavity 408, and can sense/measure a potential representing pH and liquid junction potential. When a new fluid 1404 is introduced, different ions can have different rates of diffusion in fluid cavity 408, and may arrive at the same sensor terminal at different times. As a mixture of different types of ions propagate within fluid cavity 408 to reach different sensor terminals, the local pH of the mixture of both fluids on top of each ISFET can vary over time. This spatiotemporal signature may ultimately be unique enough to be able to uniquely estimate concentrations of certain ionic species in the fluid mixture in fluid cavity 408, given a certain application.

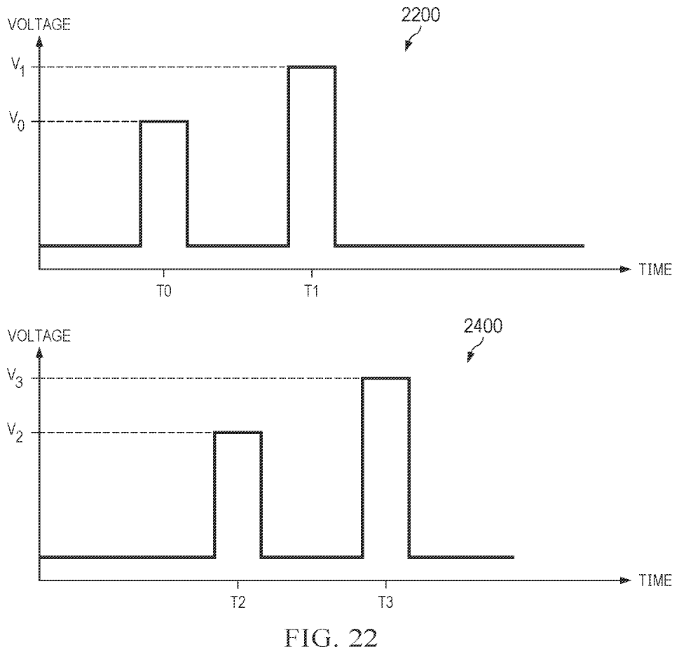

In certain instances, such as sequential introduction of fluids into cavity 408, or during application of electrochemical separation techniques such as electrophoresis, sensors can indicate concentration of certain particles/ions. FIG. 22 illustrates graphs 2202 and 2204 representing example output voltages of ISFETs 2104 and 206 in measuring a fluid including a mixture of two unknown types of ions. Graph 2202 can represent the example output voltage of ISFET 2104, and graph 2204 can represent the example output voltage of ISFET 206. Referring to graph 2202, at times TO and T1, a potential difference V0 and V1 arising from a sharp concentration gradient of a known species of particles/ions at location ISFETs 2104 can be detected and, e.g., due to the controlled nature of the experiment, associated with a known species of particles/ions. Similarly, referring to graph 2204, at times T2 and T3, a potential difference V2 and V3 arising from a sharp concentration gradient of a known species of particles/ions at location ISFETs 206 can be detected.

A data processor (e.g., part of controller 106) can correlate between the voltage peaks sensed by ISFETs 206 and 2104 and determine that voltage peaks of V0 and V2 represent a first type of ion and voltage peaks of V1 and V3 represent a second type of ions, based on the voltage peaks of V0 and V1 having a similar magnitude and timing relationship as the voltage pulses of V2 and V3. The data processor may also compute the diffusion rate for each type of ions based on the time differences between the voltage pulses, and identify the type of ion based on the computed diffusion rate. The described potential differences or peaks may give an indication of the concentration of these two species, and may arise due to a pH gradient and/or liquid junction potential gradients such as described later, or as can be achieved by surface (bio-) functionalization such as salinization, deposited ion-selective membranes, or similar techniques.

In the example of FIG. 21, sensor terminals 2120 and 224 are positioned on the same side of opening 410 and along a diffusion path in fluid cavity 408 to provide different diffusion distances. FIG. 23 illustrates additional examples of arrangements of sensor terminals 2120 and 224 to provide different diffusion distances. In FIG. 23, the fluidic sensor can include a discrete or integrated reference electrode (e.g., reference electrode 204), or can include an integrated electrode (e.g., voltage terminals 1102 and 1202) to support differential sensing, both of which are not shown in FIG. 23 for brevity. FIG. 23 include schematics illustrating plan view of two additional examples of microfluidic sensors 2100. Referring to the left schematic of FIG. 23, fluidic structure 404 of microfluidic sensor 2100 can enclose two separate fluid cavities 408a and 408b and include two openings 410a and 410b. Opening 410a extends to fluid cavity 408a, and opening 410b extends to fluid cavity 408b. Also, referring to right schematic of FIG. 23, fluidic structure 404 of microfluidic sensor 2100 can enclose a fluid cavity 408a and include an opening 410, with sensor terminals 224 and 2120 on opposite sides of opening 410. In both examples, sensor terminal 224 can be spaced from opening 410a by a distance of D1, and sensor terminal 2120 can be spaced from opening 410b by a distance of D2, with D2 greater than D1. The different separation distances between the opening and the sensor terminals can provide different diffusion distances.

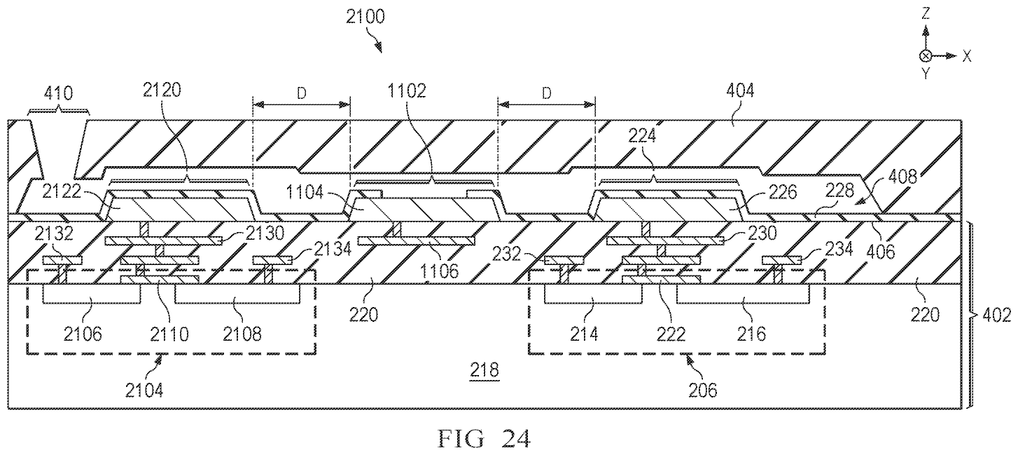

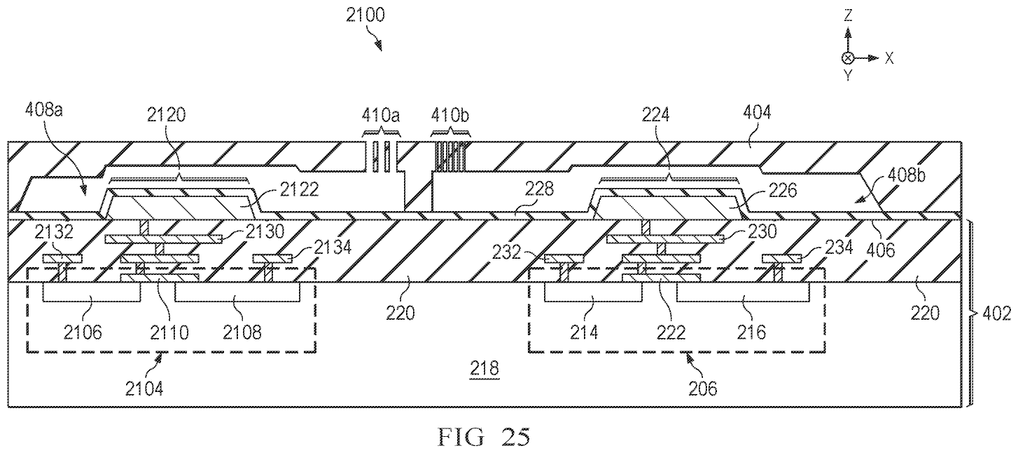

Also, in the example of FIG. 21, microfluidic sensor 2100 includes voltage terminal 1202 external to fluidic structure 404 (and fluid cavity 408). FIG. 24 illustrates an example of microfluidic sensor 2100 having voltage terminal 1102 (and electrode 1104) in fluid cavity 408. Voltage terminal 1102 can be positioned between sensor terminals 224 and 2120. In some examples, voltage terminal 1102 can be of equal distance (labelled D in FIG. 24) from each of sensor terminals 224 and 2120. Such symmetrical arrangements can cancel certain potential differences (such as so-called tip potentials commonly found in patch clamp experiments) between sensor terminals 224 and 2120, which can further improve the accuracy of measurements provided by ISFETs 206 and 2104.

In some examples, to facilitate separate measurement of multiple types of ions, fluidic sensor 2100 can include filtering mechanisms to separate between ions of different types (e.g., different sizes, different charge, etc.). In some examples, the filtering mechanism can be configured such that only ions of a particular type (e.g., having a particular size, charge, etc.) will be detected and measured.

FIGS. 25, 26A, 26B, 26C, 27, and 28 are schematics illustrating examples of microfluidic sensor 2100 including additional filtering (or flow control) mechanisms. In FIGS. 25, 26, 27, and 28, voltage terminals 1102/1202 (and/or reference electrodes) are omitted for brevity. Referring to FIG. 25, fluidic structure 404 can enclose separate fluid cavities 408a and 408b. Sensor terminal 224 can be enclosed in fluid cavity 408a, and sensor terminal 2120 can be enclosed in fluid cavity 408b. Fluidic structure 404 also includes an opening 410a that extends to fluid cavity 408a, and an opening 410b that extends to fluid cavity 408b. Openings 410a and 410b can have different widths to allow ions of certain charge or size to enter the respective fluid cavities 408a and 408b. In the example of FIG. 25, each of openings 410a and 410b can include a sieve/mesh structure, and each sieve opening 410a is wider than each sieve opening 410b. Accordingly, relatively large ions/particles can enter fluid cavity 408a via opening 410a, while only relatively small ions/particles can enter fluid cavity 408b. The effect of steric exclusion can prevent larger molecules, especially non-spherical macromolecules from entering a nanofluidic channel in the fluid cavity, as to be described below. In that way, the differential signal between fluid sensor 224 and 2120 can represent the potential (pH) difference created by “sieving” out certain ions or molecules of a certain charge or size.

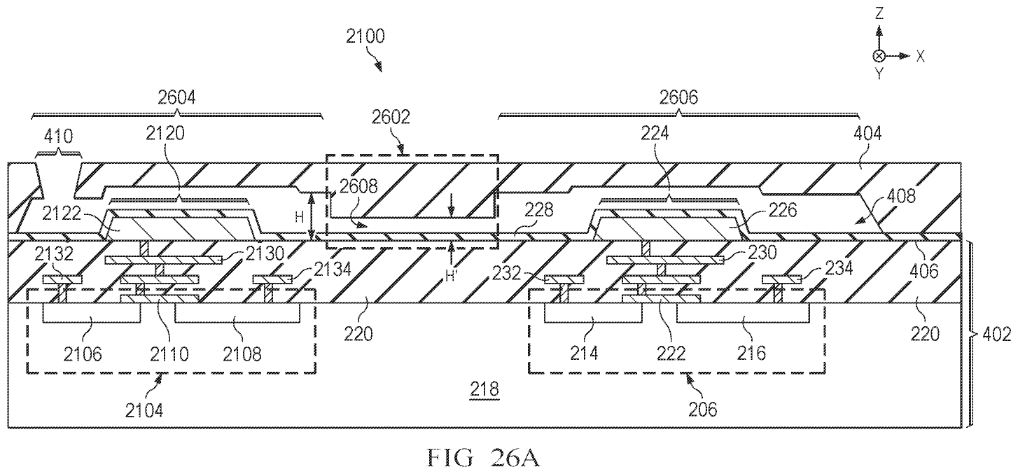

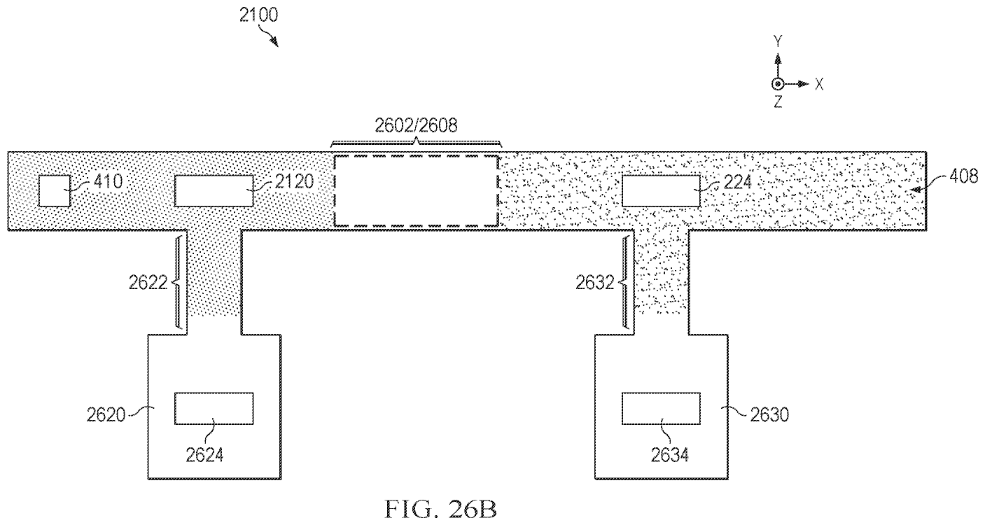

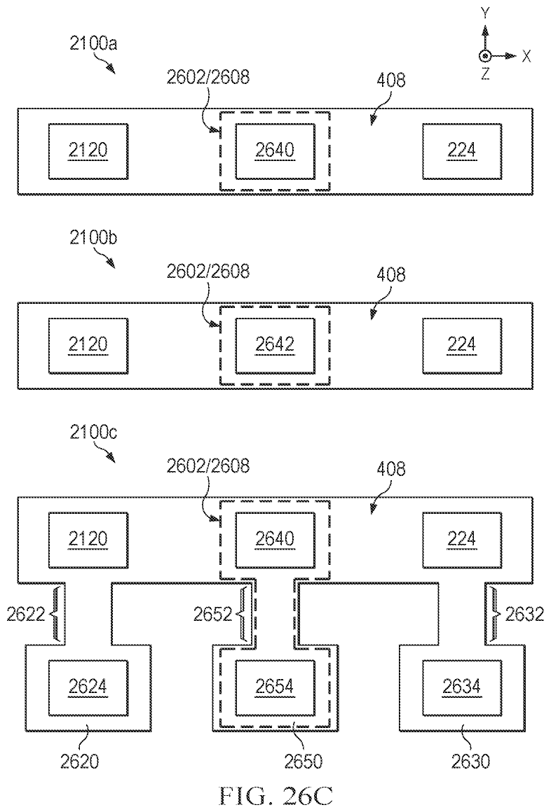

Also, in FIG. 26A, fluidic structure 404 can include a fluidic structure 2602 coupled between a first portion 2604 of fluid cavity 408 and a second portion 2606 of fluid cavity 408, where sensor terminal 2120 is enclosed in first portion 2604 and sensor terminal 224 is enclosed in second portion 2606. Fluidic structure 2602 can define a channel 2608 having a reduced dimension (e.g., height H′) compared with the dimension of the rest of fluid cavity 408 (e.g., height H). The dimension of fluidic structure 2602 can be configured so that ions or particles exceeding a particular size (referring to the hydrated ion) and/or of particular charge can remain in first portion 2604 of fluid cavity 408, and ions smaller than the particular size or of different charge can propagate to second portion 2606 of fluid cavity 408 via diffusion. The same restriction can also be achieved by vertical integration of openings of different size, such as in FIG. 25. The opening size is hence analogous to the reduced dimension H′.

In some examples, channel 2608 can be a nanofluidic channel, where nanofluidic effects start to play a role when electric double layers at the fluid-dielectric interface start to overlap. These effects should no longer be neglected when the dimension of the electric double layers, given by Debye length (the length where surface electrical potentials are shielded by a factor of 1/e with elemental charge e), is larger than 20*H′. With greater ionic strength, the Debye length decreases. For 1 mM NaCl, the Debye length is approximately 10 nm, and for physiological solutions of 150 mM ionic strength, it is approximately 0.7 nm. In some examples, channel 2608 can have a dimension at the nanoscale (e.g., 0.5-500 nanometers) to provide a nanofluidic channel (or a nanochannel). Sensor terminals 2120 and 224 can provide a measurement of a potential difference across the nanofluidic channel, and the potential difference can represent the change of a gradient (e.g., a potential gradient, a pH gradient, etc.) with time as the fluid propagate through the nanofluidic channel.

FIG. 26B is a schematic illustrating a plan view of another example of microfluidic sensor 2100. As shown in FIG. 26B, microfluidic sensor 2100 can include a reservoir 2620 and a reservoir 2630. Reservoir 2620 can be coupled to part of cavity 408 having sensor terminal 2120 via a fluid conduit structure 2622, and reservoir 2630 can be coupled to part of cavity 408 having sensor terminal 224 via a fluid conduit structure 2632. Microfluidic sensor 2100 also includes sensor terminals 2624 and 2634 in the respective reservoirs 2620 and 2630. Sensor terminals 2624 and 2634 can be coupled to respective ISFETs (not shown in FIG. 26B). Reservoirs 2620 and 2630, and sensor terminals 2624 and 2634, can be on sensing side 406 and are enclosed in fluidic structure 404. Reservoir 2620 and fluid conduit structure 2622 can be a split-off reference channel from fluid cavity 408, and reservoir 2630 and fluid conduit structure 2632 can be another split-off reference channel from fluid cavity 408.

Both reservoirs 2620 and 2630 can hold a fluid similar in its properties to the described fluid 1402 of FIG. 14, such as a reference buffer of high ionic strength, high concentration of K+ and Cl-ions, and stable pH_{Ref}. The fluid to be measured, after entering through opening 410, can diffuse through fluid conduit structures 2622/2632 and mix with the reference fluid or reference buffer in fluid cavity 408. As described in FIG. 14, such arrangements provide a pH-independent voltage reference, and can hence here in FIG. 26B be used to measure the potential difference in the fluid on the two ends of the nanofluidic structure 2602, which allows a more precise measurement of the potential difference in the fluid across the nanofluidic structure 2602. Specifically, differential sensing can be performed to measure a first pH difference between sensor terminals 2120 and 2624, and to effectively measure a pH difference between sensor terminals 224 and 2634:

$${V}_{pH 0} = {V}_{2624} - {V}_{2120} = b \times S \times ( {pH}_{Ref} - {pH}_{0} ) \qquad ( Equation 7 )$$

$${V}_{pH 1} = {V}_{2634} - {V}_{224} = b \times S \times ( {pH}_{Ref} - {pH}_{1} ) \qquad ( Equation 8 )$$

Because there is negligible liquid junction potential at the boundaries to the KCl containing reference buffer, the potential difference V_{D} can be measured. An additional term V_{NF} may arise due to a potential gradient across the nanofluidic structure 2602 and add to the liquid junction potential V_{LJP} of the two fluids in fluid cavity 408 separated by 2602:

$${V}_{D} = {V}_{2624} - {V}_{2634} = b \times ( {V}_{LJP} + {V}_{NF} ) \qquad ( Equation 9 )$$

The potential difference across the nanofluidic structure 2602 can be based on a difference between the first and second potential differences, and the liquid junction potential component can be eliminated or at least attenuated in the difference.

FIG. 26C are schematics illustrating the plan view of additional examples of microfluidic sensors 2100a, 2100b, and 2100c having nanofluidic channel 2608. In FIG. 26C opening 410 is omitted for brevity. Reference electrode (if included) is also omitted for brevity. Referring to FIG. 26C, sensor 2100a can include a control terminal 2640 in nanofluidic channel 2608. Control terminal 2640 can include an electrode 2704 covered by insulation layer 228. Electrode 2704 can be made of Platinum and can be coupled to a signal generator circuit (not shown) via an interconnect 2706, which can be part of the metallization structure in dielectric layer 220. The signal generator circuit can be in semiconductor die 402 or can be external to the integrated circuit of microfluidic sensor 2100.

In some examples, control terminal 2640 can perform a filter operation by repelling ions of a particular size and/or polarity, to control the size and/or polarity of ions that flow across nanofluidic channel 2608 and measured by sensor terminals 224 and 2634. Control terminal 2640 can receive a DC voltage to generate an electric field to repel ions of a particular polarity. For example, if the control terminal 2640 receives a negative potential, it can generate an electric field to repel negative ions (e.g., anions such as Chloride (Cl−), Bromide (Br−), or Sulfate (SO42−) and prevent those negative ions from reaching sensor terminal 224, and those negative ions can be sensed by sensor terminal 2120. Also, if control terminal 2640 receives a positive potential, it can generate an electric field to repel positive ions (e.g., cations Sodium (Na+), Iron (Fe2+), Ammonium (NH4+)) and prevent those positive ions from reaching sensor terminal 224, and those positive ions can be sensed by sensor terminal 2120.

Also, microfluidic sensor 2100b can include a sensor terminal 2642 (coupled to an ISFET not shown in the figures) in nanofluidic channel 2608. Sensor terminal 2642 can provide measurement of a potential in nanofluidic channel 2608.

Further, microfluidic sensor 2100c can include a reservoir 2650 in addition to reservoirs 2620 and 2630 of FIG. 26B. Reservoir 2650 can be coupled to nanofluidic reference channel 2602 via a fluid conduit structure 2652, which can be a nanofluidic opening, and reservoir 2650 can also hold a 3M KCl solution to reduce/eliminate the effect of liquid junction potential. Microfluidic sensor 2100c can include a sensor terminal 2654 coupled to an ISFET (not shown in FIG. 26C) to provide differential sensing between sensor terminals 2640 and 2654, and the liquid junction potential component in the potential difference measured by sensor terminals 2640 and 2654 can be eliminated/attenuated by the mixing of the 3M KCl solution with the fluid(s) in nanofluidic channel 2608. Reservoir 2650 and fluid conduit structure/nanofluidic channel 2652 can form a split-off reference channel from nanofluidic channel 2608.

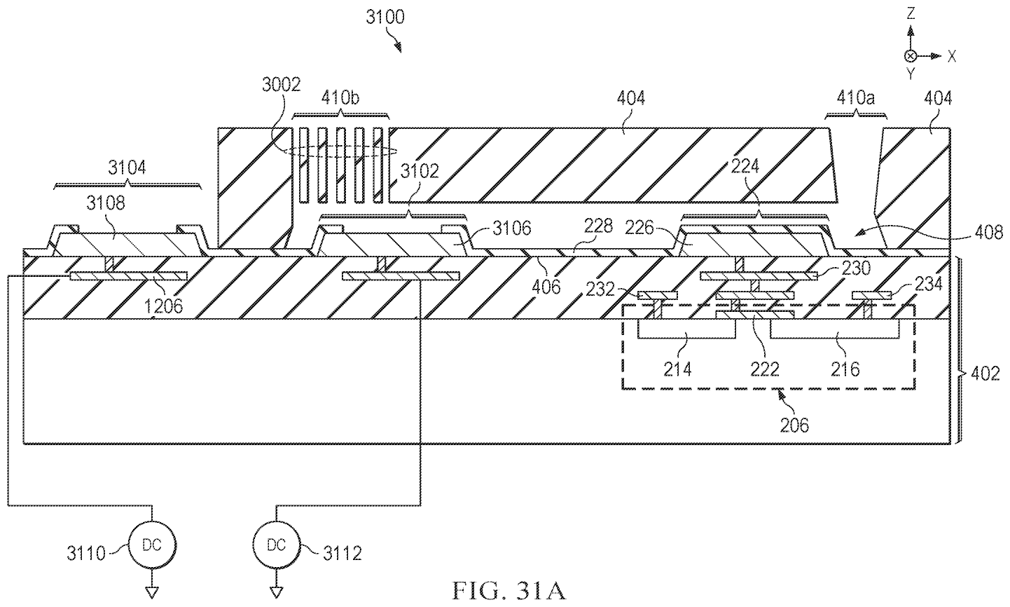

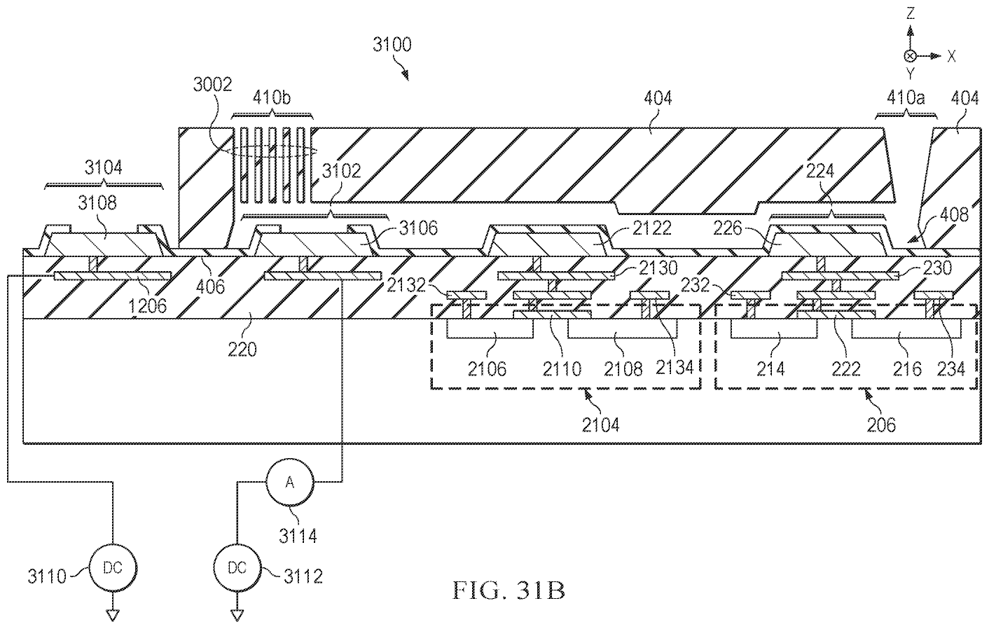

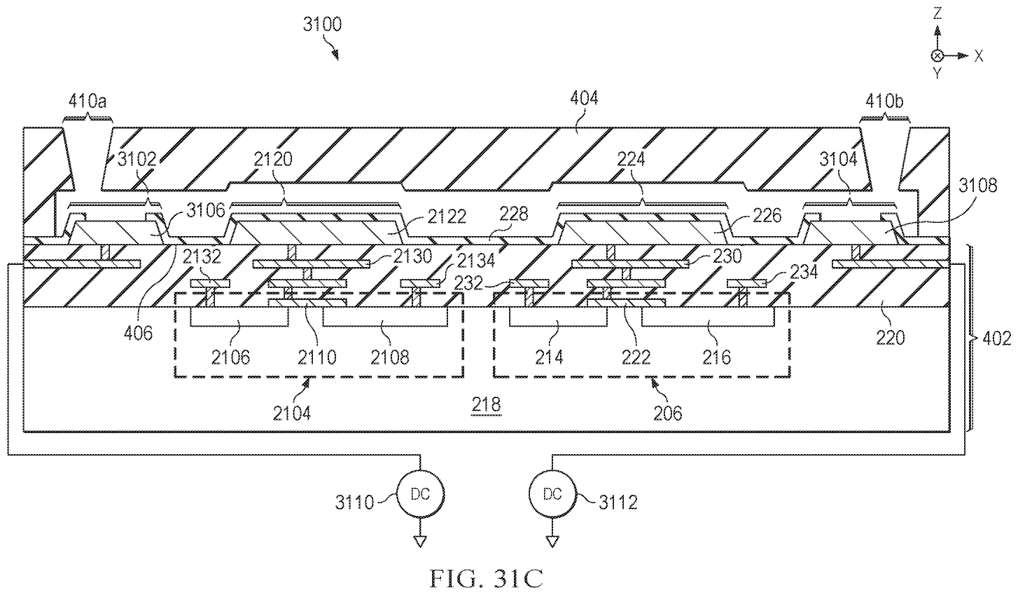

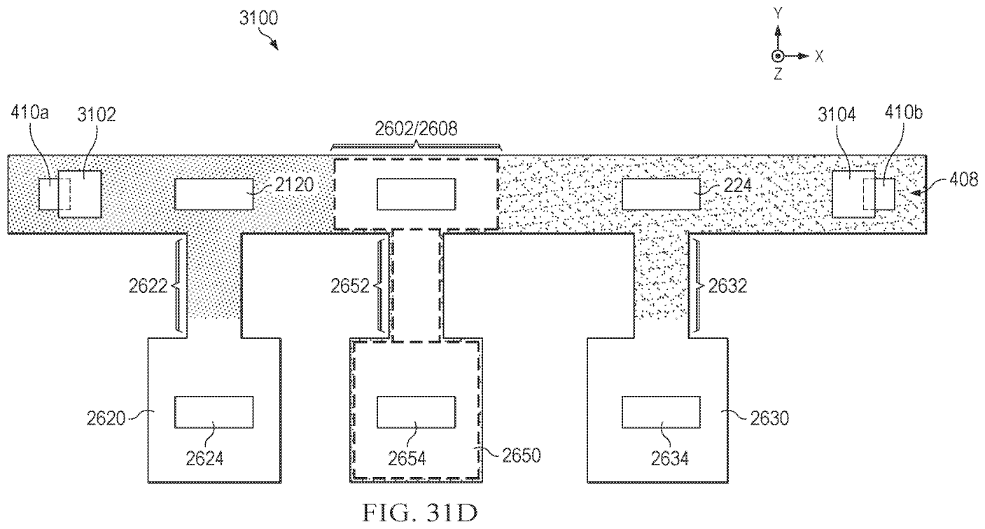

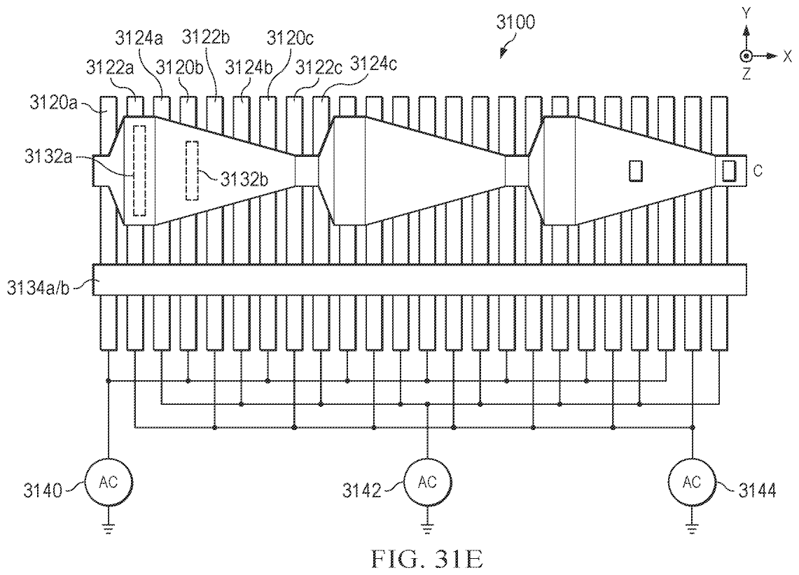

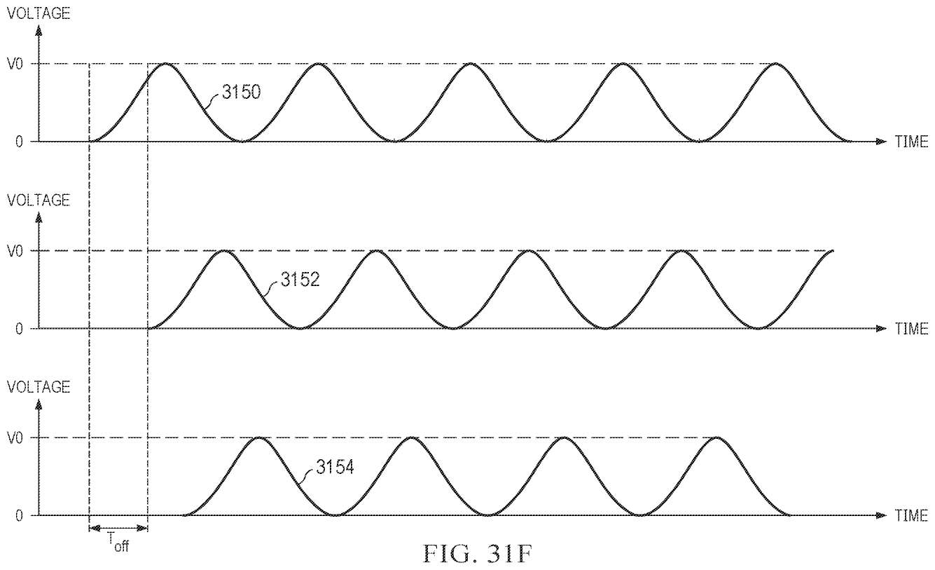

In some examples, control terminal 2640 can operate as a nanofluidic diode and generate an electric field that alters the Zeta potential between the electrode of control terminal 2640 and the fluid in fluid cavity 408, which in turn alters the force experienced by the ions in the fluid and modulates the flow of the ions in fluid cavity 408, which can create electrochemical gradients. In some examples, surface modulation, such as heterogeneous surfaces of different zeta potential, can also introduce rectifying effect as a voltage gated nanofluidic diode. In some examples, given an applied external electric field across the cavity 408, microfluidic sensor 2100 can operate as a flowFET or nanofluidic transistor such as shown below in FIG. 31D.

From an electrochemical standpoint, a nanofluidic diode can have similar (or identical) properties as a permselective membrane, which can include an organic porous membrane having a set of nanofluidic channels that limit diffusion of certain ionic species. A potential difference can be created between the cavities separated by the nanofluidic diode. This potential difference can be a Donnan potential, and can arise since certain ionic species are restricted from diffusing through the nanofluidic diode. The ISFETs coupled to 2624 and 2634 in FIG. 26B at the ends of fluid conduit structures 2622 and 2632 can measure the Donnan potential manifesting as V_{NF} of equation (9). In some examples, fluidic sensor 2100 can include an organic permselective membrane, such as a Nafion™ membrane, or an ionophore permeable only to certain ions (e.g., potassium or sodium). Such an organic permselective membrane may be locally arranged on top of or inside of a channel opening, or inside of the fluidic cavity 408, so that the Donnan potential V_{NF} can be measured in the described fashion. Biomimetic solid-state voltage-gated ion (or larger, e.g., bio-molecule) channels similar to biological nerve fibers can also be constructed by means of nanofluidic diodes (either vertically or laterally integrated), where ion impulses can create action potentials which are measurable in patch clamp experiments using micro-pipettes. Spatiotemporal potential measurement inside of such nanofluidic channels can be performed using split-off microfluidic reference channels and the ISFETs at the split-off channels in examples shown in FIGS. 26B and 26C. In both cases, an ISFET in the reservoir with a reference buffer (e.g., 3M KCl containing solution) at its end measures reference voltages, and the voltage can be pH-independent. The differential signal between an ISFET inside of a nanochannel of changing ionic content (due to mixing of fluids) and an ISFET inside of a connected, long nanochannel of non-changing ionic content (of the reference fluid) can give indication of the pH-independent potential inside of the nanofluidic channel 2608.

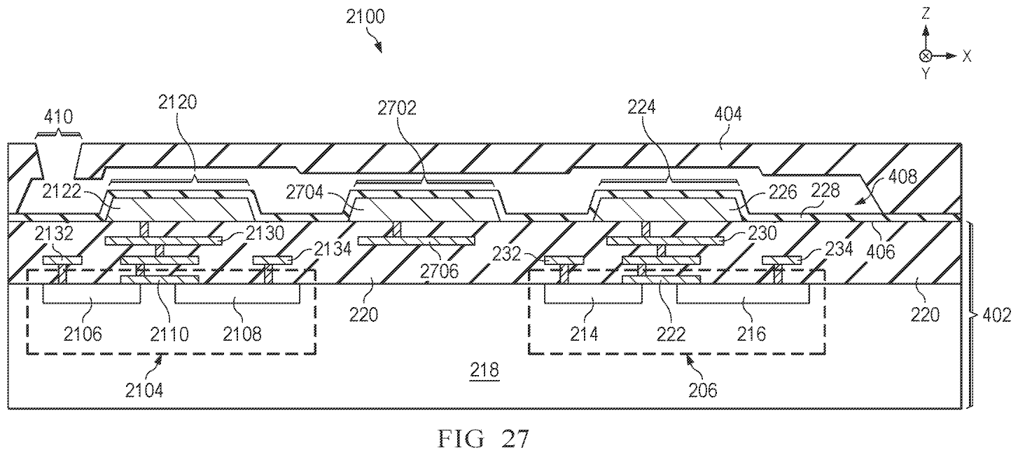

FIG. 27 is a schematic illustrating an example of microfluidic sensor 2100 having a control terminal 2702 on sensing side 406 and between sensor terminals 2120 and 224. The height of fluid cavity 408 above control terminal 2702 can be the same as other parts of fluid cavity 408, and control terminal 2702 can be in a microfluidic channel. Control terminal 2702 can include an electrode 2704 covered by insulation layer 228. Electrode 2704 can be made of Platinum and can be coupled to a signal generator circuit (not shown) via an interconnect 2706, which can be part of the metallization structure in dielectric layer 220. The signal generator circuit can be in semiconductor die 402 or can be external to the package integrated circuit of microfluidic sensor 2100. Control terminal 2702 can receive a DC voltage to repel ions of particular polarity and control the polarities of ions that propagate through the microfluidic channel and measured by sensor terminals 2120 and 224, as explained above.

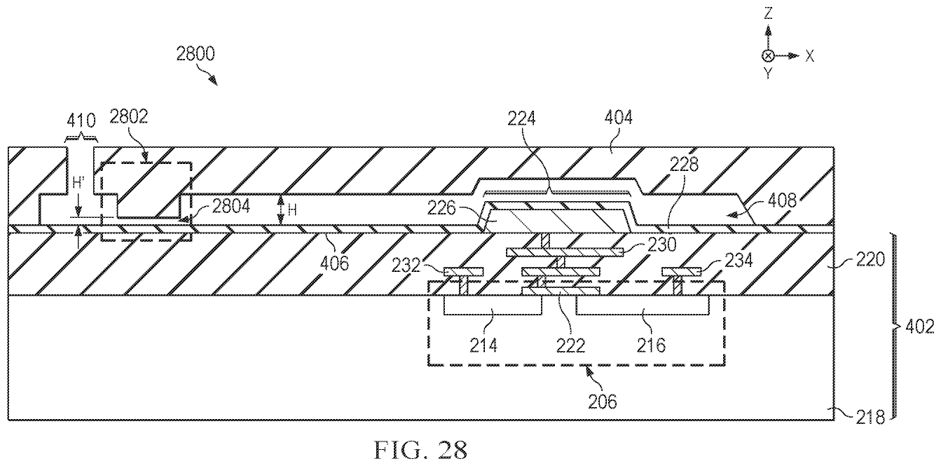

The aforementioned example filter mechanisms can also be implemented in a microfluidic sensor including a sensor terminal in fluid cavity 408, such as microfluidic sensors described in FIGS. 4-16. FIG. 28 is a schematic illustrating an example microfluidic sensor 2800, which is an integrated circuit and includes fluidic structure 404 enclosing fluid cavity 408. Reference electrode (if included) or electrodes for differential sensing are omitted in FIG. 28 for brevity. Microfluidic sensor 2800 also includes sensor terminal 224 in fluid cavity 408. Microfluidic sensor 2800 also includes a fluidic structure 2802 that defines a channel 2804 having a reduced dimension (e.g., height H′) compared with the rest of fluid cavity 408. Fluidic structure 2802 can allow ions smaller than a particular size and/or charge to reach sensor terminal 224 and prevent (or restrict) ions larger than the particular size from reaching sensor terminal 224. In some examples, the size of opening 410 can be configured to allow ions of a particular size and/or charge to enter cavity 408 and reject ions larger than the particular size. Also, in some examples, fluidic structure 2802 can be replaced by (or combine with) field effect terminal 2702 of FIG. 27, which can provide an electric field to modulate the flow of ions through fluid cavity 408. In some examples, microfluidic sensor 2800 can include a sensor terminal and an ISFET below channel 2804 (not shown in FIG. 28) to measure the potential in channel 2804.

In some examples, a microfluidic sensor can include a pair of openings in fluidic structure 404 extending to a same fluid cavity 408. Multiple ISFETs can be positioned between the two openings. Examples of such a microfluidic sensor can also include circuits to perform various operations, such as to control the flow of fluid between the inlet and the outlet in fluid cavity 408, to perform calibration, to perform an electrophoresis operation to separate ions in the fluid, to perform an impedance spectroscopy operation, etc. In some examples, having multiple openings (e.g., two openings) can speed up the initial wetting of fluid cavity 408, since air in cavity 408 can be displaced when fluid enters one of the multiple openings first.

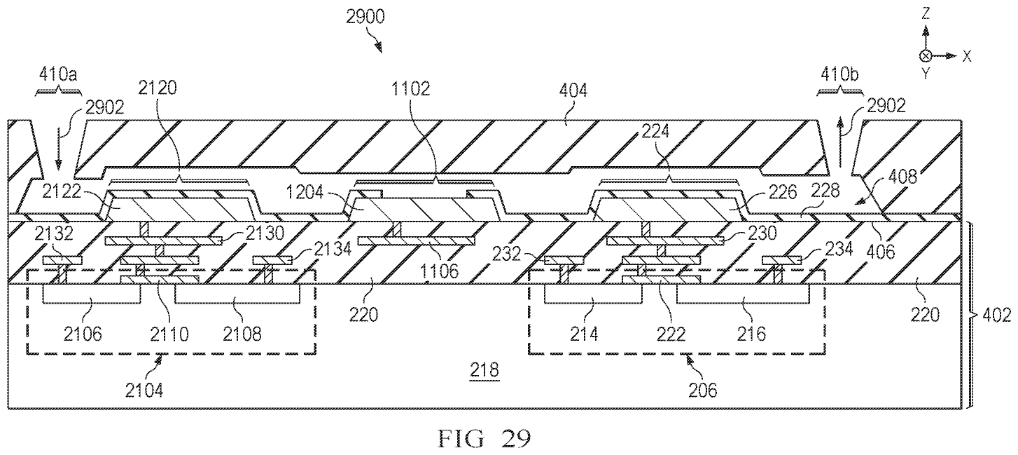

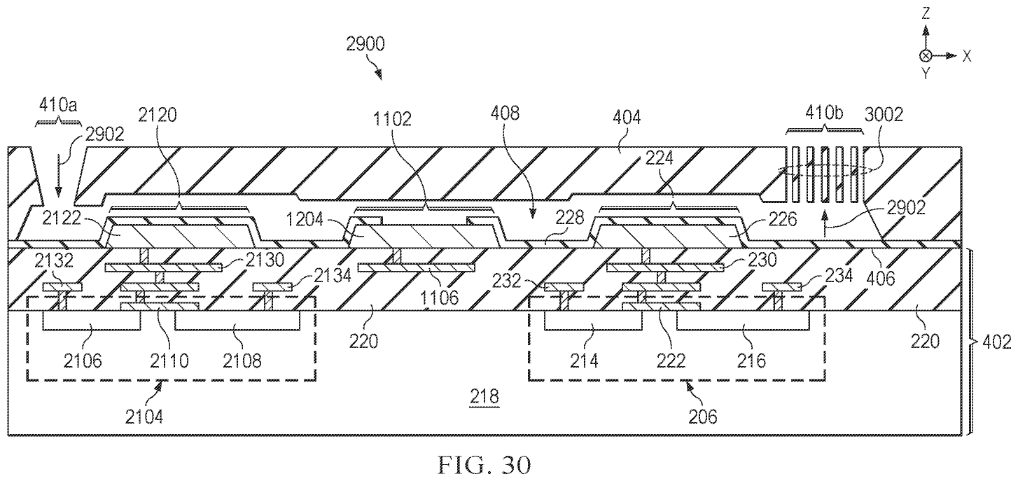

FIG. 29 and FIG. 30 illustrate examples of a microfluidic sensor 2900. Microfluidic sensor 2900 is an integrated circuit including fluidic structure 404. Microfluidic sensor 2900 also includes two openings 410a and 410b in fluidic structure 404. Both openings 410a and 410b extend to fluid cavity 408. Microfluidic sensor 2900 also includes sensor terminals 2120 and 224 and voltage terminal 1102 in fluid cavity 408. Opening 410a can be an inlet to allow a fluid 2902 to enter cavity 408, and opening 410b can be an outlet to allow fluid 2902 to exit cavity 408. In the example of FIG. 30, opening 410b can include an osmotic structure 3002 (e.g., a permselective membrane) to create a concentration gradient, which can facilitate the flow of the fluid out of cavity 408 through opening 410b via, for example, a diffusioosmotic process. In some examples, opening 410b may be of nanofluidic dimension, and its angle against sensing side 406 may be 90 degrees or tapered. In some examples, opening 410b include nanopores. Sensor terminal 2120 can be proximate opening 410a and further away from opening 410b than sensor terminal 224. Sensor terminal 224 can be proximate opening 410b and further away from opening 410a than sensor terminal 2120.

In some examples, openings 410a and 410b can be coupled to an external pump system to force the fluid to move through opening 410a to enter fluid cavity 408, and exit fluid cavity 408 through opening 410b. In some examples, such as the example of FIG. 30, the fluid can flow from opening 410a to opening 410b without the external pump system. In both cases, the fluid can be transported through fluid cavity 408 by convection at a higher speed than microfluidic diffusion. Such arrangements can facilitate initial wetting of the internal surface of fluid cavity 408 and the surfaces of the sensor terminals. Also, such arrangements can facilitate a calibration operation. For example, a fluid with a known pH can enter fluid cavity 408 and come into contact with sensor terminals 224 and 2120, and a calibration operation can be performed to determine the various capacitances of the microfluidic sensor (e.g., capacitors 316 and 318 of FIG. 3B) based on the known pH value of the fluid and the outputs of the ISFETs. By forcing the fluid to enter and flow through fluid cavity 408 by convection rather than microfluidic diffusion, the flow and possibly exchange of the fluids in fluid cavity 408 can be sped up, which allows the calibration operation to be performed more efficiently. Also, such arrangements can facilitate sample injection for subsequent electrochemical operations such as electrophoresis, as described later.

In some examples, such as examples described in FIGS. 29, 30, 31, 32, and 43, when a convective fluid flow is forced across the cavity 408, a streaming potential between the openings can be generated. The streaming potential facilitates as a potential gradient and can be measured at the locations of the sensor terminals 2120 and 224, and can be used to measure the Zeta potential. If the pH across the cavity 408 is not constant, then an arrangement of voltage references provided by ISFETs in split-off reference channels having a reference fluid of pH_{Ref} such as described earlier and shown in FIG. 26B can be used to determine the streaming potential independent of the pH gradient across 408. In some examples, for the purpose of such streaming potential measurements, the pH inside cavity 408 can be adjusted by means of electrochemical actuation such as electrolysis, as described later, which can allow experimental determination of the isoelectric point.

FIG. 31A, FIG. 31B, FIG. 31C, FIG. 31D, FIG. 31E, and FIG. 31F illustrate examples of a microfluidic sensor 3100 that can support additional operations, such as an electrophoresis operation and an electroosmotic operation. Referring to FIGS. 31A through 31D, microfluidic sensor 3100 is an integrated circuit and has two openings 410a and 410b in fluidic structure 404.

Microfluidic sensor 3100 also includes one or more sensor terminals in fluid cavity 408. In FIG. 31A, microfluidic sensor 3100 includes sensor terminal 224 coupled to ISFET 206. In FIG. 31B and FIG. 31C, microfluidic sensor 3100 includes sensor terminals 224 and 2120 coupled to the respective ISFETs 206 and 2104. In FIG. 31D, microfluidic sensor 3100 includes nanofluidic channels 2608 and 2652 and reservoir 2650 of FIG. 26C, reservoir 2620 and fluid conduit structure 2622, and reservoir 2630 and fluid conduit structure 2632. Also, in addition to sensor terminals 2120 and 224, microfluidic sensor 3100 of FIG. 31D includes and sensor terminals 2642 (in nanofluidic channel 2608) and 2654 (in reservoir 2650), sensor terminal 2624 in reservoir 2620, and sensor terminal 2634 in reservoir 2630. Microfluidic sensor 3100 can also include a reference electrode or an electrode to set an electrical potential of the fluid, and these electrodes are omitted in FIGS. 31A through 31D for brevity.

Microfluidic sensor 3100 also includes control terminals 3102 and 3104. In FIGS. 31A and 31B, control terminal 3102 is inside fluid cavity 408 and control terminal 3104 is outside fluid cavity 408. In FIGS. 31C and 31D, both control terminals 3102 and 3104 are inside fluid cavity 408. Control terminal 3102 can include an electrode 3106 partially covered by insulation layer 228, and control terminal 3104 can include an electrode 3108 partially covered by insulation layer 228. Control terminal 3102 can proximate opening 410a, and control terminal 3104 can proximate opening 410b. In some examples, control terminals 3102 and 3104 are of identical size. In other examples, control terminals 3102 and 3104 can be of different size, which enables separation and focusing of electrically neutral particles via dielectrophoresis.

Microfluidic sensor 3100 also includes direct current (DC) voltage generators 3110 and 3112. DC voltage generator 3110 is coupled to control terminal 3102 and can set a voltage of control terminal 3102. DC voltage generator 3112 is coupled to control terminal 3104 and can set a voltage of control terminal 3104. DC voltage generators 3110 and 3112 can be implemented in semiconductor die 402 or can be external to the integrated circuit of microfluidic sensor 3100. In some examples, DC voltage generator 3110 can provide a first DC voltage (e.g., 20V, 10V, etc.) to control terminal 3102, and DC voltage generator 3112 can provide a second DC voltage that is less positive (or more negative) than the first DC voltage (e.g., 0V, −10V, etc.) to control terminal 3104. In some examples, microfluidic sensor 3100 can include an ammeter 3114 coupled between one of the control terminals 3102/3104 and the DC voltage generator 3112, in order to provide an amperometric measurement of the DC current. This can be beneficial to ensure proper conduct of the electroosmotic or electrophoretic cooperation. Ammeter 3114 can be implemented in semiconductor die 402 or can be external to the integrated circuit of microfluidic sensor 3100.

In FIGS. 31A and 31B, microfluidic sensor 3100 can include opening 410b having osmotic structure 3002, and microfluidic sensor 3100 can support an electroosmotic operation, such as operating as a DC electroosmotic pump, to facilitate flow of a fluid across fluid cavity 408 from opening 410a and out of opening 410b, or from opening 410b and out of opening 410a. Control terminals 3102 and 3104 can generate an electric field across osmotic structure 3002 of opening 410b. The electric field force the fluid to move through the osmotic structure to create a flow/pressure, and osmotic structure 3002 provides additional surface area to improve the pump performance. The DC electroosmotic pump can speed up the flow of the fluid in fluid cavity to, for example, support a calibration operation, etc. Following the electroosmotic operation, microfluidic sensor 3100 can then receive another fluid via opening 410a and perform the sensing operations as described above.

In FIG. 31C, microfluidic sensor 3100 can perform an electrophoresis operation on the fluid in fluid cavity 408 to separate positive and negative particles. In some examples, openings 410a and 410b can be coupled to different ports and receive different fluids. Control terminal 3102 can attract negatively charged molecules or ions, and repel positively charged molecules or ions, which can lead to a concentration gradient or separation of molecules between the two terminals according to their mobility. Accordingly, different pH values may be found fluid cavity 408 from 3202 to 3204, and a pH value at a location within fluid cavity 408 can depend on the composition (e.g., concentrations of different types of ions and molecules) of the fluid. ISFETs 2104 and 206 can generate voltages representing pH values at different locations within fluid cavity 408, and the pH values can indicate the composition of the fluid. In the example of FIG. 31C, to support or facilitate the electrophoresis operation, the distance between opening 410a and control terminal 3102 can be greater than the distance between opening 410b and control terminal 3104, so that most of the DC current will flow across the microfluidic channel. In examples, undesired electroosmotic flow during the electrophoretic operation can be prevented by choosing the pH value of the fluid (or control of pH via actuation, as described later) close to the isoelectric point of the cavity surface, or otherwise reduction or modification of the Zeta potential, such as by surface modification or addition of zwitterionic surfactants.

As described above, potential gradients such as the liquid junction potential described earlier may arise due to the concentration gradients across the path between the openings 410a and 410b. FIG. 31D illustrates an example of microfluidic sensor 3100 having the split-off reference channels such as nanofluidic channel 2652 and reservoir 2650 of FIG. 26C, reservoir 2620 and fluid conduit structure 2622, and reservoir 2630 and fluid conduit structure 2632, to measure the liquid junction potentials (or otherwise occurring pH-independent potential difference V_{D}) on two sides of nanofluidic channel 2608, as described in FIG. 26C with the differential measurement of (Equation 9). In some examples, microfluidic sensor 3100 can include a control terminal 3118 (coupled to a voltage source not shown in FIG. 31D) in nanofluidic channel 2602, so that microfluidic sensor 3100 can also operate as a nanofluidic transistor/flowFET, where control terminals 3102 and 3104 can represent the source and drain terminals of the nanofluidic transistor/flowFET, and control terminal 3118 can represent the gate terminal of the nanofluidic transistor/flowFET.

In some examples, DC voltage generator 3110 can provide a first DC voltage (e.g., 2V, 1V, etc.) to control terminal 3102, and DC voltage generator 3112 can provide a second DC voltage that is less positive (or more negative) than the first DC voltage (e.g., 0V, −1V, etc.) to control terminal 3104. In such examples, microfluidic sensor 3100 can perform an isoelectric focusing operation on the fluid in fluid cavity 408 to create a pH gradient in order to separate amphoteric particles such as proteins or pharmaceuticals. Due to current transfer from electron to ion at the electrode interface, so called actuation, at control terminal 3102 (cathode), hydroxide ions OH− can be created, which can lead to a high pH in the portion of fluid cavity 408 below opening 410b. Similarly, at control terminal 3204 (anode), hydrogen ions H+ can be created, which can lead to a high pH in the portion of fluid cavity 408 below opening 410a. The rate of H+ and OH− creation depends on electrode metal and surface area, the distance between the electrodes, and most dominantly the ionic contents of the solution. The ratio of the two rates also depends on ionic concentration of the solution. Accordingly, a pH gradient can be formed along fluid cavity 408 from opening 410a to opening 410b, and a pH value at a location within fluid cavity 408 can depend on the composition (e.g., concentrations of different types of ions) of the fluid. ISFETs 2104 and 206 can generate voltages representing pH values at different locations within fluid cavity 408, and the pH values can indicate the composition of the fluid. In electrophoresis, described earlier, the actuated H+ and OH− ions might negatively affect the separation operation. Therefore, the control terminals 3102 and 3104 may be positioned at greater distance than for an isoelectric focusing operation. In some examples, control terminals 3102 and 3104 may be positioned in a split off path (not shown in FIGS. 31) where the products of electrolysis such as H+ and OH− generation and/or generation of H2 or O2 bubbles does not affect the electrophoresis operation.

Electroosmotic pumps based on DC electroosmosis can be affected by undesired bubble generation and other electrochemical reactions at the electrodes at voltages beyond 1 V for electrolytes. These disadvantages can limit the throughput of the pump and the flow rate. An alternating current (AC) electroosmotic pump can pump at a high frequency (e.g., higher than 100 kHz) to circumvent the bubble problem by inducing polarization and slip velocity on embedded electrodes.

FIG. 31E illustrates an example of microfluidic sensor 3100 having an AC electroosmotic pump. Referring to FIG. 31E, fluidic structure 404 (or fluid cavity 408) can have a series of arrow shape footprints pointing towards a particular direction (e.g., direction C). In some examples, cavity 408 may also have a rectangular footprint. Microfluidic sensor 3100 also includes sets of electrodes, such as a set of electrodes 3120 (e.g., 3120a-c), a set of electrodes 3122 (e.g., 3122a-c), and a set of electrodes 3124 (e.g., 3124a-c), where electrodes from different electrode sets interleave. The electrodes extend below fluid cavity 408, and some (or all) of the electrodes are coupled to respective control terminals in fluid cavity 408. Some of the control terminals are illustrated in FIG. 31E, while others may exist and are omitted for brevity. For example, microfluidic sensor includes a control terminal 3132a coupled to electrode 3122a, and a control terminal 3132b coupled to electrode 3122b. Each control terminal can include a metal electrode (e.g., Platinum) fully covered by insulation layer 228, which can avoid the electrode changing the electrical potential of the fluid. Microfluidic sensor 3100 can also include AC voltage generators, with each AC voltage generator coupled to a set of electrodes. For example, Microfluidic sensor 3100 can include an AC voltage generator 3140 coupled to electrodes 3120, an AC voltage generator 3142 coupled to electrodes 3122, and an AC voltage generator 3144 coupled to electrodes 3124.

FIG. 31F illustrate graphs 3150, 3152, and 3154 illustrating the variation of voltage signals provided by, respectively, AC voltage generators 3140, 3142, and 3144. As shown in FIG. 31F, each AC voltage generator can generate an AC voltage signal having a frequency. The AC signal can include a sequence of varying voltage signals. In the example shown in FIG. 31F, the AC signal can be sinusoidal. In other examples, the AC signal can include pulses (e.g., rectangular pulses, triangular pulses, etc.). The AC voltage signals provided by AC voltage generators 3140, 3142, and 3144 can have a phase offset from each other in time. For example, the pair of AC signals provided by AC voltage generators 3140 and 3142 (represented by graphs 3150 and 3152), and the pair of AC signals provided by AC voltage generators 3142 and 3144 can be offset from one another by a time/phase T_{off}:

Because of the offset, neighboring electrodes can have asymmetric potentials, which creates a potential difference, and the potential difference varies with time at a particular frequency (e.g., 100 kHz). The potential difference can create electric field between neighboring electrodes. The electric field can induce a nanometer layer of charge/ions (also known as double layer) at the control terminals, and the ions on neighboring control terminals have opposite polarity. Under the influence of electric fields that are parallel to the surface, the surface charges in the double layer will migrate, which in turn produces fluid motion due to fluid viscosity. By applying asymmetric electric signals to neighboring electrodes, the two electrodes in a pair will exhibit different polarizations and strength of the double layer at the electrode/electrolyte interface. This can generate a unidirectional Maxwell force on the fluid, leading to throughflow pumping. In some examples, the control terminals in fluid cavity 408, such as control terminals 3132a and 3132b, can also have asymmetric footprints to unidirectional Maxwell force, which allows pump operation with fewer AC signal generators.

FIG. 32 illustrates an example microfluidic sensor 3200 that can support an impedance spectroscopy operation. Referring to FIG. 32, microfluidic sensor 3200 is an integrated circuit and has two openings 410a and 410b in fluidic structure 404. Microfluidic sensor 3200 also includes sensor terminals 224 and 2120 and ISFETs 206 and 2104. In addition, microfluidic sensor 3200 includes control terminals 3202 and 3204. Control terminal 3202 can include an electrode 3206 covered (fully or partially) by insulation layer 228, and control terminal 3204 can include an electrode 3208 covered (fully or partially) by insulation layer 228. Control terminal 3202 can proximate opening 410a, and control terminal 3204 can proximate opening 410b. Microfluidic sensor 3200 also includes an alternating current (AC) voltage generator 3210 coupled between control terminals 3202 and 3204. AC voltage generator 3210 can provide an AC voltage signal across control terminals 3202 and 3204. Control terminals 3202 and 3204 can set an electrical potential of the fluid in fluid cavity 408 similar to voltage terminals 1102/1202, albeit the electrical potential being AC. One of control terminals 3202 and 3204 can also sense the electrical potential. Microfluidic sensor 3200 can also include an ammeter to measure current. The impedance can be based on a ratio between the electrical potential and the current, and can be measured for different AC voltage signal frequencies to generate the spectroscopy.

In some examples, AC voltage generator 3210 can be implemented in semiconductor die 402 or can be external to the integrated circuit of microfluidic sensor 3200. In some examples, more than two control terminals can be used for an impedance spectroscopy operation, such as four electrodes to support a four-electrode conductivity measurement. In some examples, the proximity between control terminals may be closer than indicated in FIG. 32, e.g., similar to the proximity of the control terminal in FIG. 31, which may in some examples be dynamically (by means of switching circuitry) re-configured for impedance spectroscopy. The components of microfluidic sensor 3200 to support the impedance spectroscopy operation (e.g., AC voltage generator 3210 and electrodes 3206 and 3208) can also be included in other examples of microfluidic sensors described herein.

To support an impedance spectroscopy operation, AC voltage generator 3210 can perform a frequency sweep by providing AC voltage signals having a range of frequencies. Openings 410a and 410b can be coupled to separate fluidic ports or inlets. In some examples, the distance of opening 410a to sensor terminal 3202 and the distance of opening 410b to sensor terminal 3204 can be greater than twice the distance between sensor terminals 3202 and 3204. In both cases, most of the AC current can flow through the microfluidic channel. At each frequency, ISFETs 2104 and 206 can generate voltages representing pH values of a fluid in fluid cavity 408, and a relationship between the pH values of the fluid and the frequency of the AC voltage signal applied across control terminals 3202 and 3204 can be determined. The relationship can represent an impedance spectroscopy of the fluid, and can reflect the composition of the fluid. For the here described purposes, impedance structures can be integrated as part of a larger fluidic network of actuators and sensors, such as described earlier and in the following. The fluidic network is can be a multitude of channels formed by the fluidic structure. There may be an element for performing mixing, another element for performing electrophoresis, and elements such as pumps and valves connecting the parts of this so-formed larger fluidic network.

In some examples, an impedance spectroscopy operation can be beneficial to ensure proper operation of these devices, e.g., by conducting an auxiliary conductivity measurement in case a certain ionic strength or conductivity is desired or to be controlled by a sensor-actuator mechanism. In other examples, undesired air bubbles or particles can be detected by impedance spectroscopy, and, for example, these air bubbles or particles can be expelled by means of convection created by (external or internal) pumps as a response to the bubble detection mechanism. In similar examples, where an emulsion of fluids or undissolved particles (i.e., colloids or suspensions) are desired to be present in the fluid of cavity 408, an impedance spectroscopy operation can give an indication about the composition of such emulsions, colloids, or suspensions.

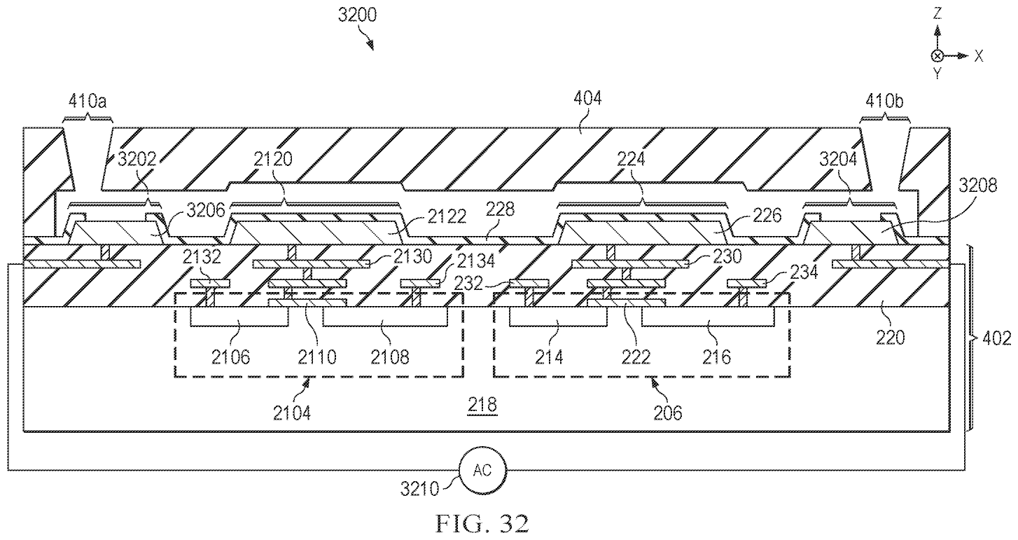

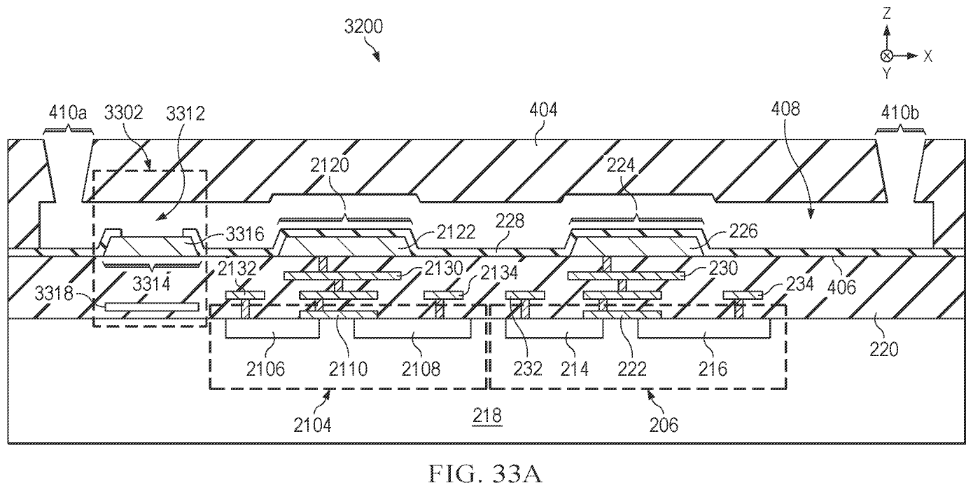

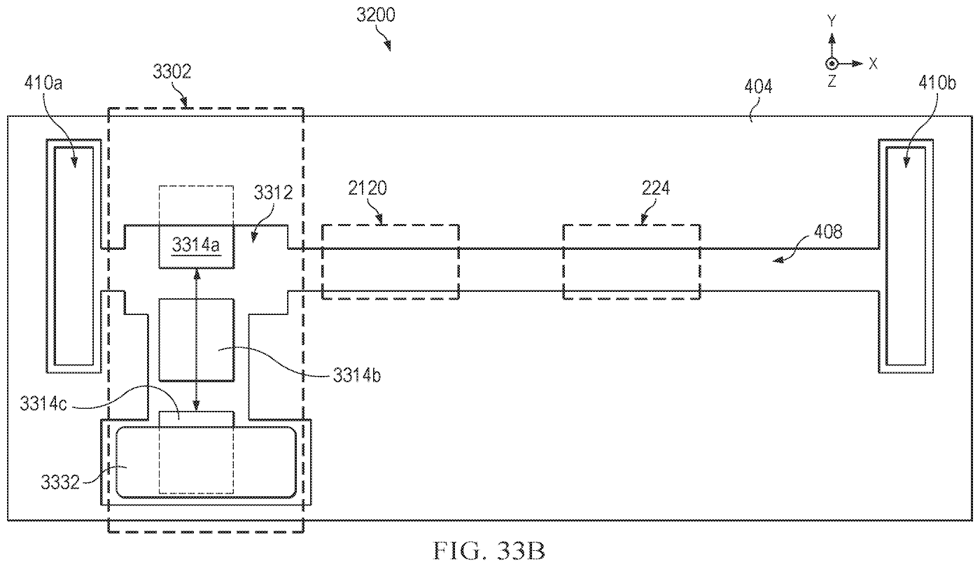

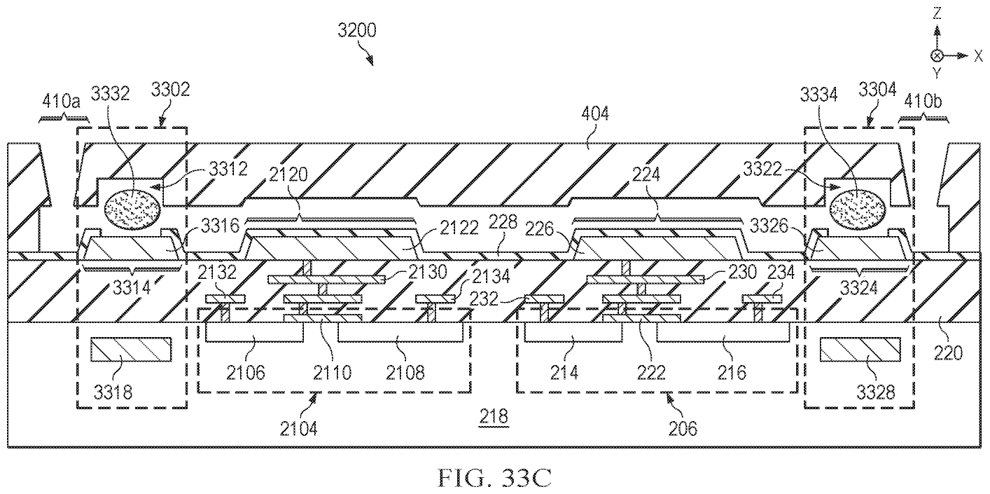

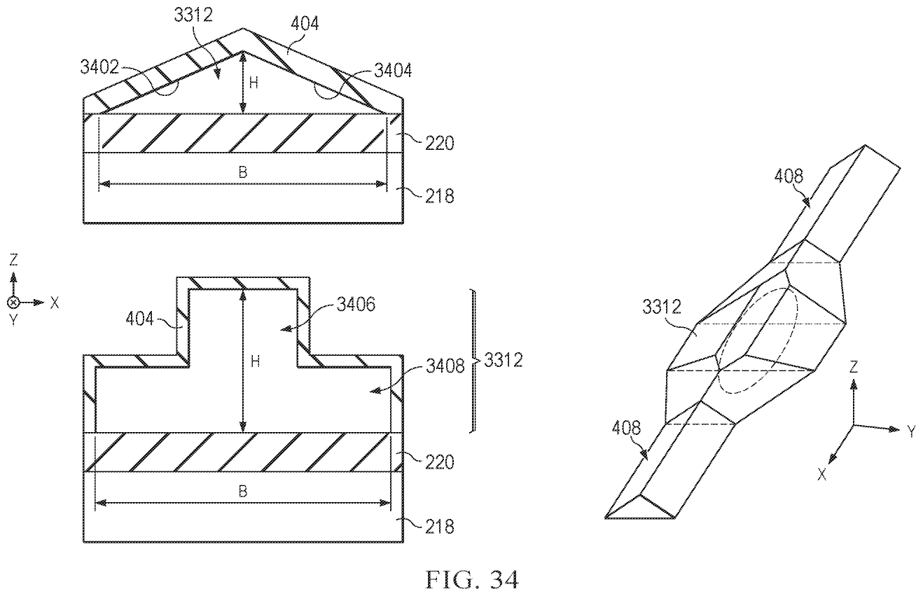

In some examples, a microfluidic sensor can include valves in fluid cavity 408 to control the direction and/or rate of flow of the fluid between openings 410a and 410b. FIGS. 33A, 33B, 33C, and FIG. 34 are schematics illustrating examples of a microfluidic sensor 3300, which is an integrated circuit including fluidic structure 404. FIG. 33A illustrates a cross-sectional view of microfluidic sensor 3300, and FIG. 34 illustrates another cross-sectional view and perspective view of fluid cavity 408 of microfluidic sensor 3300. Referring to FIG. 33A and FIG. 33B, microfluidic sensor 3300 has openings 410a and 410b in fluidic structure 404. In some examples, microfluidic sensor 330 can include one opening 410. Microfluidic sensor 3300 also includes sensor terminals 224 and 2120 and ISFETs 206 and 2104. Microfluidic sensor 3300 can also include voltage terminal 1102 in fluid cavity 408 or voltage terminal 1202 external to fluid cavity, or a discrete reference electrode, which are not shown in FIGS. 33A, 33B, and 34 for brevity.

Also, microfluidic sensor 3300 includes a valve, such as valve 3302. A valve can include a chamber that is part of fluid cavity 408, a voltage terminal, and a heater. For example, valve 3302 includes a chamber 3312 (shown in FIG. 33B), one or more control terminals 3314 each including an electrode 3316 partially covered by insulation layer 228 on sensing side 406 of dielectric layer 220, and a heater circuit 3318 in substrate 218. The interconnects are omitted in FIG. 33 for brevity.

In FIGS. 33A and 33B, chamber 3312 can extend along a lateral direction (e.g., along the y-axis) orthogonal to the flow path of a fluid in fluid cavity 408 (e.g., along the x-axis) and between opening 410a and sensor terminal 224. Chamber 3312 can hold a gas bubble 3332 (e.g., oxygen, hydrogen, etc.). In FIGS. 33A and 33B, microfluidic sensor 3300 can include multiple control terminals 3314, such as 3314a, 3314b, and 3314c positioned laterally (e.g., along the y-axis) along chamber 3312. Control terminals 3314 can be coupled to a voltage generator, which can set the control terminals to a negative electrical potential. As part of an electrolysis operation, the water component of the fluid can be broken down into oxygen gas and hydrogen ions responsive to the negative electrical potentials at control terminals 3314, and the oxygen (or hydrogen) gas can be trapped in chamber 3312. Also, as to be described below, the voltage generator can also generate voltage pulses, which causes control terminals 3314 to generate electric fields to move gas bubble 3332 along chamber 3312 to open, close, or otherwise restrict the flow of fluid between opening 410a and sensor terminal 224. For example, when gas bubble 3332 is at control terminal 3314c, valve 3302 can be in an open state. Also, when gas bubble 3332 is at control terminal 3314a and/or control terminal 3314b, valve 3302 can be in a shut off state or in a restricted state.

Also, the size of gas bubble 3332 can be controlled by respective heater 3318 to set a degree of flow restriction provided by valve 3302. If the bubbles are expanded to a certain size, they may act as an isolation valve and completely shut off the flow path so that galvanic separation between the fluid inside the cavity and outside of the cavity can be achieved. ISFETs (e.g., 206 and 2104) can be operated when the valves are open. If any ISFET operation is desired when the flow path is shut off, at least one voltage terminal is required in a liquid separated from other liquids by means of at least one isolation valve, in order to provide a V_{G} necessary to operate the ISFET. As to be described below, microfluidic sensor 3300 can also include a set of serially-connected valves operating as a pump, in which the gas bubbles in the valves can be expanded (e.g., when heater is on) and shrunk (e.g., when heater is off) sequentially to force the fluid to move in a particular direction.

FIG. 33C illustrates another example of microfluidic sensor 3300. In FIG. 33C, microfluidic sensor can include another valve 3304, which includes a chamber 3322, a control terminal 3324 including electrode 3326, and a heater 3328. In FIG. 33C, chamber 3312 and chamber 3322 can extend along a vertical direction (e.g., along the z-axis) orthogonal to the flow path of a fluid in fluid cavity 408 (e.g., along the x-axis) and between opening 410a and sensor terminal 224. Chamber 3312 can hold a gas bubble 3332 (e.g., oxygen, hydrogen, etc.). Such an arrangement may be advantageous since it allows gravitational trapping of the bubble, as indicated later in FIG. 34.

Referring to FIG. 34, each chamber can have recessed internal surfaces 3402 and 3404 forming an angle, and can have a cross-sectional shape of a triangle, or a trapezoid, having a widened base. In the example of FIG. 34, chamber 3312 extends in the z-direction and its cross-section (and that of cavity 408) can have a triangular shape having a height of H and a base width of B. In some examples, H can be about 0.5 um and B can be about 5 um. The recessed internal surface can facilitate trapping of gas bubble in chamber 3312, where due to gravity gas bubble can be trapped in the widened base. In some examples, the cross-section of chambers 3312 and 3322 can also include ridge shape including a narrow polygon portion 3406 and a wide polygon portion 3408, with narrow polygon portion 3406 of the chamber to trap the gas bubble. The width of wide polygon portion 3408 can be B, and the height of the ridge shape can be H.

In the examples of FIGS. 33A, 33B, 33C, and 34, bubbles can be introduced from openings 410a/410b during the first wetting of fluid cavity 408. If the bubble can be reliably trapped in chamber 3312, the control terminals for bubble creation can be omitted (or otherwise not used for bubble creation). Also, heater 3318 can be omitted if the size and, optionally, position (e.g., a bi-stable valve) of the bubble can be controlled by control terminals alone.

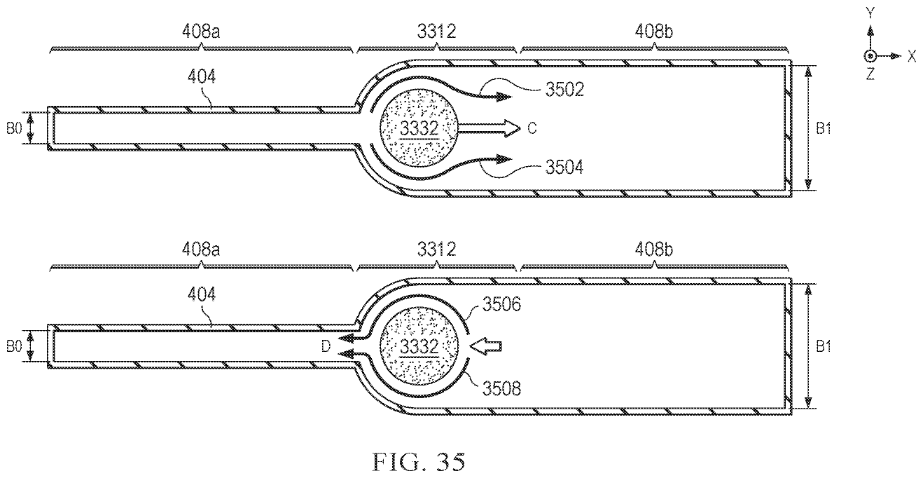

FIGS. 35 and 36 are schematics illustrating plan views of example fluid cavity 408 and valve 3302 including chamber 3312 and gas bubble 3332 enclosed in fluidic structure 404. Referring to FIGS. 35 and 36, microfluidic sensor 3300 can include chamber 3312 coupled between cavity portions 408a and 408b. In FIG. 35, cavity portion 408a can have a based width B0, and cavity portion 408b and chamber 3312 can have a base width B1 larger than B0. Also, in FIG. 36, cavity portions 408a and 408b can have base width B0.

In FIG. 35, valve 3302 can be configured as a unidirectional check valve that can block the flow of fluid towards in one direction. Specifically, gas bubble 3332 can restrict flow of fluid towards both directions C and D, where the fluid flow around gas bubble 3332 between cavity portions 408a and 408b as represented by flows 3502, 3504, 3506, and 3508. As the flow rate of the fluid increases towards direction D, bubble 3332 can be pushed against the opening between cavity portion 408a and chamber 3312 and can block the fluid from entering cavity portion 408a. On the other hand, if the flow rate the fluid increases towards direction C, bubble 3332 can be pushed further away from the opening between cavity portion 408a and chamber 3312. But because cavity portion 408b and chamber 3312 has the same base width B1, the bubble does not block the fluid from flowing into cavity portion 408b. Accordingly, valve 3302 can function as a unidirectional valve that can block of the flow of fluid towards direction D. Similarly, with added actuator elements to move the bubble, a piston pump can be achieved where the bubble is moved and creates convection along its path of motion.

Also, in FIG. 36, valve 3302 can be configured as a bidirectional check valve that can block the flow of fluid towards either directions C or D, because chamber has a larger base width than both cavity portions 408a and 408b. Specifically, as the flow rate of the fluid increases towards direction D, bubble 3332 can be pushed against the opening between cavity portion 408a and chamber 3312 and can block the fluid from entering cavity portion 408a. Also, as the flow rate of the fluid increases towards direction C, bubble 3332 can be pushed against the opening between cavity portion 408b and chamber 3312 and can block the fluid from entering cavity portion 408b.

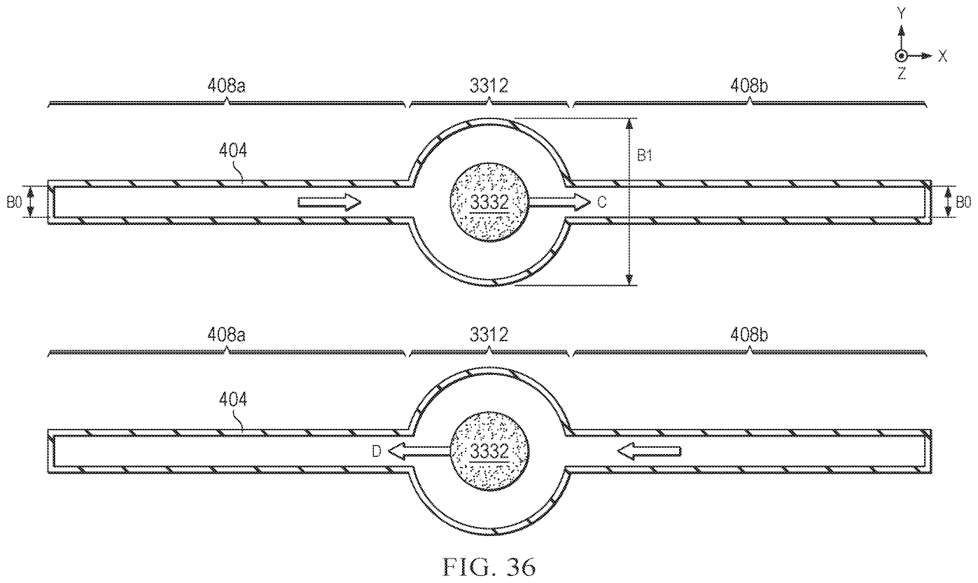

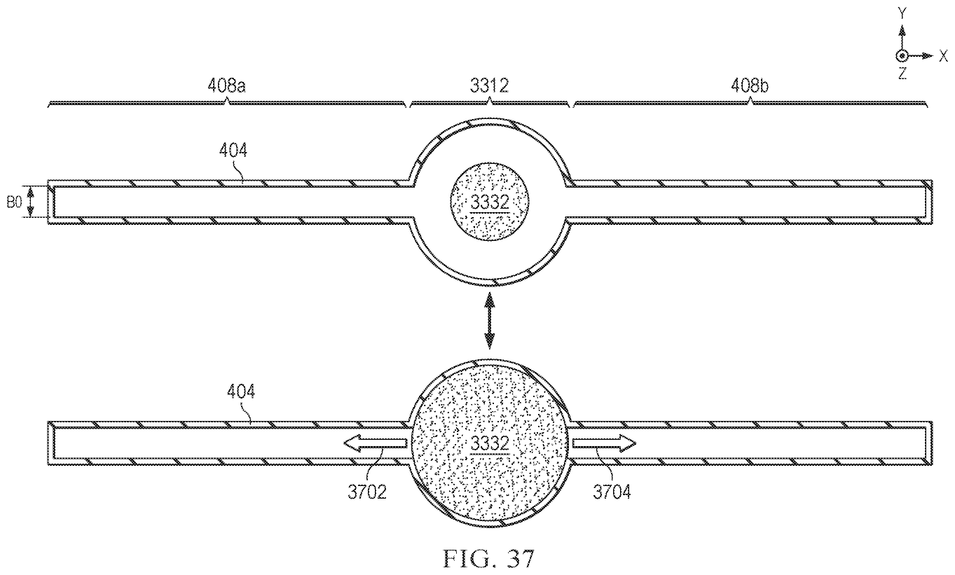

As described above, valve 3302 includes a heater circuit 3318 to thermally expand or shrink gas bubble 3332 to set a degree of flow restriction. FIG. 37 illustrates example operation of heater circuit 3318. Referring to FIG. 37, by thermal expanding gas bubble 3332 in chamber 3312, gas bubble 3332 can act as an isolation valve, completely blocking the flow of fluid between cavity portions 408a and 408b. The expansion of gas bubble 3332 in chamber 3312 can also push the fluid out of chamber 3312 into cavity portions 408a and 408b, as indicated by flows 3702 and 3704.

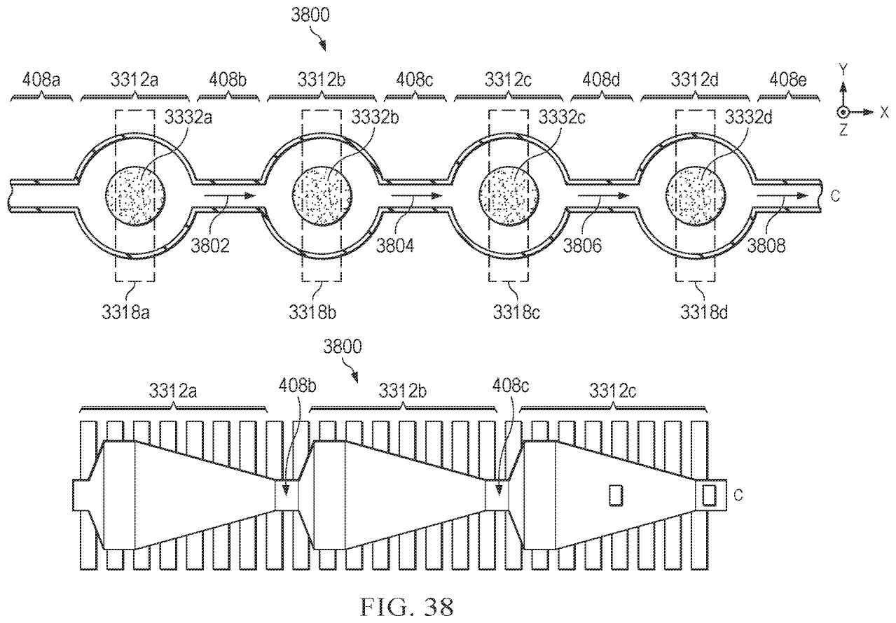

In some examples, microfluidic sensor 3300 includes a set of serially-connected valves operating as a pump, in which the gas bubbles in the valves can be expanded and shrunk sequentially to force the fluid to move in a particular direction. FIG. 38 are schematics illustrating plan views of an example pump 3800 that can be part of microfluidic sensor 3300. Referring to FIG. 38, microfluidic sensor 3300 can include a set of serially-connected chambers 3312 enclosed in fluidic structure 404. The serially-connected chambers 3312 include chambers 3312a, 3312b, 3312c, and 3312d, each holding respective gas bubbles 3332a, 3332b, 3332c, and 3332d. Chamber 3312a can be coupled between cavity portions 408a and 408b. Chamber 3312b can be coupled between cavity portions 408b and 408c. Chamber 3312c can be coupled between cavity portions 408c and 408d. Microfluidic sensor 3300 also includes heater circuits 3318a, 3318b, 3318c, and 3318d under the respective chambers 3312a, 3312b, 3312c, and 3312d. Heater circuits 3318a, 3318b, 3318c, and 3318d can thermally expand the gas bubbles sequentially to force a fluid to flow in a particular direction, such as direction C. In some examples, the chambers can have an arrow shaped footprint pointing towards a particular direction (e.g., direction C) to facilitate the flow of the fluid towards that direction.

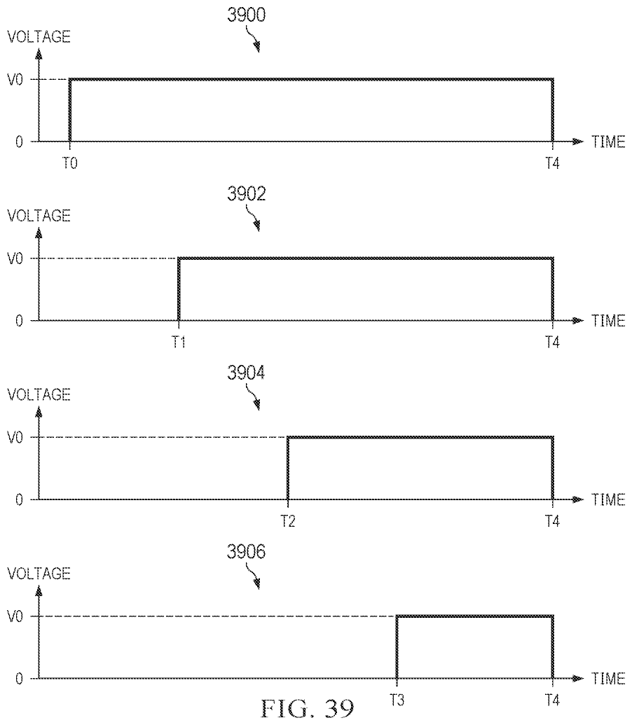

FIG. 39 are graphs 3900, 3902, 3904, and 3906 illustrating example operations of heater circuits 3318a, 3318b, 3318c, and 3318d to operate the serially-connected valves of FIG. 38 as a pump. In each of graphs 3900, 3902, 3904, and 3906, Graph 3900 illustrates an example variation of a voltage provided to heater circuit 3318a with time, graph 3902 illustrates an example variation of a voltage provided to heater circuit 3318b with time, graph 3904 illustrates an example variation of a voltage provided to heater circuit 3318c with time, and graph 3906 illustrates an example variation of a voltage provided to heater circuit 3318c with time. In each of graphs 3900 through 3906, a voltage of V0 represents that the heater circuit is enabled and thermally expand a gas bubble in the chamber, and a voltage of zero represents that the heater circuit is disabled.

Referring to FIG. 39, at time T0, heater circuit 3318a receives a voltage of V0 and thermally expands gas bubble 3332a. Referring again to FIG. 38, the expanded gas bubble 3332a pushes the fluid out of chamber 3312a into cavity portion 408b, represented by flow 3802. At time TO, heater 3318b is disabled and gas bubble 3332b is not thermally expanded, which allows the fluid to flow towards direction C into chamber 3312b via cavity portion 408b.

Also, at time T1, heater circuit 3318b receives a voltage of V0 and thermally expands gas bubble 3332b, while heater circuit 3318a remains enabled. Accordingly, both gas bubbles 3332a and 3332b can be in the thermally expanded state. The expanded gas bubble 3332b pushes the fluid into cavity portion 408c, as represented by flow 3804. Because gas bubble 3332a is in the thermally expanded state and block the opening between chamber 3312a and cavity portion 408b, the fluid cannot enter chamber 3312a and can be forced to flow towards direction C and into chamber 3312c via cavity portion 408c.

Further, at time T2, heater circuit 3318c receives a voltage of V0 and thermally expands gas bubble 3332c, while heater circuits 3318a and 3318b remain enabled. Accordingly, gas bubbles 3332a, 3332b, and 3332c can be in the thermally expanded state. The expanded gas bubble 3332c pushes the fluid into cavity portion 408d, as represented by flow 3806. Because gas bubbles 3332a and 3332b are in the thermally expanded state, the fluid cannot enter chambers 3312b and 3312c and can be forced to flow towards direction C and into chamber 3312d via cavity portion 408d.

Also, at time T3, heater circuit 3318d receives a voltage of V0 and thermally expands gas bubble 3332d, while heater circuits 3318a, 3318b, and 3318c remain enabled. Accordingly, gas bubbles 3332a, 3332b, 3332c, and 3332d can be in the thermally expanded state. The expanded gas bubble 3332d pushes the fluid into cavity portion 408e, as represented by flow 3806. Because gas bubbles 3332a, 3332b, and 3332c are in the thermally expanded state, the fluid cannot enter chambers 3312a, 3312b, and 3312c, and can be forced to flow towards direction C and into cavity portion 408d. At time T4, the pump operation can end, and the voltages provided to the heaters can be back to zero to disable the heaters.

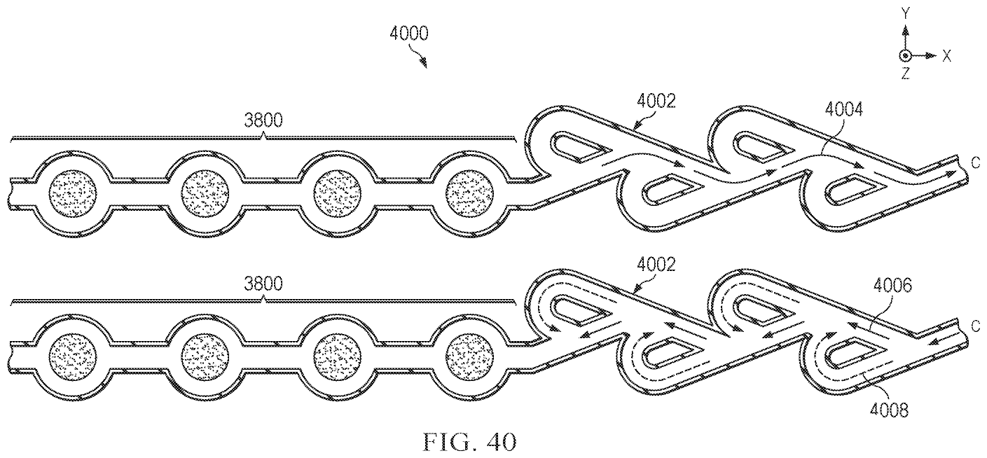

FIG. 40 is a schematic illustrating a plan view of an example pump 4000. As shown in FIG. 40, in some examples pump 4000 can include pump 3800 of FIG. 38 coupled to a Tesla valve 4002. Both pump 3800 and Tesla valve 4002 can be enclosed in fluidic structure 404. Tesla valve 4002 can allow the fluid to flow in one direction (e.g., direction C), as represented by flow 4004. When receiving fluid flowing in an opposite direction from the allowed direction, Tesla valve 4002 can create flows of the fluid, such as flows 4006 and 4008, that cancel each other out, so that the fluid can only flow in the allowed direction within fluid cavity 408. It can also be coupled to other pumps which generate non-directional movement to rectify the fluid flow.

In the examples of FIGS. 29-30 where a microfluidic sensor includes two openings 410a and 410b in fluidic structure 404, one of the two openings (e.g., opening 410a) is configured as an inlet, and the other one of the two openings (e.g., opening 410b) is configured as an outlet. The microfluidic sensor can receive a fluid via opening 410a and drain the fluid via opening 410b.

Also, in the examples of FIGS. 31, 33-40 where a microfluidic sensor includes valves or pumps, these elements can be integrated as part of a larger fluidic network of actuators and sensors, such as described earlier and in the following. In the example of multiple package fluidic ports as shown in FIG. 6, pumps can serve to provide new fluid between the ports, which may be connected by a fluidic network. For example, referring again to FIGS. 5A-5C and FIG. 6, pumps can be controlled to mix, exchange, or replace fluids between fluid cavity 408 and fluid 110. Similarly, isolation valves can act to (stop) restrict diffusion or flow into- and out of cavities such as 408. This can provide a significant advantage when a first fluid is aimed to be stored for a long period of time T1′ without mixing it with a second fluid under test, such as in the pH sensor described in previous figures.

In some examples, a microfluidic sensor can be configured as a fluid mixer, in which two openings 410a and 410b can be configured as inlets. In such examples, the microfluidic sensor can receive a first fluid via opening 410a, and a second fluid via opening 410b, and allow mixing of the fluids in fluid cavity 408. One example application of a fluid mixer is to determine a strength of a buffer solution, which can be one of the fluids provided to the microfluidic sensor. A buffer solution may resist pH change when mixed with a second fluid, and the buffer strength can represent the resistance of the buffer solution to the pH change after mixing with the second fluid. A small pH change may indicate a high buffer strength, and vice versa. A microfluidic sensor can measure the pH of the mixture to indicate the relative buffer strengths of the two fluids. Additional examples can include chemical reaction monitoring, a feedback control (e.g., if a stable gradient is desired) for separation of molecules or focusing applications, etc.

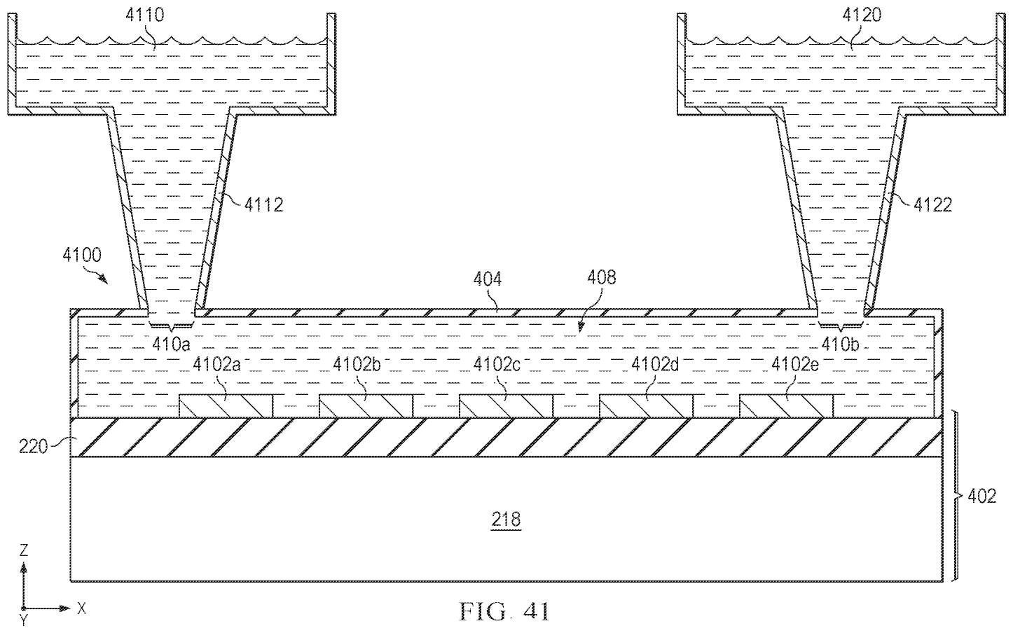

FIG. 41 is a schematic illustrating a cross-sectional view of an example microfluidic sensor 4100 that supports mixing and buffer strength measurement. Microfluidic sensor 4100 can be an integrated circuit including fluidic structure 404 on semiconductor die 402. Fluidic structure 404 encloses fluid cavity 408 and includes openings 410a and 410b extending to fluid cavity 408. Fluidic structure 404 may include additional openings not shown in FIG. 41. Each of openings 410a and 410b can be configured as a fluid inlet. Microfluidic sensor 4100 can include a set of sensor terminals, such as sensor terminals 4102a, 4102b, 4102c, 4102d, and 4102e, on dielectric layer 220 and inside fluid cavity 408. Each sensor terminal can include an electrode covered by insulation layer 228 (not shown in FIG. 41), and each sensor terminal is coupled to an ISFET in semiconductor die 402. Each sensor terminal/ISFET can sense the pH at a particular location in fluid cavity 408 between openings 410a and 410b, and provide a voltage representing the sensed pH value. Microfluidic sensor 4100 may also include a voltage terminal (not shown in FIG. 41) or an external reference electrode to set the electrical potential of the fluids. In some examples, microfluidic sensor 4100 can include a nanofluidic channel (e.g., nanofluidic channel 2608), a nanofluidic diode, or a nanofluidic transistor between openings 410a and 410b.

Microfluidic sensor 4100 can receive a fluid 4110 from a fluid container 4112 via opening 410a (and a port), and receive a fluid 4120 from a fluid container 4122 via opening 410b (and another port). Microfluidic sensor 4100 can enable a mixing of fluids 4110 and 4120 in fluid cavity 408, and provide measurements of pH at different locations in fluid cavity 408. The pH measurements can indicate the relative buffer strengths of the fluids.

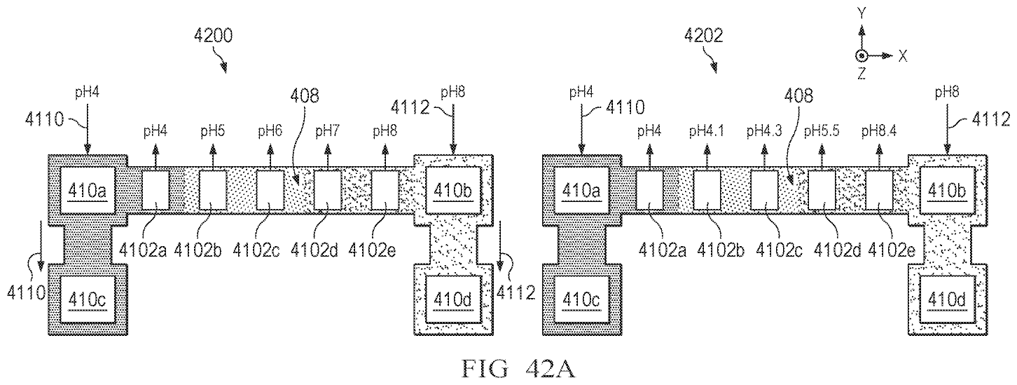

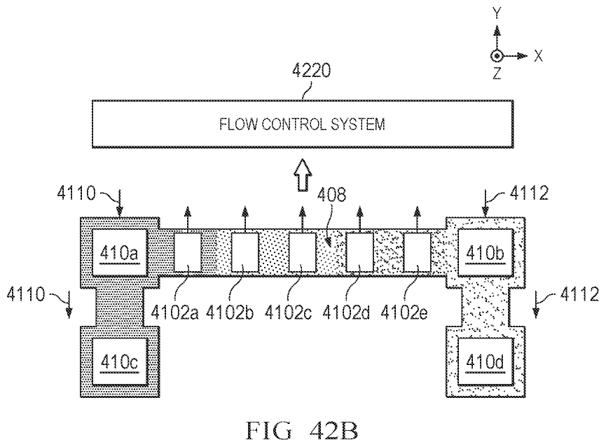

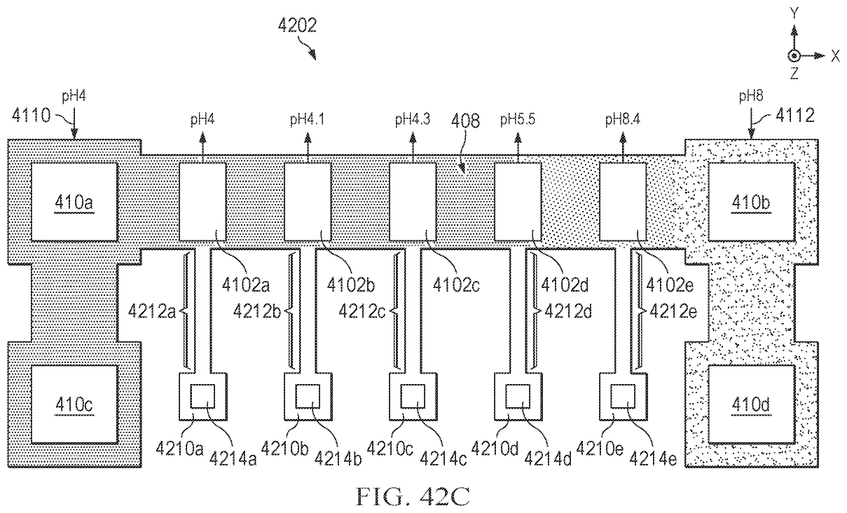

FIGS. 42A, 42B, and 4C are schematics of plan view of microfluidic sensor 4100 illustrating examples of pH measurement operations. FIG. 42A illustrates pH measurement operations 4200 and 4202 provided by microfluidic sensor 4100 from the mixing of fluids 4110 and 4112. Microfluidic sensor 4100 can receive a fluid 4110 from opening 410a, and fluid 4410 can exit through opening 410c. Also, microfluidic sensor 4100 can receive a fluid 4112 from opening 410b, and fluid 4112 can exit through opening 410d. Fluid 4110 can have a pH value of 4, and fluid 4112 can have a pH value of 8. The mixture of fluids 4110 and 4112 can have a pH gradient from pH 4 to pH 8 across fluid cavity 408, and the slope of the pH gradient can indicate relative buffer strengths of fluids 4110 and 4112. As shown in pH measurement operation 4200, sensor terminals 4102a-c can provide results indicating that the pH rising steadily from pH4 to pH8 following a constant or steady pH gradient. The middle sensor terminal 4102c measures a pH6, which is the average pH between the two fluids. The results of pH measurement operation 4200 can indicate that fluids 4110 and 4112 have similar buffer strength. In contrast, in pH measurement operation 4202, the measured pH has a relatively shallow gradient from sensor terminals 4102a to 4102d (e.g., pH4 to pH5.5), and a relatively steep gradient between sensor terminals 4102d and 4102c (e.g., pH5.5 to pH8.4). This can indicate that fluid 4110 has a much higher buffer strength than fluid 4112, and a mixture of fluid 4110 and 4112 exhibits a relatively small pH change from standalone fluid 4110. In the region between sensor terminals 4102d and 4102e, because very little of fluid 4110 is present and the mixture is dominated by fluid 4112, the pH value of such a mixture is dominated by fluid 4112. Accordingly, sensor terminal 4102e outputs a pH close to 9.

Referring to FIG. 42B, in some examples, microfluidic sensor 4100 can be coupled to (or include) a flow control system 4220 to set the flow rates of fluids 4110 and 4112 based on the signals provided by sensor terminals 4102a-e. For example, if the signals provided by sensor terminals 4102a-c indicate that the buffer strength of one of the fluids (e.g., fluid 4110) far exceeds the buffer strength of the other fluid (e.g., fluid 4112), such as shown in operation 4202, flow control system 4220 can reduce the flow rate of the fluid having the much higher buffer strength. In some examples, flow control system 4220 can include components integrated into microfluidic sensor 4100, such as including valve 3302. Referring back to FIGS. 33A and 33B, flow control system 4220 can move bubble 3332, or enable heater 3318 to expand bubble 3332, to block the fluid having the stronger buffer strength from entering fluid cavity 408 from opening 410a.

FIG. 42C illustrates another example of microfluidic sensor 4100, which can include split-off reference channels containing 3M KCl solution (or other solutions with approximately zero liquid junction potential) similar to examples described above (e.g., FIG. 26B) to provide liquid junction potential measurements, and the measurement results can be used to eliminate/attenuate the liquid junction potential component in the pH measurements. Specifically, in FIG. 42C, microfluidic sensor 4100 can include reservoirs 4210a, 4210b, 4210c, 4210d, and 4210c each coupled to fluid cavity 408 via, respectively, openings 4212a, 4212b, 4212c, 4212d, and 4212e. Each reservoir can include a respective sensor terminal (e.g., one of sensor terminals 4124a-4214c) and can hold a 3M KCl solution and forms a pair of sensor terminals with one of sensor terminals 4102a-4102e in fluid cavity 408. As the KCl solution mixes with the fluid(s) in fluid cavity 408, each of pair sensor terminals (e.g., sensor terminals 4102a and 4214a, 4102b and 4214b, 4102c and 4214c, 4102d and 4214d, and 4102c and 4214c) can measure a potential difference representing the liquid junction potential of the fluid(s) at a particular location in fluid cavity 408. The measurement result can be used to remove/attenuate the liquid junction potential component in the pH measurements provided by sensor terminals 4102a-4102e as described above.

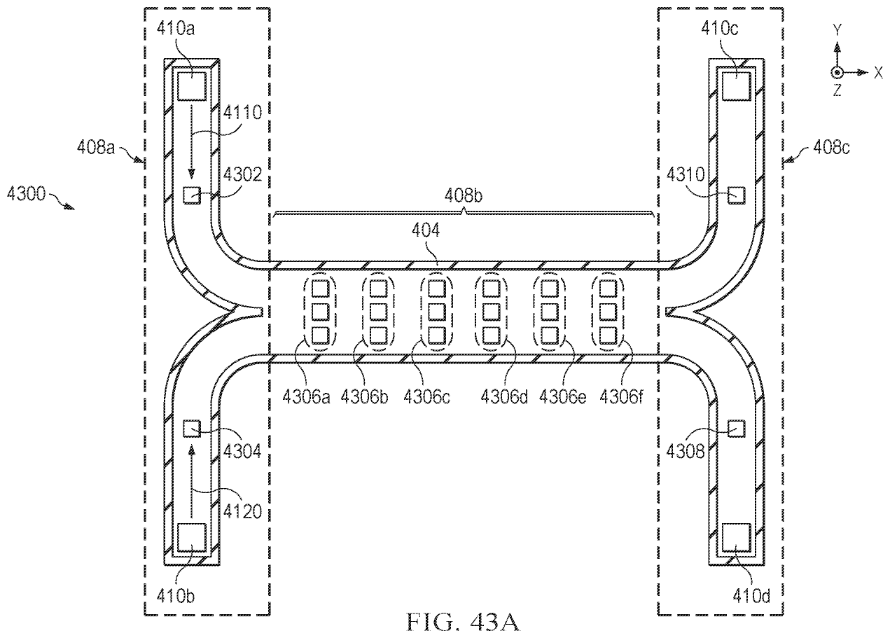

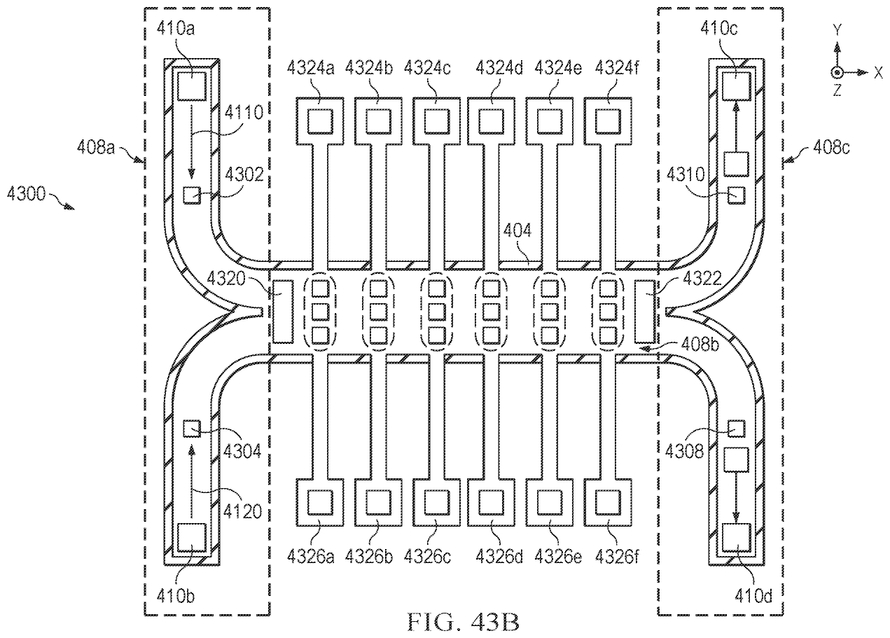

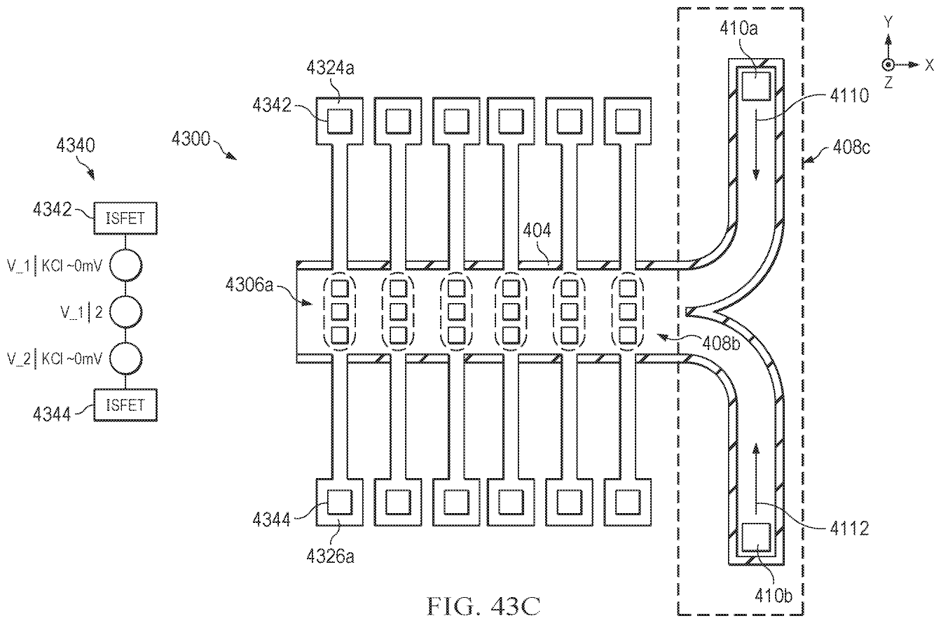

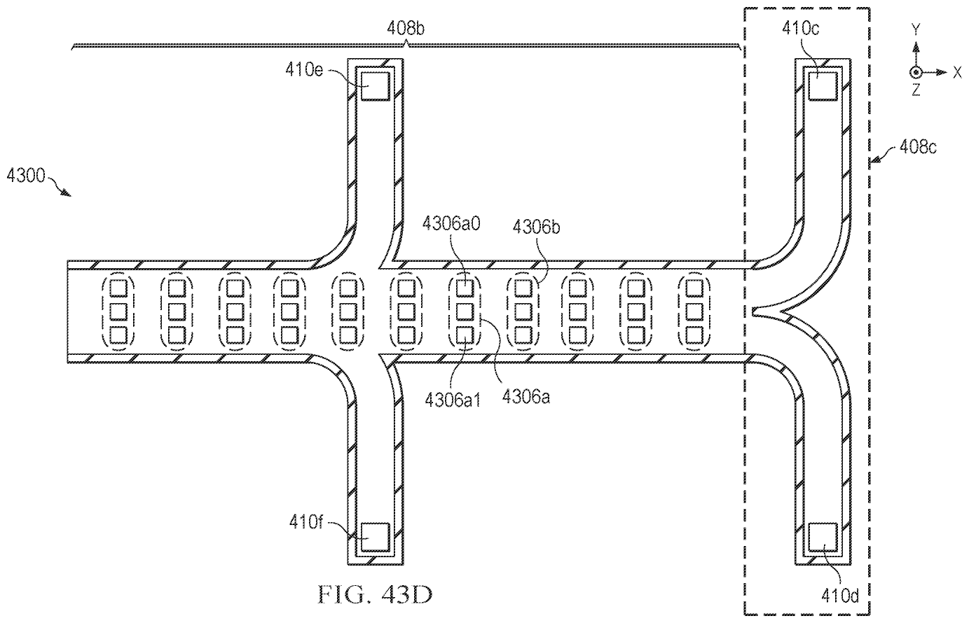

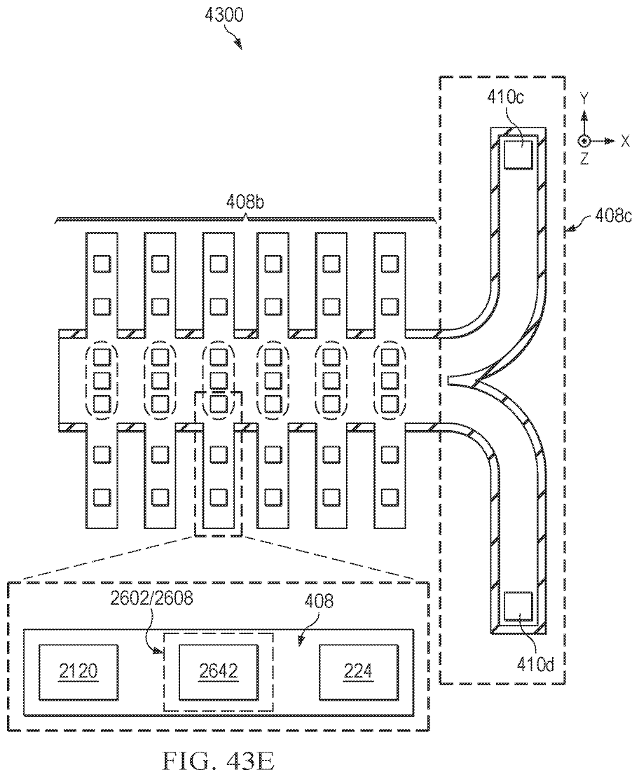

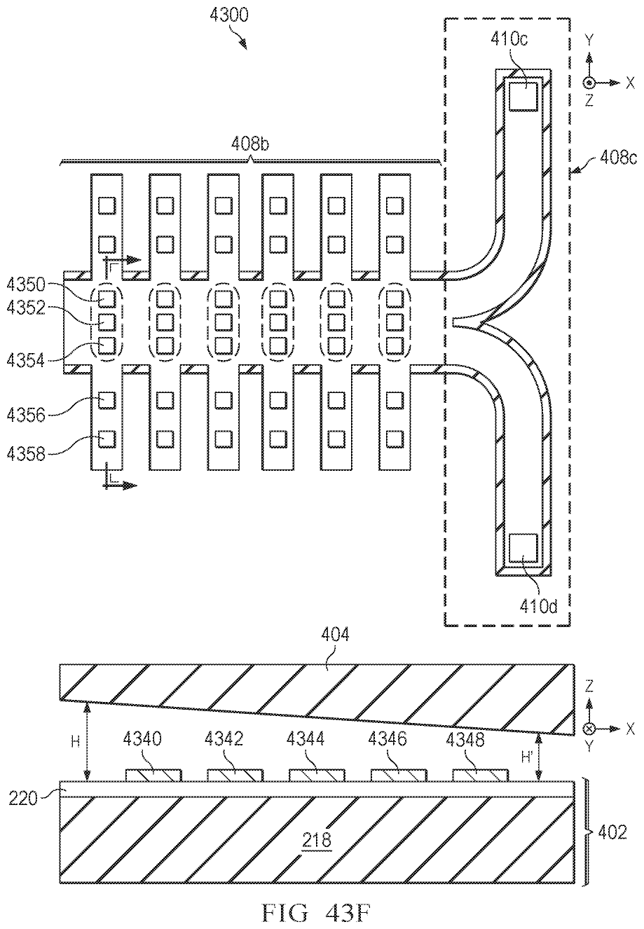

In some examples, a microfluidic sensor can include sensor terminals arranged in a two-dimensional array. Such arrangements allow spatiotemporal tracking of mixing (or reactions due to mixing) between two fluids. FIGS. 43A and 43B are schematics illustrating examples of microfluidic sensor 4300 including sensor terminals arranged in a two-dimensional array.

FIG. 43A illustrates a plan view of an example microfluidic sensor 4300. Microfluidic sensor 4300 can be an integrated circuit including fluidic structure 404 that encloses fluid cavity 408. Fluidic structure 404 can include openings 410a, 410b, 410c, and 410d. Openings 410a and 410b can extend to a branch portion 408a of fluid cavity 408, and openings 410c and 410d can extend to a branch portion 408c of fluid cavity 408. Fluid cavity 408 also includes a middle portion 408b coupled between branch portions 408a and 408c. Openings 410a and 410b can be inlets and opening 410c and 410d can be outlets. Opening 410a can receive a first fluid (e.g., fluid 4110), and opening 410b can receive a second fluid (e.g., fluid 4112). Branch portion 408a can separate the first and second fluids until they converge at middle portion 408b, and the first and second fluids can mix as they flow across middle portion 408b. The mixture can enter branch portion 408c and exit fluid cavity 408 via openings 410c and 410d.

Also, microfluidic sensor 4300 can include sensor terminals 4302, 4304, groups of sensor terminals 4306, such as groups 4306a, 4306b, 4306c, 4306d, 4306c, and 4306f, and sensor terminals 4308 and 4130. Sensor terminals 4302 and 4304 are in branch portion 408a, and sensor terminals 4308 and 4130 are in branch portion 408c. Sensor terminals 4302 can measure the pH of fluid 4110, and sensor terminal 4304 can measure the pH of fluid 4112, prior to the mixing of the fluids in middle portion 408b. Further, sensor terminals 4308 and 4310 can measure the pH of the mixed fluids as they exit through openings 410c and 410d.

Further, each group of sensor terminals 4306 can measure the pH values of the mixture along a first dimension (e.g., along the y-axis) of middle portion 430c. A group of sensor terminals can provide a pH gradient measurement indicating the relative buffer strength or a state of reaction between the two fluids at a particular location along a second dimension (e.g., along the x-axis) of middle portion 430c. As the fluids mix while propagating along the second dimension, the pH gradient may change due to, for example, different diffusion speeds of the fluids, reactions due to mixing of the fluids, and flow speed, etc. Accordingly, different groups of sensor terminals 4306 may output different pH gradient measurements that indicate a progress of mixing or a progress of a chemical reaction between the two fluids with respect to time.

In FIG. 43A, the mixing of two fluids can lead to a liquid junction potential at the junction between the two fluids. Accordingly, the potential difference ΔV between any two ISFETs inside of the middle portion 408b (e.g., between ISFETs coupled to sensor terminals 4306a) can include a pH component and a liquid junction potential component, as follows:

$$ΔV = b ( S \times {ΔpH}_{1 \vert 2} + {V}_{LJP , 1 \vert 2} ) \qquad ( Equation 10 )$$

In Equation 10, ΔpH_{1|2} can represent the pH component from the mixing of fluids 4110 (fluid 1) and 4120 (fluid 2), and V_{LJP,1|2} can represent the liquid junction potential between the two fluids. Both ΔpH_{1|2} and V_{LJP,1|2} vary along the second dimension, and V_{LJP,1|2} can affect the accuracy of AV in representing the pH of the mixed fluids.

FIG. 43B illustrates an example of microfluidic sensor 4300 that provides liquid junction potential measurements as well as measurements of the ohmic drop potential. Referring to FIG. 43B, microfluidic sensor 4300 can include voltage/control terminals 4320 and 4322 on opposite sides of middle portion 408b. Microfluidic sensor 4300 can also include split-off reference channels containing reference buffer solution similar to examples described above (e.g., FIG. 26B). Each split-off reference channel includes a reservoir holding the reference buffer solution (for example, a solution containing 3M KCl) and a fluid conduit structure coupled between the reservoir and middle portion 408b, and a sensor terminal (and an ISFET) in the reservoir. In FIG. 43B, microfluidic sensor 4300 can include a pair of split-off reference channels 4324a-f and split-off channels 4326a-f. Each pair of split-off channels are on opposites sides of one group of sensor terminals 4306a-f (e.g., along the first dimension, the y-axis). For example, split-off reference channels 4324a and 4326a are on opposite sides of sensor terminals 4306a, split-off reference channels 4324b and 4326b are on opposite sides of sensor terminals 4306b, split-off channels 4324c and 4326c are on opposite sides of sensor terminals 4306c, split-off reference channels 4324d and 4326d are on two sides of sensor terminals 4306d, split-off reference channels 4324e and 4326e are on two sides of sensor terminals 4306e, and split-off reference channels 4324f and 4326f are on two sides of sensor terminals 4306f. In some examples, microfluidic sensor 4300 can include a valve between each split-off reference channel and middle portion 408b (e.g., valve 3302 of FIG. 33B), and the valve can be periodically opened or close to allow mixing of the fluid(s) in middle portion 408b with the KCl containing reference buffer solution, so that the junction potential between the fluids and the KCl containing reference buffer solution can be at zero.

Voltage/control terminals 4320 and 4322 can each be coupled to a voltage source to apply an electrical potential across middle portion 408b along the x axis. Also, the sensor terminals at the reservoirs of the split-off channels are in contact of the KCl containing reference buffer solution having a constant pH_{Ref}. Accordingly, these sensor terminals can measure the electrical potentials at the junction between the split-off channels and middle portion 408b. The potential differences measured by the sensor terminals for each pair of split channels on two sides of middle portion 408b can have components representing the pH within middle portion 408b, and the ohmic drop between voltage/control terminals 4320 and 4322.

FIG. 43C illustrates a circuit model 4340 representing the electrical potentials between sensor terminals 4342 and 4344 of split-off channels 4324a and 4326a and across sensor terminals 4306a. Referring to circuit model 4340, ISFETs coupled to sensor terminals 4342 and 4344 can include a liquid junction potential between fluid 4110 and KCl of V_{1|KCl} (which is close to 0 mV), a potential V_{1|2} that reflects the electrical potential in middle portion 408b, and another liquid junction potential between fluid 4120 and KCl of V_{2|KCl} (which is also close to 0 mV). Sensor terminal 4342 can measure a potential of:

$$V1 = b \times S \times {pH}_{Ref} \qquad ( Equation 11 )$$

And sensor terminal 4344 can measure a potential of:

$$V2 = b \times ( {V}_{1 \vert 2} + S \times {pH}_{Ref} ) \qquad ( Equation 12 )$$

Since b is known, the potential difference V_{1|2}=V_{LJP,1|2} can be obtained by the difference between V2 and V1. Since the ohmic drop potential depends on the location along the x axis within middle portion 408b, which is identical for opposite terminals such as 4324a and 4326a, there is no ohmic drop component in Equations 11 and 12.

Accordingly, the ohmic drop potential V_{Ohm} between two horizontally (i.e., along the x axis) arranged split-off reference channels such as 4324a and 4324b can be obtained by subtraction of their respective measured potentials, which will result in the potential difference V_{1|2}=V_{Ohm}, since no liquid junction component arises between horizontally arranged reference channels.

FIG. 43D illustrate another example of microfluidic sensor 4300. In FIG. 43D, microfluidic sensor 4300 can include additional inlets 410e and 410f on opposite sides of middle portion 408b. Each of inlets 410e and 410f can receive a KCl containing reference buffer solution, which can enter middle portion 408b from the opposite sides. Sensor terminals within each sensor terminal group (e.g., 4306a) on opposite sides of middle portion 408b along the y-axis (e.g., sensor terminal 4306a0 and 4306a1 in FIG. 43D) can sense a potential difference V_{1|2}=V_{LJP,1|2}. Also, sensor terminals in different sensor terminal groups (e.g., 4306a and 4306b) can provide a measurement of the ohmic drop potential V_{Ohm} as described above.

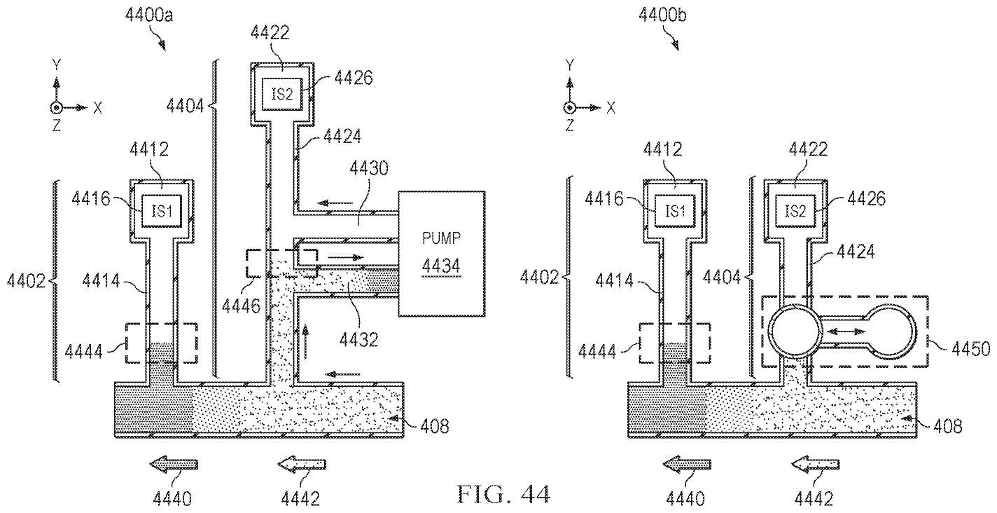

FIG. 43E and FIG. 43F illustrate additional examples of microfluidic sensor 4300 to measure (or provide an estimation of) ionic strength. Referring to FIG. 43E, microfluidic sensor 4300 can include a nanofluidic channel 2608 of FIGS. 26A-26C in each split-off channel, and each split-off channel can include multiple sensor terminals similar to microfluidic sensor 2100b of FIG. 26C. For example, sensor terminal labelled “1” can correspond to sensor terminal 2120, sensor terminal labelled “2” can correspond to sensor terminal 2642, and sensor terminal labelled “3” can correspond to sensor terminal 224. If a measured potential difference between the ISFETs coupled to 2120, 2642, and 224 arises, this may indicate a low ionic strength. In some examples, as shown in FIG. 43F, the split-off channel may include multiple sensor terminals including sensor terminals 4350, 4352, 4354, 4356, and 4358, and the split-off channel height may decrease (e.g., from H to H′) with distance from middle portion 408b. As soon as the Debye length is on the same order as the reduced channel height H′, nanofluidic surface potentials will arise and the respective ISFET coupled to the sensor terminal underneath H′ will show a non-zero potential deviation with regards to the potential of the previous, larger channel height. Since the Debye length d is directly correlated to the ionic strength I via d˜I^{-0.5}, such an arrangement can be used to measure the ionic strength. Additional 4-electrode impedance structures (omitted in the FIGS. 43 and 44 for brevity) can serve to do a conductivity measurement to further confirm the ionic strength measurement and give additional confidence in the measurement result.

FIG. 44 are schematics illustrating examples of a microfluidic sensor 4400 to support measurement of a liquid junction potential between two fluids, in a case where the two fluids are introduced to fluid cavity 408 sequentially. The fluids may be introduced into fluid cavity 408 sequentially to, for example, support differential sensing as described above. FIG. 44 illustrates a microfluidic sensor 4400a and a microfluidic sensor 4400b. Each of microfluidic sensors 4400a and 4400b can include split-off reference channels 4402 and 4404. Split-off reference channel 4402 includes a reservoir 4412 to hold a 3M KCl containing reference buffer solution, a fluid conduit structure 4414 coupled between reservoir 4412 and fluid cavity 408, and a sensor terminal 4416 in reservoir 4412. Also, split-off reference channel 4404 includes a reservoir 4422 to hold a 3M KCl containing reference buffer solution, a fluid conduit structure 4424 coupled between reservoir 4422 and fluid cavity 408, and a sensor terminal 4426 in reservoir 4422. Split-off reference channel 4402 may include a similar arrangement as described for 4404, but is omitted in FIG. 44 and the following figures showing similar arrangements for brevity.

In addition, microfluidic sensor 4400a includes openings 4430 and 4432 at fluid conduit structure 4424, and a pump 4434 coupled to openings 4430 and 4432. Cavity 408 of microfluidic sensor 4400 can first be filled with a first fluid 4440, followed by a second fluid 4442. After cavity 408 is filled with first fluid 4440, a liquid junction 4444 can form between the KCl containing reference buffer solution and first fluid 4440. When second fluid 4442 enters cavity 408 to displace or mix with first fluid 4440, pump 4434 can pump the KCl containing reference buffer solution into fluid conduit structure 4424 via opening 4430 and remove first fluid 4440 from fluid conduit structure 4424 via opening 4432. The pump action can create a liquid junction 4446 between the KCl containing reference buffer solution and second fluid 4442. Accordingly, the potential difference sensed by sensor terminals 4416 and 4426 in microfluidic sensor 4400a can represent the junction potential between first fluid 4440 and second fluid 4442. In some examples, fluid conduit structure 4414 can also include a pump to perform similar operations as pump 4434.

Also, microfluidic sensor 4400b includes a valve 4450 (e.g., valve 3302 of FIGS. 33B and 33C) at fluid conduit structure 4424. When cavity 408 is filled with first fluid 4440, valve 4450 can be closed to disconnect fluid conduit structure 4424 and reservoir 4422 from cavity 408. First fluid 4440 can flow into fluid conduit structure 4414, and liquid junction 4444 between the KCl containing reference buffer solution and first fluid 4440 can be created in fluid conduit structure 4414. When second fluid 4442 enters cavity 408 to displace or mix with first fluid 4440 (and equilibrium is reached), valve 4450 can be opened, which allows second fluid 4442 to enter fluid conduit structure 4424, and liquid junction 4446 (not shown in microfluidic sensor 4400b) can be created in fluid conduit structure 4424 between the KCl containing reference buffer solution and second fluid 4442. Accordingly, the potential difference sensed by sensor terminals 4416 and 4426 in microfluidic sensor 4400b can also represent the junction potential between first fluid 4440 and second fluid 4442. In some examples, fluid conduit structure 4424 can also include a pump or a valve to perform similar operations as valve 4450.

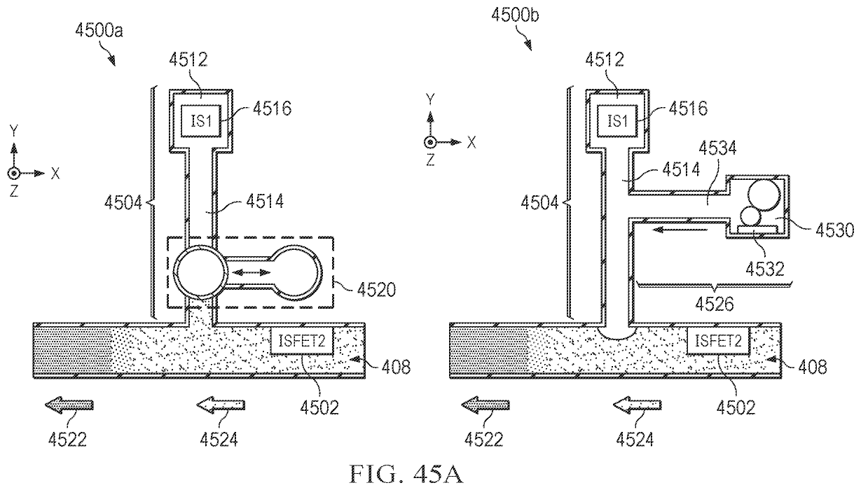

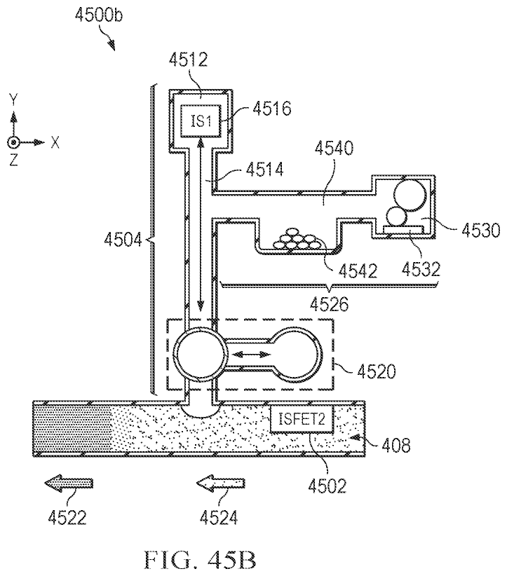

FIG. 45A and FIG. 45B are schematics illustrating examples of a microfluidic sensor 4500 to support elimination of a liquid junction potential between two fluids, in a case where the two fluids are introduced to fluid cavity 408 sequentially. The fluids may be introduced into fluid cavity 408 sequentially to, for example, support differential pH sensing as described above. To eliminate the liquid junction potential between the two fluids, microfluidic sensor 4500 can bring the fluid being measured/sensed mix with a KCl containing reference buffer solution to bring the liquid junction potential of the fluid to zero, and the liquid junction potential component in the pH measurement of the fluid can be eliminated or at least attenuated.

FIG. 45A illustrates a microfluidic sensor 4500a and a microfluidic sensor 4500b. Each of microfluidic sensors 4500a and 4500b includes fluid cavity 408, a sensor terminal 4502 in fluid cavity 408, and a split-off reference channel 4504. Split-off reference channel 4504 includes a reservoir 4512 to hold a 3M KCl containing reference buffer solution, a fluid conduit structure 4514 coupled between reservoir 4512 and fluid cavity 408, and a sensor terminal 4516 in reservoir 4512.

Microfluidic sensor 4500a also includes a valve 4520 (e.g., valve 3302 of FIGS. 33A and 33B) to control the release of the KCl solution into fluid cavity 408 from reservoir 4512. When a first fluid 4522 enters and fills fluid cavity 408, valve 4520 can be opened to release the KCl containing reference buffer solution into fluid cavity 408, and the KCl containing reference buffer solution mixes with first fluid 4522. The mixing can set the liquid junction potential of first fluid 4522 to zero, and a potential difference measured by sensor terminals 4502 and 4516 can represent, for example, the pH of first fluid 4522, with the liquid junction potential component eliminated or at least attenuated to improve the precision of the pH measurement. Also, as a second fluid 4524 enters fluid cavity 408, before second fluid 4524 displaces first fluid 4522 and equilibrium is reached, valve 4520 can be closed to stop the KCl containing reference buffer solution from mixing with the fluids in fluid cavity 408. After second fluid 4524 displaces first fluid 4522 in fluid cavity 408 and equilibrium is reached, valve 4520 can be opened to release the KCl containing reference buffer solution into fluid cavity 408 and set the junction potential of second fluid 4524 to zero. A potential difference measured by sensor terminals 4502 and 4516 can then represent, for example, the pH of second fluid 4524, with the liquid junction potential component also eliminated or at least attenuated to improve the precision of the pH measurement.

Also, microfluidic sensor 4500b includes a pump 4526 including a reservoir 4530, a control terminal 4532 in reservoir 4530, and a fluid conduit structure 4534 coupled between reservoir 4530 and fluid conduit structure 4514. Reservoir 4530 can hold the KCl containing reference buffer solution. Control terminal 4532 can be coupled to a voltage source (not shown in the figure), and can start an electrolysis process to generate gas responsive to receiving a signal from the voltage source. The gas can force the KCl containing reference buffer solution out of reservoir 4530 through fluid conduit structures 4534 and 4514 into fluid cavity 408. Pump 4526 can be enabled to force the KCl containing reference buffer solution into fluid cavity 408 after first fluid 4522 fully fills fluid cavity 408 and reaches equilibrium, and after second fluid 4524 fully displaces (or mixes with) first fluid 4522 and reaches equilibrium. Pump 4526 can be disabled during other times.

Also, FIG. 45B illustrates a microfluidic sensor 4500c including both valve 4520 and pump 4526, and a salt container 4540 coupled between fluid conduit structure 4514 and reservoir 4530. Microfluidic sensor 4500c can also include KCl salt crystals 4542 in salt container 4540. The KCl salt crystals 4542 can dissolve so that the KCl containing reference buffer solution in reservoirs 4512 and 4530 are saturated. Such arrangements can allow precise pH measurement over a long time.

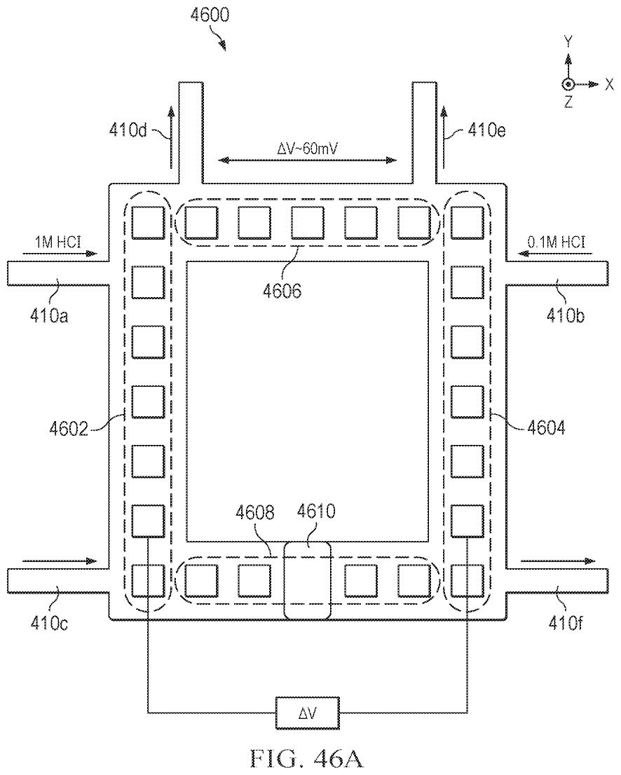

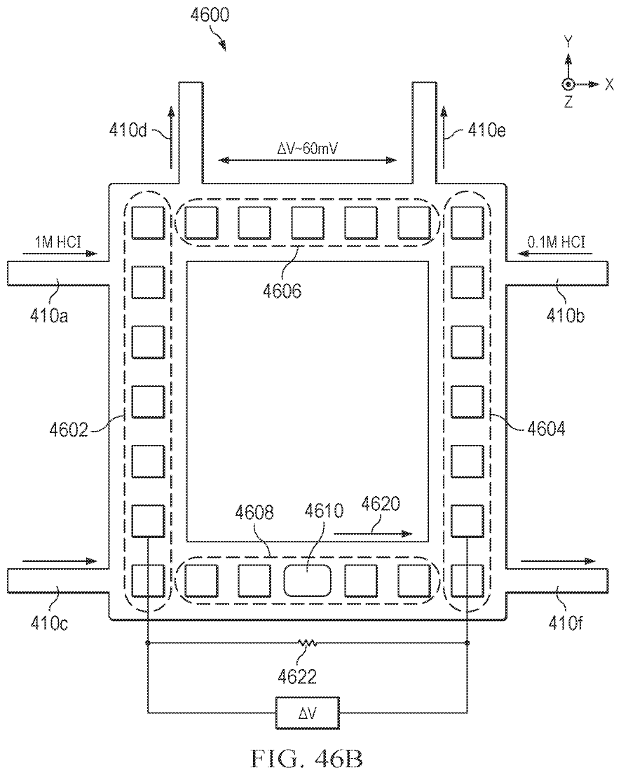

FIGS. 46A and 46B illustrate plan view of an example microfluidic sensor 4600. Microfluidic sensor 4600 can include components of microfluidic sensor 4300, such as fluid cavity 408 enclosed in fluidic structure 404, and openings 410a, 410b, 410c, 410d, 410c, and 410f. Fluid cavity 408 can be in the form a ring and include sensor terminals along the ring and between the openings. For example, sensor terminal group 4602 can be along part of the ring between openings 410a and 410c, sensor terminal group 4604 can be along part of the ring between openings 410b and 410f, sensor terminal group 4606 can be along part of the ring between openings 410d and 410c, and sensor terminal group 4608 can be along part of the ring between openings 410c and 410f.

Microfluidic sensor 4600 can provide a 2-dimensional gradient generator, which can be used to determine electrochemical properties of two unknown fluids, or of one unknown fluid. In the example of FIGS. 46A and 46B, different molar concentrations of a fluid, such as hydrochloric acid, (HCl) are introduced. As an example for the two unknown fluids, opening 410a can receive 1M HCl, and opening 410b can receive 0.1M HCl. Opening 410c can receive a KCl containing reference buffer solution (e.g., 3M KCl). Also, openings 410d, 410e, and 410f can receive the outflow of the respective fluids. A concentration/diffusion gradient between the 1M HCl and the 0.1M HCl solution is formed across fluid cavity 408 between openings 410a and 410b. Also a concentration/diffusion gradient between the 1M HCl and the KCl buffer solution is formed across fluid cavity 408 between openings 410a and 410c. Further, a concentration/diffusion gradient between the 0.1M HCl and the KCl buffer solution is also formed across fluid cavity 408 between openings 410b and 410f.

Also, microfluidic sensor 4600 can include a valve 4610, which can be a bubble valve. Valve 4610 can be controlled to stop (or enable) ionic electric currents and block (or unblock) the flow of KCl containing reference buffer solution between openings 410c and 410f for short periods of time. During that time, the potential difference ΔV sensed by sensor terminal groups on two sides of valve 4610, such as sensor terminal groups 4602 and 4604, can be equal to the liquid junction potential between the two fluids; here in the example 1M and 0.1M HCl. The generation of the potential difference ΔV leads to formation of a liquid junction battery.

Also, referring to FIG. 46B, when valve 4610 is opened, the flow of KCl can resume, and the potential difference ΔV measured by sensor terminal groups 4602 and 4064 can decrease. The decrease of the potential difference can be due to an ionic current 4620 which can flow and decrease the potential due to the ohmic drop across the liquid junction battery. The ohmic drop is represented by resistor 4622 in FIG. 46B. The flow of current depends on the total conductivity of the fluids located across the cavity 408, and acts to equilibrate the system, which will change the gradient between openings 410a and 410b, and this change of potential (and in some cases, of pH) can be detected by sensor terminal group 4606 across the gradient between openings 410a and 410b. This change depends on properties such as ionic activities and ionic strength, and can give an indication as to the nature of the (difference between the) first two fluids. This allows study of various electrochemical properties of the two fluids (1M and 0.1M HCl) under a potential difference, as well as fingerprinting of an unknown fluid.

In some examples, a method of operating an example microfluidic sensor as described herein can include: receiving first and second electrical potential measurements from, respectively, a first sensor terminal and a second sensor terminal of a microfluidic sensor when the first and second sensor terminals are exposed to a first fluid; exposing the first sensor terminal to a second fluid at a second time; exposing the second sensor terminal to the second fluid at a third time after the second time by delaying a transportation of the second fluid to the second terminal by a restriction structure of the microfluidic sensor; receiving third and fourth electrical potential measurements from, respectively, the first and second sensor terminals between the second and third times; and generating a pH measurement of the second fluid based on a difference between the second and fourth electrical potential measurements.

In some examples, the method further comprises applying an electrical potential to the first and second fluids via one of: a discrete reference electrode separate from the microfluidic sensor, or a voltage terminal on a surface of the microfluidic sensor.

In some examples, the first and second sensor terminals are in the restriction structure.

In some examples, the second sensor terminal is in a nanofluidic channel within the restriction structure.

In some examples, a method of operating an example microfluidic sensor as described herein can include: receiving a first electrical potential measurement from a first sensor terminal in a buffer solution, in which the first sensor terminal is in a first reservoir including the buffer solution, the first reservoir is coupled to a fluid cavity via a first connection structure, the fluid cavity is also coupled to a second reservoir including the buffer solution via a second connection structure, the microfluidic cavity includes a first fluid, and the first fluid mixes with the buffer solution and forms a first fluid and buffer liquid junction in the first and second connection structures; enabling a second fluid to enter the second connection structure via the fluid cavity to mix with the buffer solution and to form a second fluid and buffer liquid junction in the second connection structure; receiving a second electrical potential measurement from a second sensor terminal in the second reservoir when the second fluid and buffer liquid junction is in the second connection structure; and generating an electrical potential representing a liquid junction potential between the first and second fluids.

In some examples, the method further comprises removing the first fluid from the second connections structure by a pump.

In some examples, the method further comprises blocking the first fluid from entering the second connections structure when the first fluid enters the fluid cavity.

In some examples, a method of operating an example microfluidic sensor as described herein can include: enabling a first fluid to enter a fluid cavity; releasing a buffer solution from a reservoir into the fluid cavity to mix with the first fluid; receiving first and second electrical potential measurements from, respectively, a first sensor terminal in the reservoir and a second sensor terminal in the fluid cavity; generating a first electrical potential difference based on the first and second electrical potential measurements; blocking the buffer solution from entering the fluid cavity; enabling a second fluid to enter the fluid cavity; releasing the buffer solution from the reservoir into the fluid cavity to mix with the second fluid; receiving third and fourth electrical potential measurements from, respectively, the first and second sensor terminals; generating a second electrical potential difference based on the third and fourth electrical potential measurements; and generating a pH measurement of the second fluid based on the first and second electrical potential differences to reduce a liquid junction potential component between the first and second fluids in the pH measurement.

In some examples, the blocking of the buffer solution is by a bubble pump.

In some examples, the reservoir is a first reservoir, and the method further comprises flowing the buffer solution through a second reservoir including salt crystals to saturate the buffer solution.

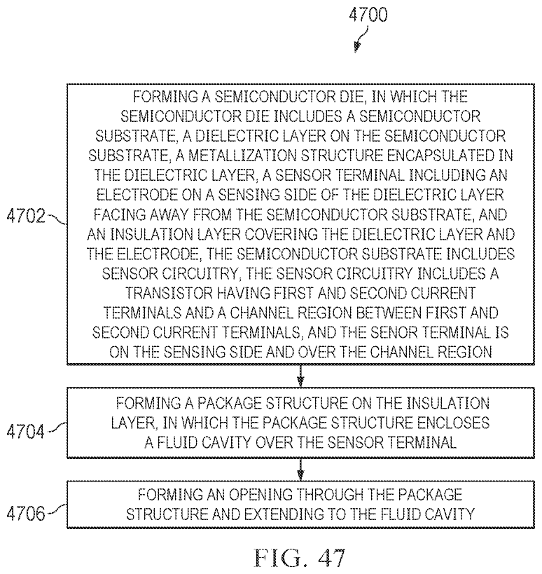

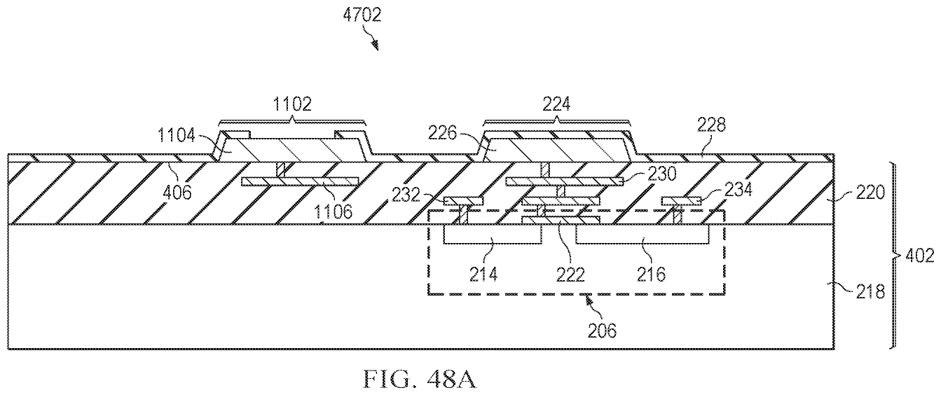

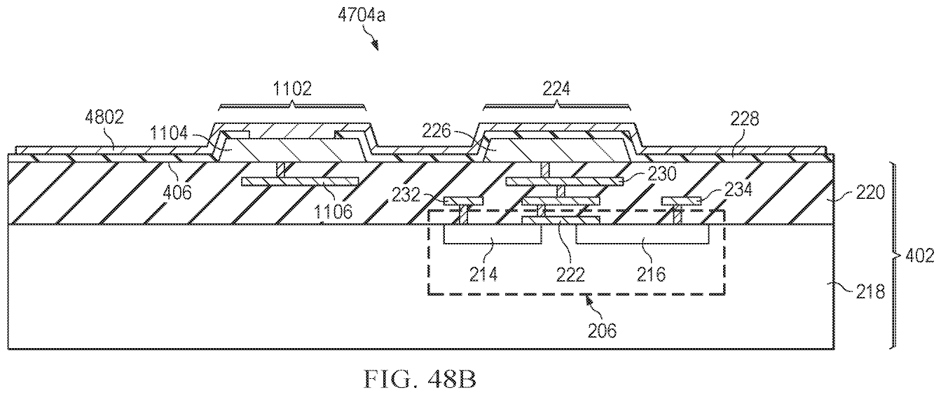

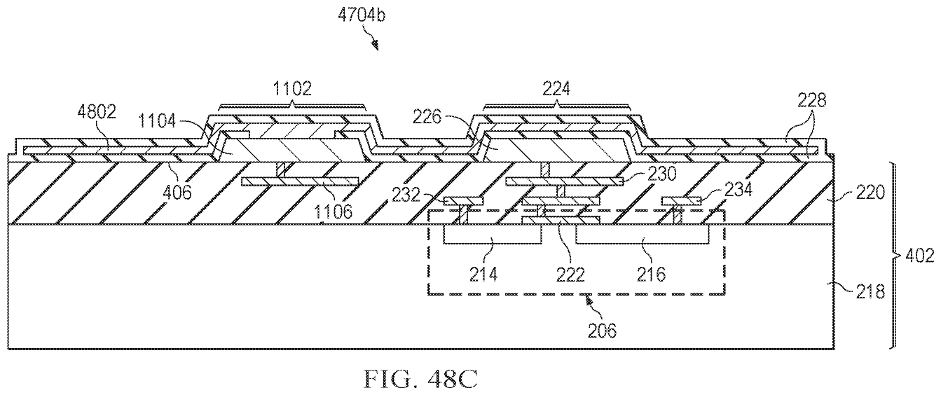

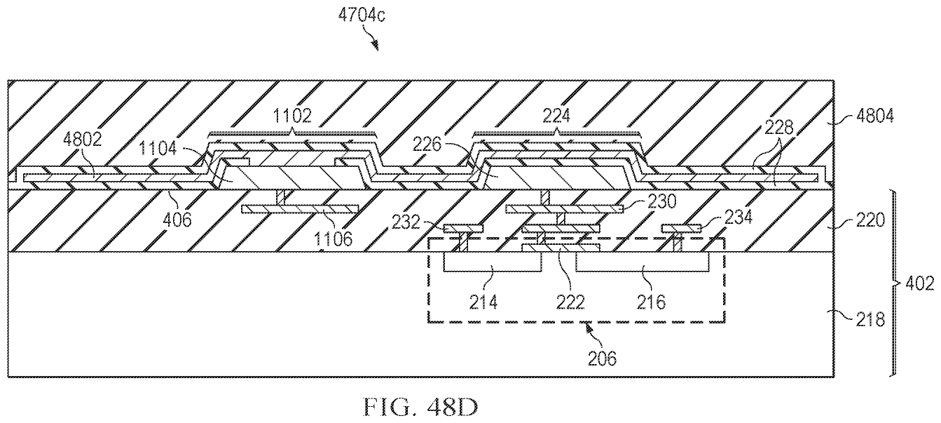

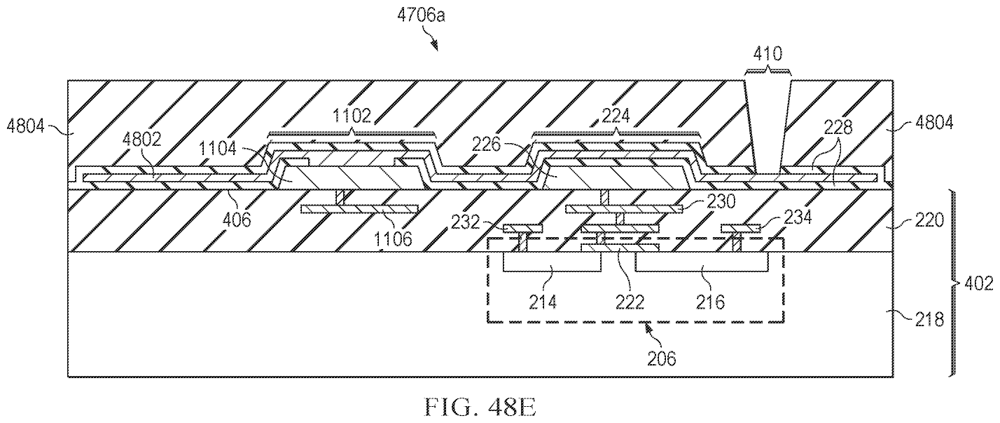

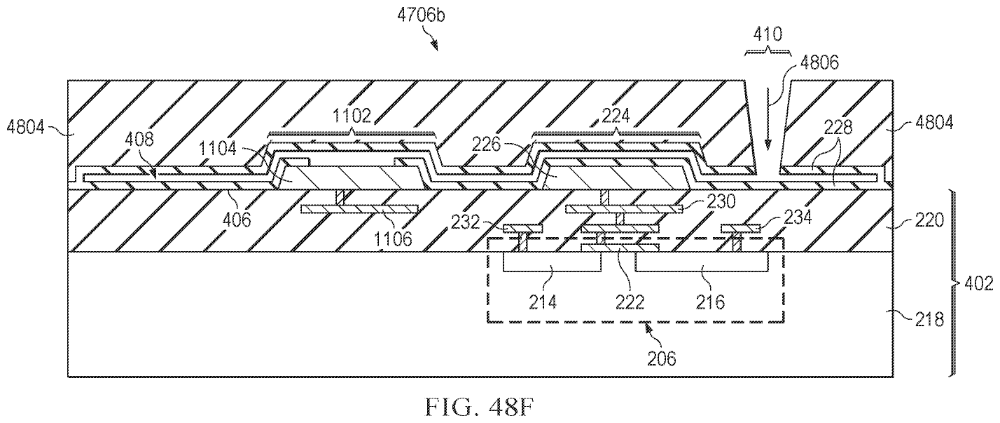

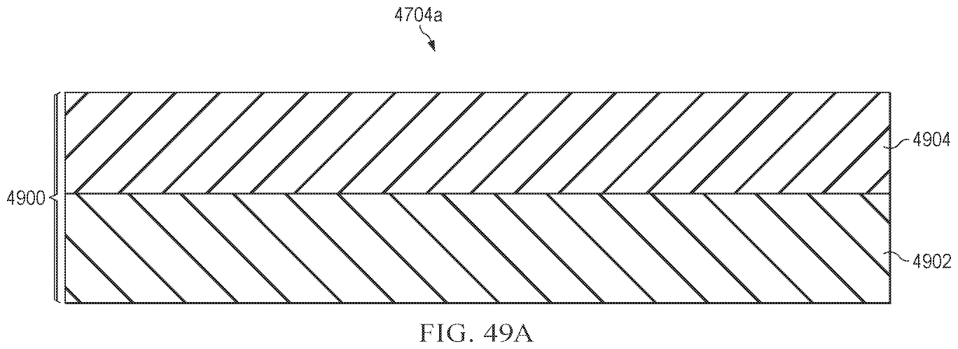

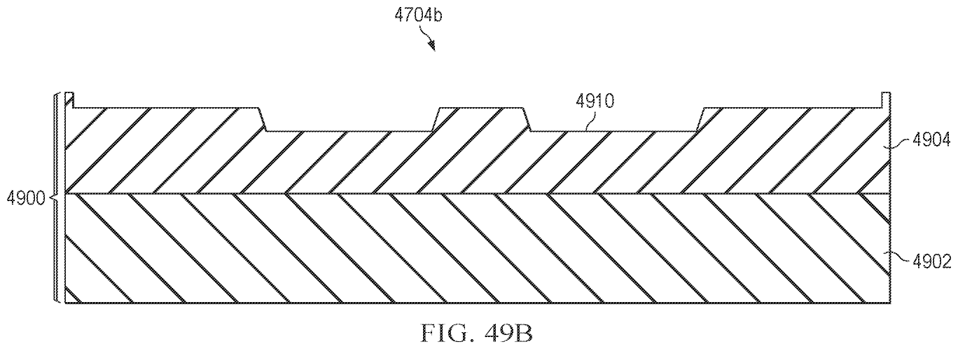

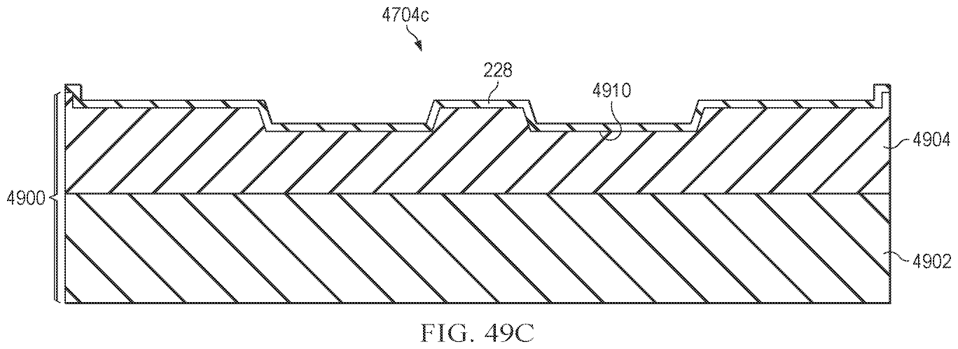

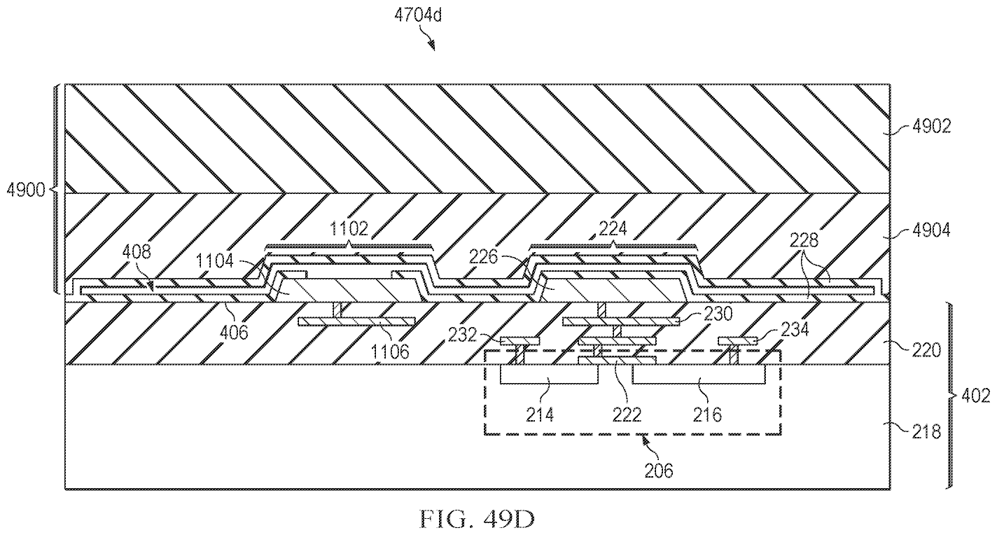

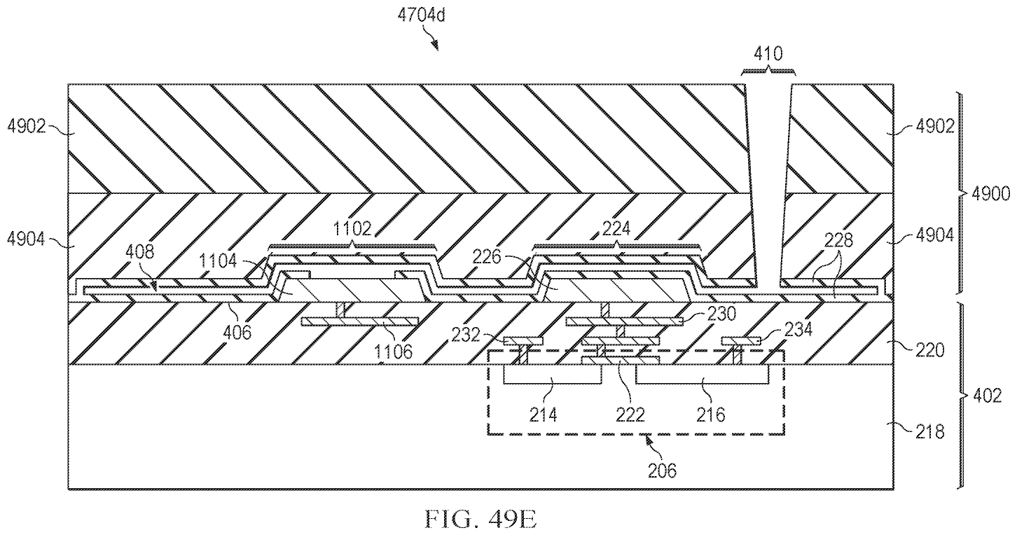

FIG. 47 illustrates a method of fabricating an integrated circuit microfluidic sensor, such as examples of microfluidic sensor illustrated in FIGS. 4 through 46. FIG. 47 illustrates a flowchart 4700 of the example method, and FIGS. 48A, 48B, 49A, and 49B are schematics illustrating various operations of the example method of FIG. 47.

Referring in FIG. 47 and FIG. 48A, in operation 4702, semiconductor die 402 is formed, in which semiconductor die 402 includes semiconductor substrate 218, dielectric layer 220 on the semiconductor substrate, a metallization structure encapsulated in the dielectric layer, an electrode on a sensing side of the dielectric layer facing away from the semiconductor substrate, and an insulation layer covering the dielectric layer and the electrode, the semiconductor substrate includes sensor circuitry, the sensor circuitry includes a transistor having first and second current terminals and a channel region between first and second current terminals, and the senor terminal is on the sensing side and over the channel region, and the sensor terminal is on the sensing side and over the channel region.

Referring to FIG. 48A, in operation 4702, semiconductor die 402 includes semiconductor substrate 218, and dielectric layer 220 on semiconductor substrate 218. The dielectric layer 220 has a sensing side 406 facing away from semiconductor substrate 218. Semiconductor die 402 includes one or more transistors configured as ISFETs, such as an EG-ISFET 206 including gate terminal 222, source terminal 214, and drain terminal 216, and channel region 217 between the drain and source terminals as shown in FIG. 2A. In some examples, semiconductor die 402 includes an OG-ISFET 206 as shown in FIG. 2B. Semiconductor die 402 also includes a metallization structure embedded (or surrounded) in dielectric layer 220 including interconnects 230, 232, and 234 coupled to the respective gate terminal 222 (in a case of EG-ISFET), drain terminal 214, and source terminal 216. Semiconductor die 402 also includes insulation layer 228 covering sensing side 406 of dielectric layer. Examples of insulation layer 228 can include SiO₂, Si₃N₄, Al₂O₃, and Ta₂O₅.

Semiconductor die 402 also includes one or more sensor terminals on sensing side 406, such as sensor terminal 224 including an electrode 226 covered by insulation layer 228. Electrode 226 can be platinum or other noble metals and can be coupled to gate terminal 222 via interconnect 230. In some examples, semiconductor die 402 can also include a voltage terminal on sensing side 406, such as voltage terminal 1102 including an electrode 1104 partially covered by insulation layer 228.

In some examples, as part of operation 4702, a metal layer (Platinum or other noble metals) can be formed on sensing side 406 of dielectric layer 220. The metal layer can be formed by various techniques, such as vacuum deposition (e.g., chemical vapor deposition and physical vapor deposition) and electroplating, followed by patterning of the metal layer (e.g., photolithography and selective etching) to form electrodes 226 and 1104 and to expose dielectric layer 220. Insulation layer 228 can be formed on the patterned metal layer and the exposed dielectric layer 220 using various techniques, such as thermal oxidation, chemical vapor deposition, etc. Insulation layer 228 can be further patterned to expose part of electrode 1104 to form voltage terminal 1102.

Referring again to FIG. 47, in operation 4704, fluidic structure 404 is formed on insulation layer 228, in which fluidic structure 404 encloses fluid cavity 408 over at least sensor terminal 224.

FIGS. 48B-F illustrate examples of sub-operations of operation 4704 to form fluidic structure 404. Referring to FIG. 48B, in sub-operation 4704a, a sacrificial metal layer 4802 can be formed on insulation layer 228, sensor terminal 224, and voltage terminal 1102. In some examples, sacrificial metal layer 4802 can include a Tungsten-Titanium (TiW) alloy. Sacrificial metal layer 4802 can also include a mixture of Chromium (Cr), Nickel (Ni), TiW, Al, Co, TiW, Al, Co, TiN, Ti, Si₃N₄, SiO₂, Pt, Cu, Ta, TaN, or Al₂O₃. Sacrificial metal layer 4802 can have a high etch rate to provide a high selectivity against other materials not to be etched inside fluid cavity 408.

Sacrificial metal layer 4802 can define the footprint and cross-sectional shape of fluid cavity 408. In some examples, multiple layers of sacrificial metal layer 4802 can be formed on insulation layer 228 to define different heights of fluid cavity 408. For example, one layer of sacrificial metal layer 4802 can define nanofluidic channel 2608 of FIG. 26A, and additional layers of sacrificial metal layer 4802 can define the microfluidic channels of the rest of fluid cavity 408. Sacrificial metal layer 4802 can be formed on insulation layer 228 using various techniques, such as vacuum deposition (e.g., evaporation, chemical vapor deposition and physical vapor deposition) and electroplating. In some examples, to create chambers 3312 and 3322, sacrificial metal layer 4802 can be etched using an anisotropic etching operation to have a triangular/trapezoidal cross-sectional, which can define the recessed internal surfaces 3402 and 3404 of chambers 3312 and 3322.

In some examples, the sacrificial material can be deposited (electroplated, CVD, sputtered, etc.) into a pre-defined shape, such as a moat of Si₃N₄ or SiO₂. Sacrificial material can then be planarized, i.e., via CMP or etched back (where some material of the moat is also lost), or reflow in e.g., an oven for materials such as photoresist or spin on glass (SOG). Later, the sacrificial material can be removed out of the moat.

Referring to FIG. 48C, in an optional sub-operation 4704b, another insulation layer 228 can be formed on sacrificial metal layer 4802, to cover the internal surface of fluid cavity 408 with insulation layer 228. As described above, such arrangements can provide a uniform wetting surface, which can reduce measurement error caused by Zeta potential difference due to the fluid being measured/sensed is in contact with two different wetting surfaces. In some examples, insulation layer 228 can be formed by a passivation of sacrificial metal layer 4802.

Referring to FIG. 48D, in sub-operation 4704c, an insulation layer 4804 can be formed on sacrificial metal layer 4802 to form fluidic structure 404, and insulation layer 4804 defines fluid cavity 408. In some examples, insulation layer 4802 can be formed as a passivation layer by continuing the passivation of sacrificial metal layer 4802 as part of a wafer fabrication operation. In some examples, insulation layer 4802 can be formed as a passivation layer including SiO₂, Si₃N₄, or a mixture of both. In some examples, insulation layer 4802 can be formed by chemical vapor deposition (CVD), spin coating, metal deposition (if a mixture of dielectric and metals), etc.

Referring again to FIG. 47, in operation 4706, opening 410 can be formed through fluidic structure 404 and extending into fluid cavity 408.

Referring to FIG. 48E and FIG. 48F, operation 4706 can include sub-operations 4706a and 4706b. In sub-operation 4706a, opening 410 can be formed through insulation layers 4804 and 228 to expose part of sacrificial metal layer 4802. Opening 410 can be formed by selectively etching (after photolithography, not shown) a particular location on insulation layer 4804. Photoresist is subsequently removed wet-chemically or via ashing. Also, in sub-operation 4706b, a reagent 4806 (e.g., hydrogen peroxide) can be provided via opening 410 to etch away sacrificial metal layer 4802 to form fluid cavity 408.

FIG. 49A-49E illustrate additional examples of sub-operations 4704 and 4706. Referring to FIG. 49A, in sub-operation 4706a, a semiconductor die 4900 having a substrate 4902 and an insulation layer 4904 can be formed. Insulation layer 4904 can be a passivation layer and can include SiO₂, Si₃N₄, or a mixture of both.

Referring to FIG. 49B, in sub-operation 4706b, insulation layer 4904 can be etched to form an indented surface 4910. Indented surface 4910 can define the internal surfaces, footprints, and dimensions (height and width) of fluid cavity 408. Referring to FIG. 49C, in an optional sub-operation 4704c, insulation layer 228 can be formed on indented surface 4910 of insulation layer 4904 so that the internal surfaces of fluid cavity 408 can be covered with insulation layer 228.

Referring to FIG. 49D, in sub-operation 4704c, semiconductor die 4900 can be flipped and attached onto semiconductor die 402 from operation 4702, so that indented surface 4910 of semiconductor die 4900 faces sensing side 406 of semiconductor die 402. The space between indented surface 4910 and sensing side 406 can provide fluid cavity 408, and insulation layer 4904 can provide fluidic structure 404. In some examples, insulation layer 4904 can be bonded to insulation layer 228 by heating, or by anodic bonding.

Also, referring to FIG. 49E, in operation 4708, opening 410 can be formed through substrate 4902 and insulation layer 4904. Opening 410 can be formed by etching. In some examples, substrate 4902 can be removed from insulation layer 4904 by a polishing operation. Alternatively, opening was already formed as part of 4706a-c.

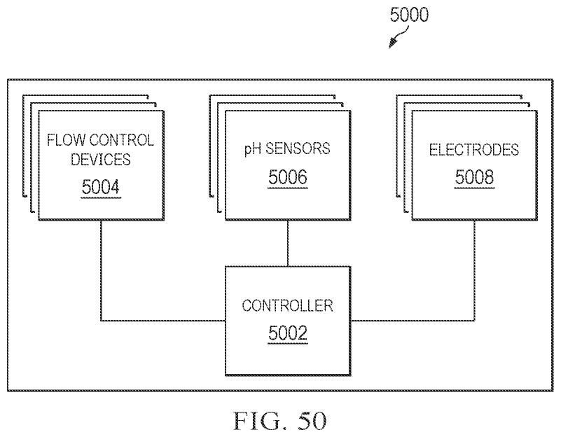

FIG. 50 is a block diagram of an example fluid sensor device 5000 that can be incorporated by the techniques described in FIGS. 1-49E. The fluid sensor device 5000 includes a controller 5002, such as a processor. The controller 5002 is coupled to multiple flow control devices (e.g., valves and pumps) 5004, multiple pH sensors 5006 (e.g., ISFETs), and multiple electrodes 5008. The controller 5002 is configured to dynamically control the flow control devices 5004, pH sensors 5006, and electrodes 5008. The fluid sensor device 5000 may include other structures that facilitate fluid testing, and such structures may be static or dynamic in nature. For example, the controller 5002 also may be coupled to various other structures that may be dynamically controlled to affect the operation of the fluid sensor device 5000.

The flow control devices 5004 (which may include co-located pumps and valves) arc located in and control the flow of fluid through microfluidic channels in the fluid sensor device 5000. Flow control devices 5004 can include valves, pumps, or other flow control structures described in FIGS. 1-49E. The controller 5002 may open and close the flow control devices 5004 independently of each other, both simultaneously and at differing times, to control the timing of flow of fluid between reservoirs coupled to the microfluid channels, which allows differential ion sensing for pH measurement. When no measurement is done, the controller 5002 can close the flow control devices 5004 to prevent contamination by preventing mixing of fluids between the reservoirs, which can increase selectivity and reduce risk of false positive detection.

The pH sensors 5006 may be located within reservoirs (e.g., a main reaction reservoir, detection reservoirs, and a reference reservoir) of the fluid sensor device 5000. The pH sensors 5006 may sense the pH levels of contents of the reservoirs and provide signals to the controller 5002 indicating such pH levels. The electrodes 5008 may be positioned within the aforementioned reservoirs and may emit currents into the reservoirs in amounts and at times determined by the controller 5002. The electrodes 5008 may include anodes, cathodes, or a combination thereof and may be positioned within the fluid sensor device 5000 to enable the controller 5002 to dynamically control the pH levels of the contents of the aforementioned reservoirs by providing currents into the reservoirs. For example, if the controller 5002 determines through a pH sensor 5006 that the pH level of the contents of a particular reservoir is below a threshold, the controller 5002 may dynamically cause an electrode 5008 in that reservoir to provide a current into the reservoir, thereby producing hydroxide (OH—) ions to raise the pH level of the contents of the reservoir. As to be explained below, the controller 5002 can measure the amount of the current provided to electrode 5008 to measure the pH change indicative/representative of replication of a nucleic strand by a reagent in the reservoir.

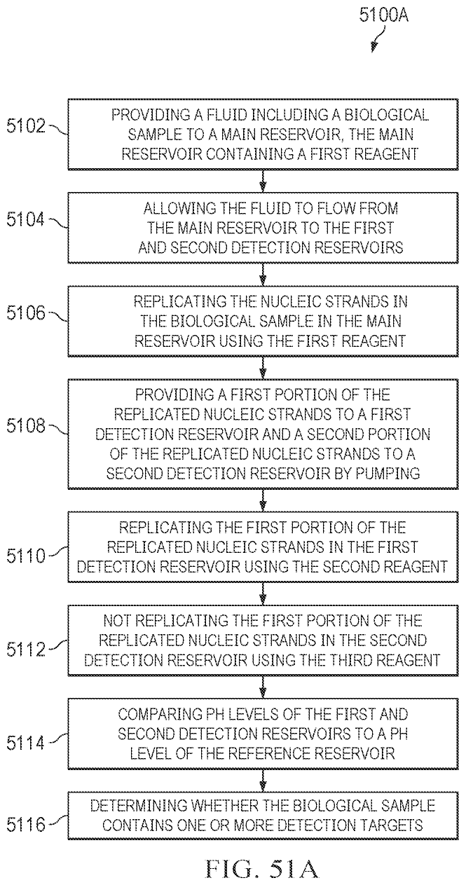

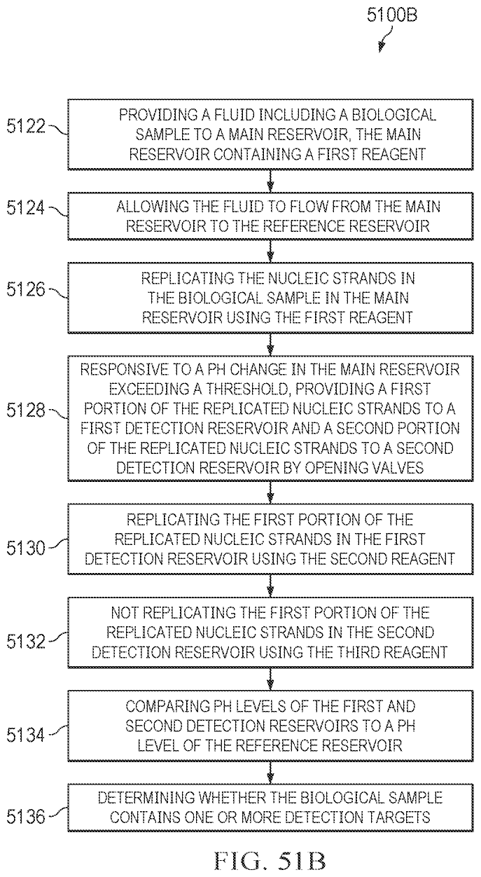

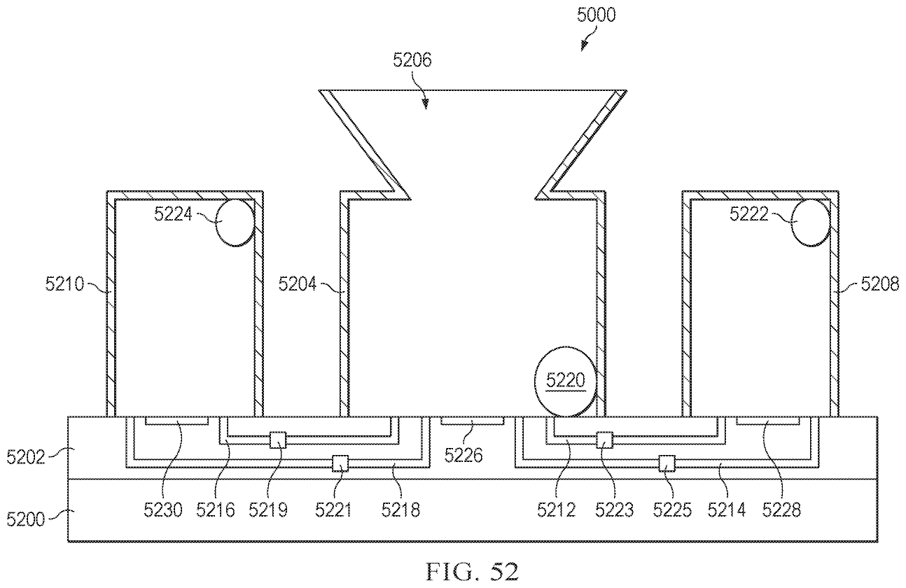

FIGS. 51A and 51B are flow diagrams illustrating example method 5100A and 5100B for performing a fluid sensor test. FIGS. 52, 53, 54, 55, 56, 57, and 58 are schematics of example fluid sensor devices performing a fluid sensor test. Methods 5100A and 5100B can be two alternative methods, or can be performed together or sequentially. The method 5100A can include initial wetting of all reservoirs with a fluid containing a biological sample, including the main reaction reservoir, the reference reservoir, and the detection reservoir(s), followed by replication of all nucleic strands (including non-target nucleic strands and target nucleic strands if present) by reagents in the main reaction reservoir and replication of target nucleic strands (if present) in the detection reservoir(s). If the pH change in the main reaction reservoir exceeds a certain threshold, which indicates one or more detection targets (e.g., a coronavirus, an influenza virus, etc.) may be present in the biological sample, the replicated nucleic strands in the main reaction reservoir can be pumped into various detection reservoir(s) for detection/measurement of specific targets.

Further, the method 5100B can initial wetting of only the main reaction reservoir and the reference reservoir with the biological samples, where initial wetting of the biological samples of the detection reservoirs are prevented by the valves. Replication of all nucleic strands (including non-target nucleic strands and target nucleic strands if present) by reagents in the main reaction reservoir. If the pH change in the main reaction reservoir exceeds a certain threshold, which indicates one or more detection targets (e.g., a coronavirus, an influenza virus, etc.) may be present in the biological sample, the replicated nucleic strands in the main reaction reservoir can be allowed to be transferred into specific detection reservoir(s) by opening of the valves for detection/measurement of specific targets.

The schematics of FIGS. 52-58 are simplified diagrams that are intended to conceptually convey the structure and operation of example fluid sensor devices 5000, but they are not intended to convey the specific structure of any particular fluid sensor device 5000. The methods 5100A and 5100B and the schematics of FIGS. 52-58 are now described in parallel.

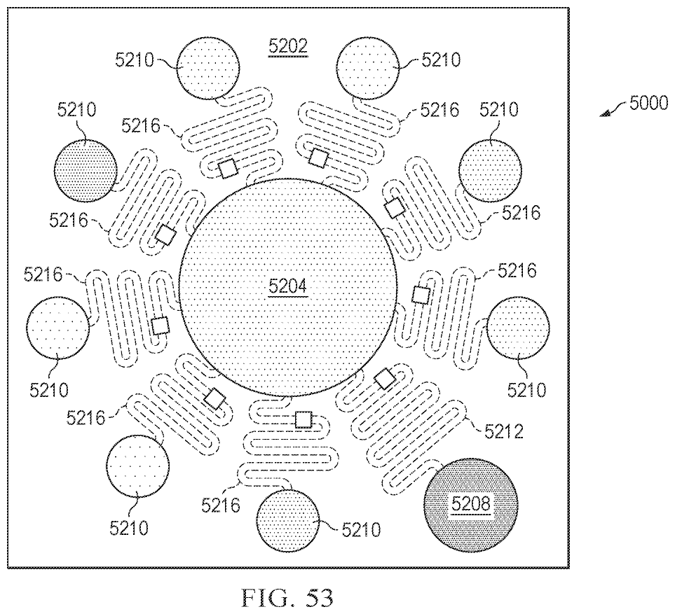

Referring to FIG. 51A, the method 5100A comprises providing a fluid including a biological sample to a main reaction reservoir, where the biological sample includes nucleic strands that may or may not be of the detection target(s), and the main reaction reservoir includes a first reagent (5102). FIG. 52 is a conceptual illustration of an example fluid sensor device 5000, which can be a packaged integrated circuit. The fluid sensor device 5000 includes a semiconductor substrate 5200 (e.g., silicon, gallium nitride) and a back end of line (BEOL) 5202 on the semiconductor substrate 5200. The fluid sensor device 5000 further includes a main reaction reservoir 5204 and an input funnel 5206 on BEOL 5202. Through input funnel 5206, biological samples (e.g., mucus, saliva, urine, blood) are provided to the main reaction reservoir 5204. The fluid sensor device 5000 includes a fluidic structure including multiple auxiliary reaction reservoirs, including auxiliary reaction reservoirs 5208 and 5210, on BEOL 5202. The fluidic structure including the multiple reservoirs can be an example of fluidic structure 404 shown in FIGS. 1-49E and can be made of a rigid silicon-based material, such as Silicon Oxide (SiO₂), Silicon Nitride (Si₂N₃), etc. In some examples, fluidic structure 404 can be made of or include other materials, such as polymers like SU-8 or Polyimide, Al₂O₃, etc. As to be described below, the reservoirs can also include metal or dielectric walls covered with inert metal. In some examples, auxiliary reaction reservoir 5208 can be a reference reservoir, as shown in FIG. 53, that may contain a buffer fluid to maintain a constant pH. In some examples, auxiliary reaction reservoir 5208 can also be a detection reservoir containing a second reagent to replicate the nucleic strands of a first detection target (e.g., a first microbe/pathogen). Also, auxiliary reaction reservoir 5210 can be another detection reservoir containing a third reagent to replicate the nucleic strands of a second detection target (e.g., a second microbe/pathogen). The main reaction reservoir 5204 may have a size of approximately 10 microliters (uL) to 100 uL, and the detection reservoir(s) 5210 may have a size of 1 nanoliter (nL) to 1 uL. In some examples, the reference reservoir 5208 can be several orders of magnitude smaller that main reaction reservoir 5204. For example, the reference reservoir 5208 can include one or more dead end microchannels in the BEOL 5202 and can have a volume of around 1 picoliter (pL), which can be the volume of a microchannel. Accordingly, the volume of the reference reservoir 5208 can have a range between, for example, 1 pL and 1 uL.

The BEOL 5202 includes example microfluidic channels 5212, 5214, 5216, 5218. Flow control devices 5219, 5221, 5223, and 5225 (which are examples of the flow control devices 5004 of FIG. 50 including co-located pumps and valves) are configured to control the flow of a fluid through the microfluidic channels 5216, 5218, 5212, and 5214, respectively. For example 5219 and 5223 can be pumps (e.g., electro osmotic pumps), and 5221 and 5225 can be valves. The BEOL 5202 may also include dead end microfluidic channels configured as the reference reservoir 5208. A controller, such as the controller 5002 of FIG. 50, is configured to dynamically control the flow control devices 5219, 5221, 5223, and 5225. The main reaction reservoir 5204 includes a reagent 5220, the reference reservoir 5208 includes a reagent 5222, and the detection reservoir 5210 includes a reagent 5224. The reagent 5220 includes the reagents of some or all of the multiple detection reservoirs 5210. Optionally, in a case where auxiliary reaction reservoir 5208 is a reference reservoir, the reagent 5222 is or includes a buffering agent that is configured to maintain the pH of the contents of the reference reservoir 5208 at a relatively constant level (e.g., at a pH of 8). The reagent 5224 of each of the multiple detection reservoirs 5210 is configured to replicate a specific target nucleic strand, if that target nucleic strand is present in that detection reservoir 5210, and different detection reservoirs 5210 store different reagents 5224 to replicate different target nucleic strands. For example, given first and second detection reservoirs 5210, the reagent 5224 in the first detection reservoir 5210 is configured to replicate only nucleic strands of a first detection target (e.g., a first microbe, such as an influenza virus), while the reagent 5224 in the second detection reservoir 5210 is configured to replicate only nucleic strands of a second detection target (e.g., a second microbe, such as a coronavirus and not of any other pathogen. In examples, the reagents 5220, 5222, and 5224 are in a freeze-dried state in the reservoirs prior to the reservoirs being wetted with the solution containing the biological samples, and the reagents can dissolve in the fluid completely over a period of time after the fluid is introduced into the reservoirs in which the reagents are stored.

The fluid sensor device 5000 includes pH sensors 5226, 5228, and 5230 (e.g., ISFETs). In examples, other types of sensors may be used in lieu of pH sensors. The pH sensors 5226, 5228, and 5230 are representative of the pH sensors 5006 of FIG. 50. The pH sensors 5226, 5228, and 5230 are configured to sense the pH levels of the contents of the reservoirs 5204, 5208, and 5210, respectively. The controller of the fluid sensor device 5000 (e.g., controller 5002) is configured to receive signals from the pH sensors 5226, 5228, and 5230.

FIG. 53 is a top-down, conceptual illustration of an example fluid sensor device 5000 (e.g., the fluid sensor device 5000 of FIG. 52). FIG. 53 depicts the BEOL 5202 including multiple microfluidic channels, such as microfluidic channels 5212 and 5216. Each of the multiple microfluidic channels 5216 is coupled to a different detection reservoir 5210, as shown. In examples, one or more of the microfluidic channels 5212, 5216 may be of a sufficient length that valves are unnecessary, or at least such that the need of valves may be reduced, to restrict the flow of reagents between the reservoirs. Such arrangements can reduce contamination of reagents between the different reservoirs which would otherwise lead to undesired replication of non-target nucleic strands and false detection. For example, the one or more microfluidic channels 5212, 5216 may be of a sufficient length such that nucleic strand replication and testing occurs before dissolved reagents in one reservoir can flow through the length of the microfluidic channel 5212, 5216 and reach a different reservoir. For example, the reagent in a detection reservoir for coronavirus should replicate only the nucleic strands of coronavirus and not the nucleic strand of other microbes/pathogens. On the other hand, the reagent(s) in the main reaction reservoir can replicate the nucleic strands of various types of microbes, including detection target and non-detection targets, and the microfluid channels (with or without valves) can restrict the flow of reagents from the main reaction reservoir to the detection reservoir which would otherwise contaminate the reagent in that detection reservoir. FIG. 53 shows the inclusion of eight different detection reservoirs 5210, but any number of detection reservoirs 5210 may be included. The microfluidic channel 5212 is coupled to the reference reservoir 5208. The various microfluidic channels 5212 and 5216 are coupled to the centrally-located main reaction reservoir 5204.

FIG. 54 is another example illustration of the fluid sensor device 5000. The fluid sensor device 5000 of FIG. 54 is the same as that of FIG. 53, except that a biological sample 5234 (e.g., blood, saliva, urine, mucus) has been introduced to the main reaction reservoir 5204. The biological sample 5234 includes nucleic strands 5232 (e.g., deoxyribonucleic acid, ribonucleic acid).

The method 5100A comprises allowing (e.g., by opening the valves of the flow control devices) the fluid including the biological samples to flow from the main reaction reservoir to other reservoirs, such as the detection reservoirs, via the microfluid channels (5104). Accordingly, both the main reaction reservoir and the detection reservoirs are wetted by the fluid. Prior to the reagents dissolving and replicating the nucleic strands in the fluid in the reservoirs, the reservoirs can have the same pH. The fluid sensors (e.g., ISFET) in the main and the detection reservoirs can output a common signal indicating the same pH among the reservoirs.

FIG. 55 is another example illustration of the fluid sensor device 5000. The fluid sensor device 5000 of FIG. 55 is the same as that of FIG. 54, except that the biological sample 5234 has been provided from the main reaction reservoir 5204 to the auxiliary reaction reservoirs 5208 and 5210, which can be detection reservoirs in this example. The biological sample 5234 is not provided to a reference reservoir (not shown in FIG. 55). Fluid containing the biological sample 5234 flows from the main reaction reservoir 5204 to the auxiliary reaction reservoirs 5208 and 5210 by way of the microfluidic channels 5218 and 5214 when the valves 5221 and 5225 are open by the controller (e.g., controller 5002). The biological sample 5234 may also be provided to additional detection reservoirs, such as those shown in FIG. 53. As FIG. 55 shows, the biological sample 5234 begins to dissolve the reagents 5220, 5222, and 5224.

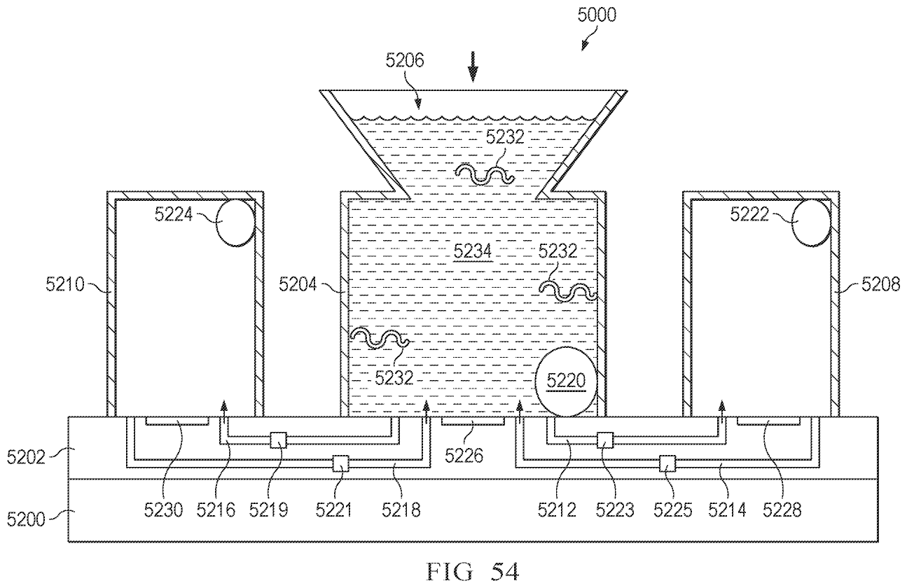

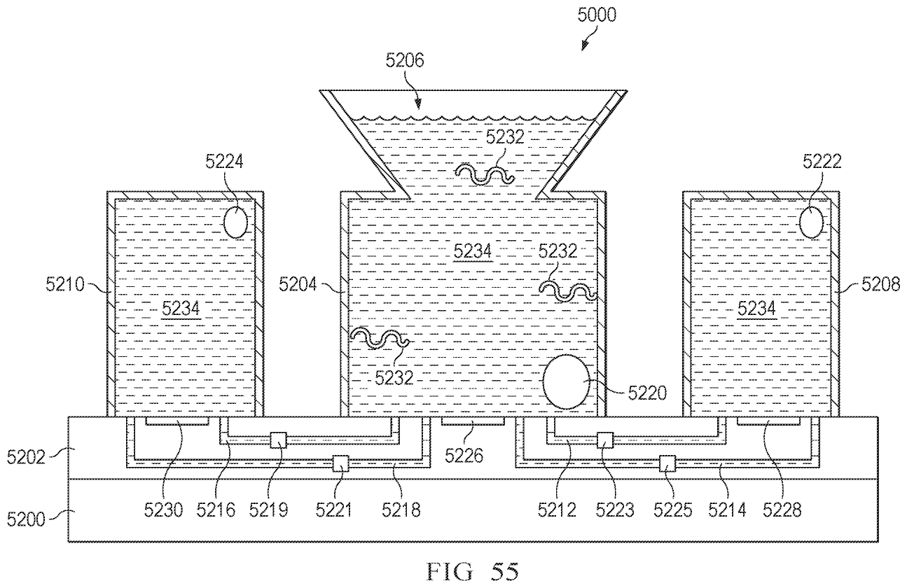

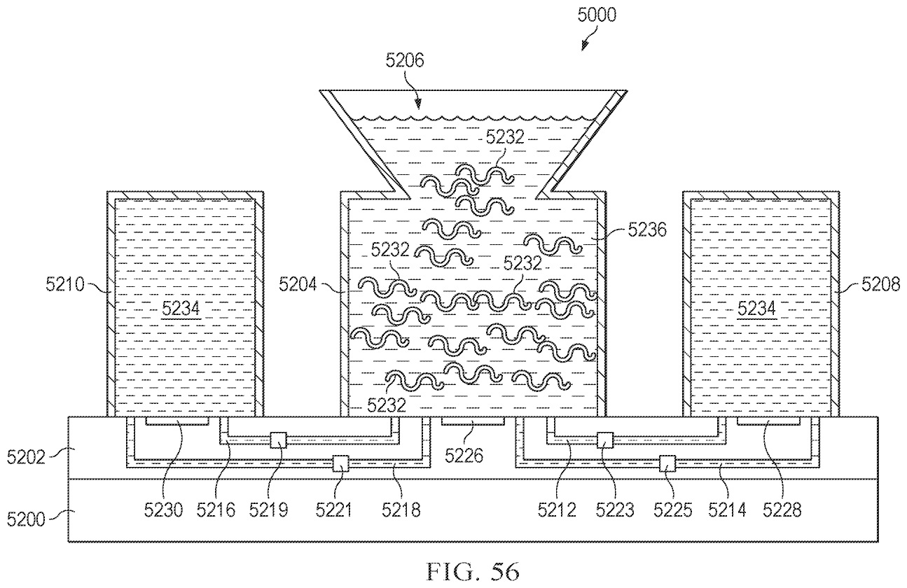

The method 5100A also comprises replicating the nucleic strands of the biological sample in the main reaction reservoir using the first reagent to produce multiple nucleic strands (5106), where The nucleic strands may or may not include the nucleic strands of the detection target(s). FIG. 56 is an example illustration of the fluid sensor device 5000. The fluid sensor device 5000 of FIG. 56 is the same as that of FIG. 55, except that the main reaction reservoir 5204 has begun to replicate the nucleic strands 5232. Replication may be achieved by the presence of a suitable reagent (e.g., reagent 5220 of FIG. 52), which dissolves in the fluid, in combination with controlling the temperature of the biological sample 5234 in a manner conducive to the replication of nucleic strands. Because the reagent 5220 has already dissolved in the main reaction reservoir 5204, the reagent is present. Furthermore, the fluid sensor device 5000 includes heating and/or cooling elements, described below, that precisely control the temperature of the biological sample 5234 in the main reaction reservoir 5204. This combination of reagent 5220 and temperature control causes the nucleic strands 5232 to replicate, as shown. Although the microbe whose nucleic strands 5232 are present in the main reaction reservoir 5204 is not yet known, the reagent 5220 includes some or all reagents present in the detection reservoirs 5210, so if the nucleic strands 5232 in the main reaction reservoir 5204 belong to a specific detection target of any of the detection reservoirs 5210, the reagent 5220 can replicate those nucleic strands 5232. Conversely, if the nucleic strands 5232 present in the main reaction reservoir 5204 do not belong to any of the detection targets of the detection reservoirs 5210 (or none of the detection target(s) is present in the main reaction reservoir 5204), then the nucleic strands 5232 in the main reaction reservoir 5204 will not replicate.

Continuing to refer to FIG. 56, the replication of the nucleic strands 5232 in the main reaction reservoir 5204 is associated with the production of the hydrogen ions (H⁺) in the biological sample stored in the main reaction reservoir 5204, which, in turn, changes (e.g., decreases) the pH level of the fluid containing the biological sample in the main reaction reservoir 5204, as numeral 5236 indicates.

The method 5100A includes providing a portion of the replicated nucleic strands to a detection reservoir, such as auxiliary reaction reservoirs 5208 and 5210 (5108). The portion of the replicated nucleic strands can be provided to the detection reservoir by, for example, a pump of a flow control device. In some examples, a first portion of the replicated nucleic strands can be provided to a first auxiliary reaction reservoir (e.g., 5208) via a first microfluidic channel (e.g., microfluidic channel 5212) by actuating a first pump (e.g., pump 5223), and a second portion of the replicated nucleic strands can be provided to a second detection reservoir (e.g., 5210) via a second microfluidic channel (e.g., microfluidic channel 5216) by actuating a first pump (e.g., pump 5219), where the first and second detection reservoirs contain different reagents for replication of different nucleic strands (of different detection targets).

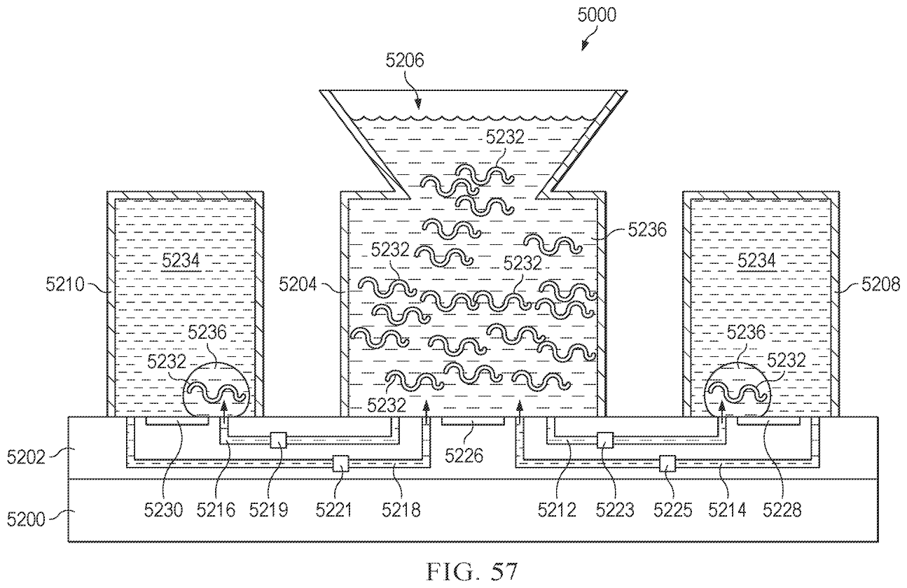

FIG. 57 is an example illustration of the fluid sensor device 5000. The fluid sensor device 5000 as depicted in FIG. 57 is the same as shown in FIG. 56, except that the pumps 5219, 5223 have been actuated to provide portions of the replicated nucleic strands 5232 from the main reaction reservoir 5204 to the auxiliary reservoirs 5208 and 5210. In examples, the controller (e.g., controller 5002 of FIG. 50) is configured to actuate pumps 5219 and 5223 after a reaction time has elapsed, for example, after sufficient time has passed for the replication of the nucleic strands 5232 to occur in the main reaction reservoir 5204. If the fluid sensor device 5000 includes multiple detection reservoirs, the main reaction reservoir may provide nucleic strands 5232 to each such detection reservoir, or to only a subset of the detection reservoirs 5210. Because the detection reservoirs contain different reagents for replicating nucleic strands of different detection targets, the different portions of replicated nucleic strands from the main reaction reservoir may fail to replicate in some of the detection reservoirs, or may replicate by different degrees, as numeral 5236 shows in FIGS. 57 and 58. Also, no portion of the replicated nucleic strands 5232 is provided to the reference reservoir.

The method 5100A comprises replicating the first portion of the multiple nucleic strands in the first detection reservoir using the second reagent (5110), not replicating the second portion of the multiple nucleic strands in the second detection reservoir using the third reagent (5112). Still referring to FIG. 57, introduction of the nucleic strands 5232 to the detection reservoir 5210 may result in replication of the nucleic strands 5232, if the nucleic strands 5232 are of the detection target to be detected in the detection reservoir 5210. If the detection reservoir 5210 depicted in FIG. 57, or any other detection reservoir 5210 in the fluid sensor device 5000 (e.g., the detection reservoirs 5210 shown in FIG. 53), stores a biological sample that has dissolved therein a reagent that is configured to replicate the nucleic strands 5232, then the introduction of those nucleic strands 5232 into such detection reservoirs 5210 will result in the rapid replication of the nucleic strands 5232. For example, as shown in FIG. 57, a nucleic strand 5232 is provided from the main reaction reservoir 5204 to the detection reservoir 5210. Because the reagent 5224 (FIG. 52) dissolved in the biological sample stored in the detection reservoir 5210 is configured to replicate the nucleic strands of a specific detection target to be detected in the detection reservoir 5210 (e.g., influenza virus), and because the nucleic strand 5232 introduced into the detection reservoir 5210 belongs to that same detection target, and further because the temperature within the detection reservoir 5210 is precisely controlled (e.g., to a constant temperature, or to varying temperatures) by heating elements as described below, the number of nucleic strands 5232 in the detection reservoir 5210 increases rapidly (e.g., exponentially with time), as FIG. 58 shows. Further, the significant replication of nucleic strands 5232 in the detection reservoir 5210 causes the pH level within the detection reservoir 5210 to change (e.g., drop), as numeral 5236 indicates. Other detection reservoirs 5210 contain other reagents and thus may not experience replication of the nucleic strands 5232 therein.

The method 5100A further comprises comparing pH levels of the first and second detection reservoirs to a pH level of the reference reservoir (5114). The method 5100 also includes, based on the comparisons, determining whether the biological sample provided to the main reaction reservoir contains one or more detection targets, such as a first detection target (e.g., coronavirus) to be detected in the first detection reservoir and a second detection target (e.g., an influenza virus) to be detected in the second detection reservoir (5116). For example, the controller 5002 (FIG. 50) may be configured to use the signals provided by the pH sensors 5228 and 5230 (FIG. 58) to compare the PH levels of the biological samples in the reservoirs 5208 and 5210. For instance, the controller 5002 may compare the pH levels within auxiliary reservoirs 5208 and 5210 and may determine that the difference in pH levels is above a threshold, causing the controller 5002 to determine that the biological sample provided to the fluid sensor device 5000 contains a detection target (e.g., a pathogen) to which the reagent 5224 (FIG. 52) corresponds. Alternatively, the difference in pH levels may be below the threshold, in which case the controller 5002 determines that the biological sample does not contain the detection target to which the reagent 5224 (FIG. 52) corresponds. The PH levels of various other detection reservoirs 5210 also may be compared to the pH level of the reference reservoir 5208, and the differences in pH levels may be compared to the threshold to determine whether the biological sample contains pathogens corresponding to the reagents stored in those detection reservoirs 5210. In some cases, a biological sample may contain multiple detection targets that can be identified by the fluid sensor device 5000 in this manner. The controller 5002 may indicate the testing results to a user by providing a signal to a display, to another device, etc. Further, the time resolved change of pH level in the reservoirs is a direct indication of the originally present quantity (concentration) of target nucleic acid in the biological sample, hence this test can also constitute a quantitative nucleic acid test.

FIG. 51B illustrates another example method 5100B. The method 5100A comprises providing a fluid including a biological sample to a main reaction reservoir, where the biological sample includes nucleic strands that may or may not be of the detection target(s), and the main reaction reservoir includes a first reagent (5122), which is identical to operation 5102 of FIG. 51A.

The method 5100B also comprises allowing the fluid to flow from the main reaction reservoir to the reference reservoir (e.g., reference reservoir 5208 of FIG. 53) by opening valve 5225 (5124), so that both the main reaction reservoir and the reference reservoir are wetted by the fluid. The reference reservoir may contain a buffer solution to maintain the pH in the reference reservoir, and when the fluid enters the reference reservoir and come into contact with the buffer solution, the pH in the reference reservoir can remain unchanged. Also, the fluid is not allowed to flow to the detection reservoir (e.g., detection reservoir 5210) by, for example, closing valve 5221.

The method 5100B also comprises replicating the nucleic strands in the biological sample in the main reaction reservoir using the first reagent (5126), which is the same as operation 5106.

The method 5100B also comprises determining a pH change in the main reaction reservoir and, responsive to a pH change in the main reaction reservoir exceeding a threshold, providing a first portion of the replicated nucleic strands to a first detection reservoir and a second portion of the replicated nucleic strands to a second detection reservoir by opening valves, such as valves 5221 and 5225. The method 5100B further comprises replicating the first portion of the replicated nucleic strands in the first detection reservoir using the second reagent (5130), not replicating the first portion of the replicated nucleic strands in the second detection reservoir using the third reagent (5132), comparing pH levels of the first and second detection reservoirs to a pH level of the reference reservoir (5134), and determining whether the biological sample contains one or more detection targets (5136), which are identical to, respectively, operations 5110, 5112, 5114, and 5116 of method 5100A.

As described above, in operation 5124, valves are opened to provide the fluid including the replicated nucleic strands to the detection reservoirs. During operation 5124, some of the replicated nucleic strands may be provided to the reference reservoir. However, because the reference reservoir does not include a reagent to further replicate the nucleic strands, the nucleic strands are not replicated in the reference reservoir. There is also no substantial impact on the pH level in the reference reservoir due to the presence of the buffer solution, which can maintain the pH level in the reference reservoir.

As described above, the controller 5002 compares pH levels of the contents of the reference reservoir 5208 to the pH levels of the contents of one or more detection reservoirs 5210. However, in some examples, the controller 5002 may be configured to compare the pH level of the contents of the reference reservoir 5208 to the pH level of the contents of the main reaction reservoir 5204 after the nucleic strands 5232 in the main reaction reservoir 5204 are replicated, but before the nucleic strands 5232 are provided to reservoirs other than the main reaction reservoir 5204. Because the reagent 5220 stored in the main reaction reservoir 5204 contains the reagents stored in the various detection reservoirs 5210, a positive test result in any of the detection reservoirs 5210 means that a positive result would also have been present in the main reaction reservoir 5204. Thus, by comparing the pH levels of the contents of the main reaction reservoir 5204 and the reference reservoir 5208, the controller 5002 can determine whether a positive test result (e.g., detection of a particular microbe or a class of microbes) may result by using the fluid sensor device 5000, or whether analysis of the PH levels of the detection reservoirs 5210 is not going to provide a positive test result (e.g., absence of the particular microbe or any identifiable microbe). If the pH levels of the contents of the main reaction reservoir 5204 and reference reservoir 5208 do not differ beyond a threshold, the controller 5002 may issue a signal (e.g., to a display or to another device) indicating that the biological sample provided does not contain a pathogen that the fluid sensor device 5000 is capable of identifying. However, if the pH levels of the contents of the main reaction reservoir 5204 and reference reservoir 5208 differ beyond a threshold, the controller 5002 may issue a signal (e.g., to a display or to another device) indicating that the biological sample provided does contain a pathogen that the fluid sensor device 5000 is capable of identifying, and further, the controller 5002 may cause the nucleic strands 5232 to be distributed from the main reaction reservoir 5204 to the detection reservoir(s) 5210 (and, optionally, to the reference reservoir 5208, as described above). After the nucleic strands 5232 are distributed to the detection reservoir(s) 5210, the testing process may continue as described above with reference to the method 5100 (FIG. 51).

The example fluid sensor 5000 of FIG. 50 and FIGS. 52-58, and the example methods of 5100A and 5100B of FIGS. 51A and 51B, can provide various advantages. Specifically, multiplexing (e.g., testing/detection of different target microbes) can be performed simultaneously in different detection reservoirs, which can substantially reduce the test time, especially if each test includes a sequence of repeated heating and cooling, as to be described below. Also fluid sensor 5000 be built on a semiconductor substrate and can be a packaged integrated circuit sensor. The pH sensors 5226, 5228, and 5230 can be ISFETs, and the microbe detection can be based differential ion sensing as described in FIGS. 1-49E and do not require external reference electrode, which makes fluid sensor 5000 compact and portable. Further, the reservoirs, being built as part of the BEOL of a semiconductor die, can be very small (e.g., having volumes in the order of uL), which can reduce the volume of patient sample needed for the test. The microfluidic channels, valves, and the restriction structure enclosing the reservoirs can also prevent contamination between the reservoirs, which can improve the accuracy of the testing.

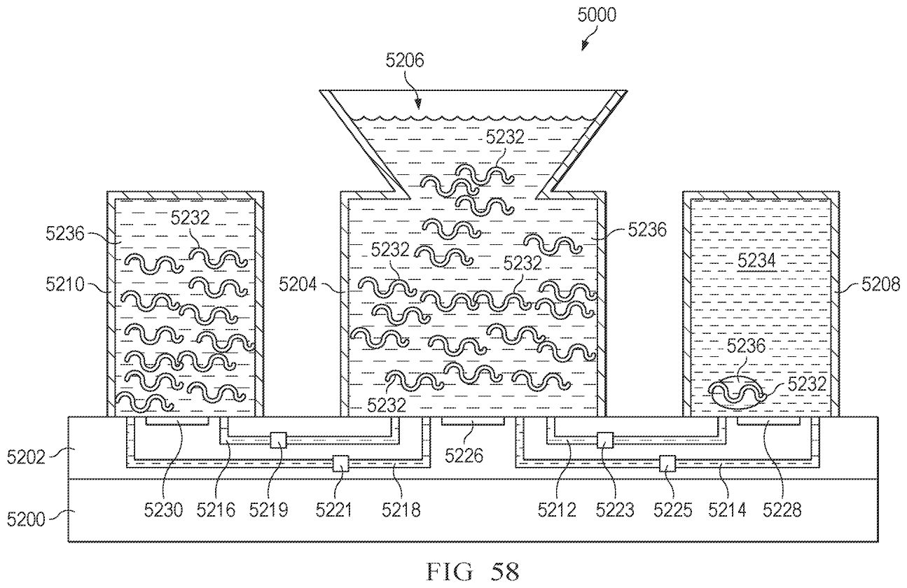

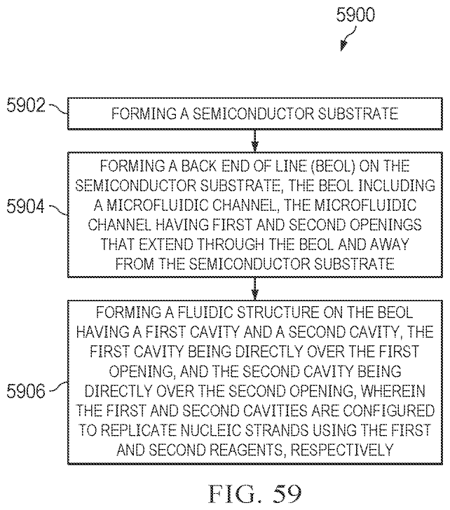

FIG. 59 is a flow diagram illustrating an example method 5900 for manufacturing a fluid sensor device, such as the fluid sensor device 5000. FIGS. 60, 61, 62, 63, 64, and 65 are process flow diagrams depicting an example fluid sensor device manufacturing process. Accordingly, FIGS. 59-65 are now described in parallel.

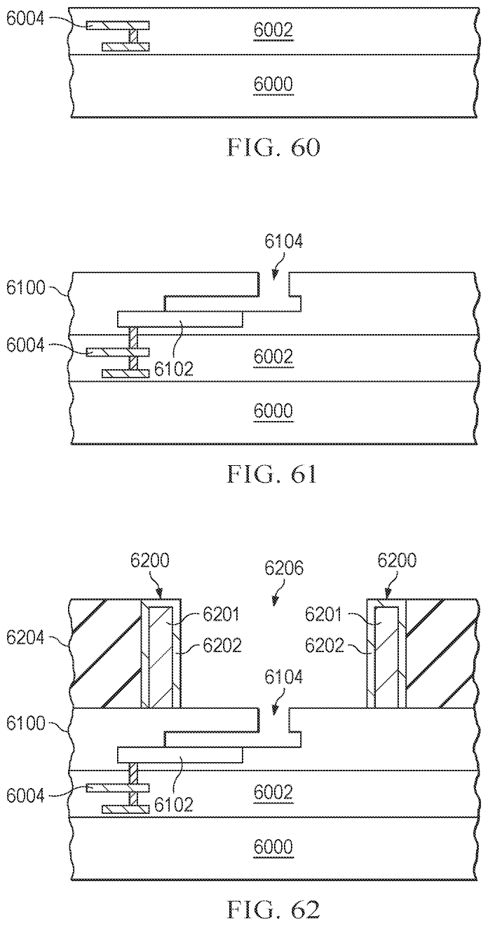

The method 5900 begins with forming a semiconductor substrate (5902) and forming a BEOL on the semiconductor substrate, where the BEOL includes a microfluidic channel (5904) having first and second openings that extend through the BEOL and away from the semiconductor substrate. FIG. 60 shows a semiconductor substrate 6000 (e.g., silicon, gallium nitride) and a BEOL 6002 on the semiconductor substrate 6000. The BEOL 6002 includes metallization 6004 that is configured to provide one or more electrical pathways between the semiconductor substrate 6000 and other components in the fluid sensor device, such as pH sensors, electrodes, valves, etc. FIG. 61 shows the formation of a BEOL 6100 on the BEOL 6002. Like the BEOL 6002, the BEOL 6100 includes metallization and sensors (e.g., sensor 6102, such as a pH sensor), and the BEOL 6100 also includes microfluidic channels 6104. In some examples, the BEOLs 6002 and 6100 may be considered to be the same BEOL. Microfluidic channels such as the microfluidic channels 6104 may be formed by any suitable process, such as bonding of multiple wafers with pre-formed cavities, release of a patterned sacrificial material underneath a passivation layer, multiple patterning and lamination steps with dry film.

The method 5900 includes forming a fluidic structure on the BEOL having a first cavity and a second cavity, the first cavity being directly over the first opening, and the second cavity being directly over the second opening, wherein the first and second cavities are configured to replicate nucleic strands using the first and second reagents (5906).

In some examples, as part of operation 5906, forming the first and second cavities may include forming first and second walls on the BEOL, the first and second walls defining the first and second cavities, respectively, and positioning an insulative material on the BEOL and contacting the first and second walls. The first and second metal walls define first and second cavities, respectively, which are fluidically coupled by the microfluidic channel. The first and second cavities can represent, for example, main reaction reservoir 5204 and an auxiliary reaction reservoir (e.g., 5208, 5210), and are configured to store first and second reagents, respectively (5906). The method 5900 comprises positioning an insulative material on the BEOL and contacting the first and second metal walls (5908). FIG. 62 shows the structure of FIG. 61, except with the addition of a metal or dielectric wall 6200 (e.g., a copper wall 6201 plated with an inert metal 6202, such as electroless plated nickel palladium immersion gold (ENEPIG)) and an insulative material 6204 (e.g., an epoxy) abutting an outer surface of the metal wall 6200. The metal or dielectric wall 6200 defines a cavity 6206, as shown. An open cavity on the semiconductor die may also be formed by injection molding with a stamp on the such to be defined cavities, and other open cavity packaging techniques may be used.

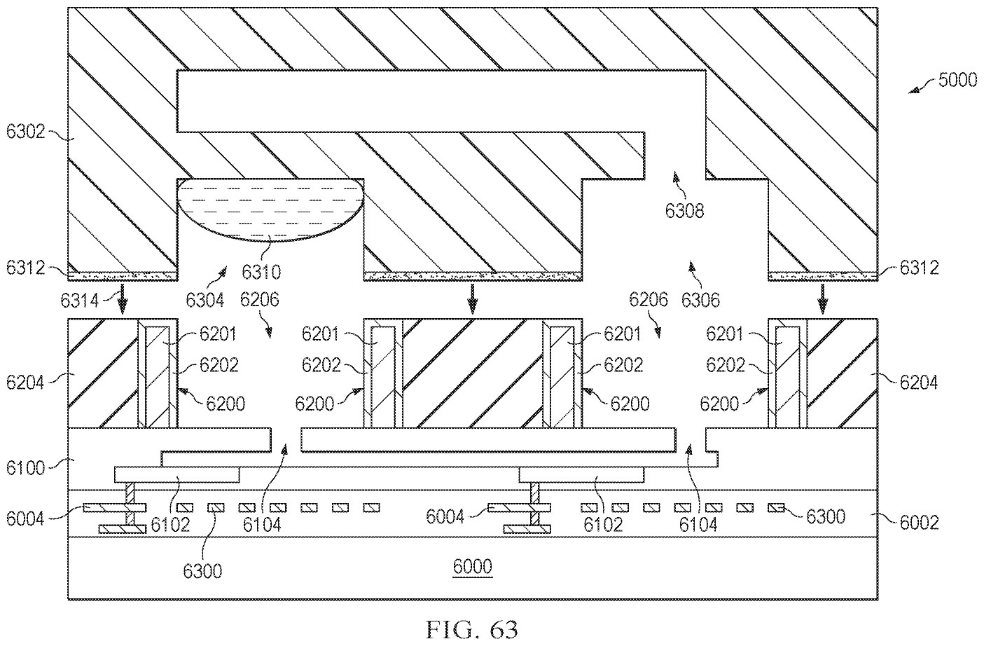

The method 5900 steps 5902, 5904, and 5906 may be repeated and/or expanded to produce multiple metallizations, sensors, microfluidic channels, metal walls, and cavities, for example as shown in FIG. 63. FIG. 63 depicts the semiconductor substrate 6000 and the BEOLs 6002 and 6100 containing metallization 6004 and sensor 6102, as described above, as well as a heating element 6300 in the BEOL 6002. The structure of FIG. 63 also includes multiple cavities 6206 defined by multiple metal walls 6200, as shown. Heating element 6300 can include examples of heater circuits described in FIGS. 1-49E.

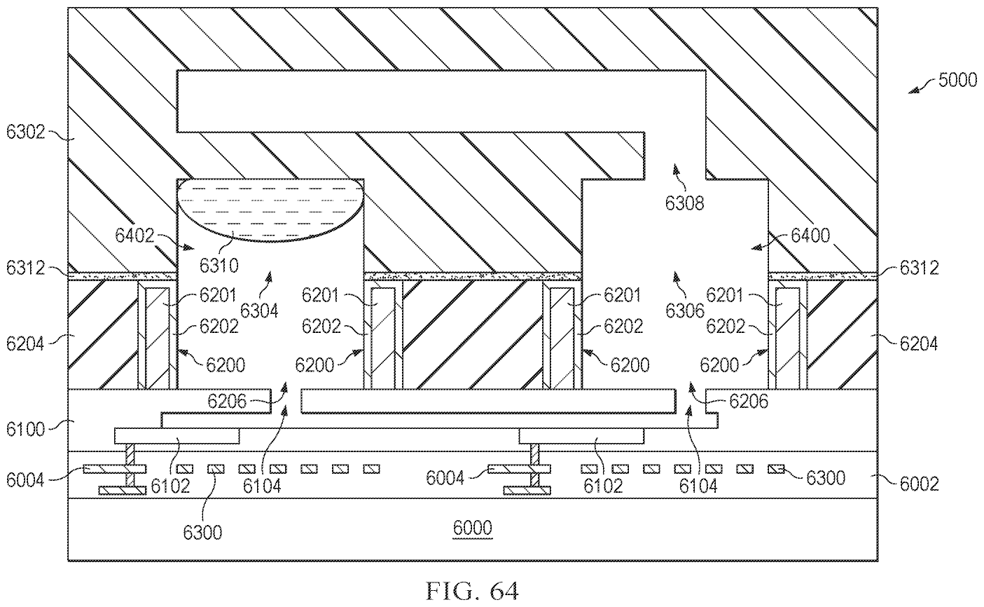

The method 5900 may also include coupling a cartridge to the first and second metal walls and the insulative material. The cartridge includes a third cavity in vertical alignment with the first cavity and a fourth cavity in vertical alignment with the second cavity. The cartridge further includes a channel in fluidic communication with the fourth cavity. The first and second cavities are configured to replicate nucleic strands using the first and second reagents, respectively. FIG. 63 illustrates a cartridge 6302 including cavities 6304, 6306 that are positioned in vertical alignment with the cavities 6206, as shown. In some examples, cartridge 5302 and cavity 6306 can combine as a main reaction reservoir having an enlarged volume (e.g., 100 uL or above), which may be difficult to implement solely in the BEOL of a semiconductor substrate. The cartridge 6302 also includes a channel 6308 in fluidic communication with the cavity 6306. The cartridge 6302 may include a reagent 6310 in solid form that is coupled to the cartridge 6302 within the cavity 6304. In examples, a reagent may be placed inside either the cavity 6306 or the cavity 6206 in vertical alignment with the cavity 6306 instead of being attached to any specific structure. An adhesive 6312 may be useful to couple the cartridge 6302 to the insulative material 6204 and the metal walls 6200, as the arrows 6314 indicate. FIG. 64 shows the same structure as that of FIG. 63, except that the cartridge 6302 is coupled to the insulative material 6204 and the metal walls 6200. The vertically aligned cavities 6206 and 6306 define a main reaction reservoir 6400, and the vertically aligned cavities 6206 and 6304 define a detection reservoir 6402.

In some examples, as part of operation 5906, cartridge 6302 can be coupled to the BEOL 6100 via adhesive 6312, and the cavities 6400 and 6402 of cartridge 6302 are directly over openings of the microfluidic channel 6104.

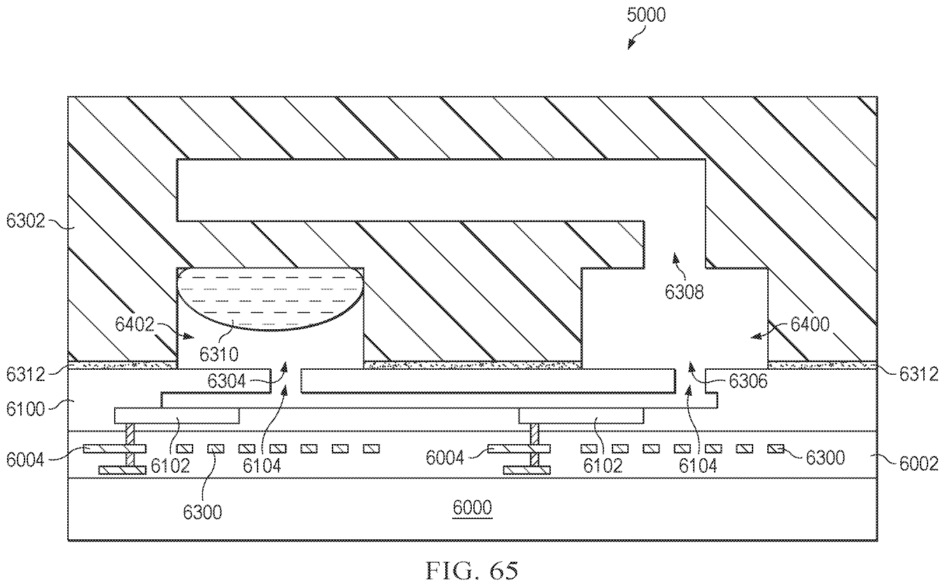

Referring to FIGS. 64 and 65, in operation, a biological sample to be tested is provided to the cartridge 6302 through an inlet (not expressly shown), which is in fluid communication with the channel 6308. The channel 6308 provides the biological sample to the main reaction reservoir 6400. The microfluidic channel 6104 have openings that extend through BEOL 6100 away from the semiconductor substrate 6000 and fluidically couple to the main reaction reservoir 6400 to the detection reservoir 6402. The microfluidic channel 6104 can also provide a portion of the biological sample from the main reaction reservoir 6400 to the detection reservoir 6402. Other microfluidic channels may provide additional portions of the biological sample from the main reaction reservoir 6400 to other detection reservoirs and/or to a reference reservoir, as described above. The reagent 6310 then begins to dissolve in the detection reservoir 6402, and any reagents in the main reaction reservoir 6400 and any other reservoirs also begin to dissolve. A heating and/or cooling element, such as the heating element 6300, controls the temperatures of the contents of the reservoirs and, along with the dissolved reagents, may cause the replication of nucleic strands in the main reaction reservoir 6400. After such replication, the pH level of the contents of the main reaction reservoir 6400 may optionally be compared to the pH level of the contents of a reference reservoir. If the pH level difference exceeds a threshold, the main reaction reservoir 6400 is determined to contain the nucleic strands of a microbe (e.g., a pathogen) whose presence the fluid sensor device 5000 is configured to detect. A positive test result may be provided to a user (e.g., by way of a display), followed by more specific testing in the individual detection reservoirs to identify the specific pathogen(s) present in the biological sample. If the pH level does not exceed the threshold, a negative test result is provided to an end user (e.g., by way of a display).

A nucleic strand from the main reaction reservoir 6400 may be provided to the detection reservoir 6402, and the heating element 6300, in combination with the dissolved reagent 6310, may cause replication of the nucleic strand in the detection reservoir 6402. The pH level of the contents of the detection reservoir 6402 may be compared to the pH level of the contents of a reference reservoir (e.g., by controller 5002). If the pH level difference exceeds a threshold, the detection reservoir 6402 is determined (e.g., by controller 5002) to contain the nucleic strands of a pathogen whose presence the fluid sensor device 5000 is configured to detect. A positive test result may be provided (e.g., by controller 5002) to a user (e.g., by way of a display), including an identification of the specific pathogen(s) present in the biological sample (e.g., based on the type of reagent 6310 that was present in the detection reservoir 6402). If the pH level does not exceed the threshold, a negative test result is provided (e.g., by controller 5002) to an end user (e.g., by way of a display).

The heating element 6300 controls the temperature of the contents of various reservoirs in the fluid sensor device 5000 through radiant heating. However, this disclosure includes other examples of heating and/or cooling elements that may be included in fluid sensor devices, for example as shown in FIGS. 66-73. FIG. 66 shows a top-down view of a portion of an example fluid sensor device 6600, which includes a main reaction reservoir 6601, multiple detection reservoirs 6604, and a reference reservoir 6608. The main reaction reservoir 6601 includes multiple thermally conductive members 6602 extending into the volume of the main reaction reservoir 6601. One or more of the detection reservoirs 6604 includes multiple thermally conductive members 6606 extending into the volume of the detection reservoirs 6604. The reference reservoir 6608 includes multiple thermally conductive members 6610 extending into the volume of the reference reservoir 6608. The thermally conductive members 6602, 6606, and 6610 may be dynamically controllable by a controller (e.g., the controller 5002 in FIG. 50) to emit heat. In some examples, the thermally conductive members 6602, 6606, and 6610 may be metal rods coated with inert metal. In examples, the thermally conductive members 6602 may be separate from each other, and in other examples, the thermally conductive members 6602 may be coupled to each other in a grid pattern. In examples, the thermally conductive members 6606 may be separate from each other, and in other examples, the thermally conductive members 6606 may be coupled to each other in a grid pattern. In examples, the thermally conductive members 6610 may be separate from each other, and in other examples, the thermally conductive members 6610 may be coupled to each other in a grid pattern.

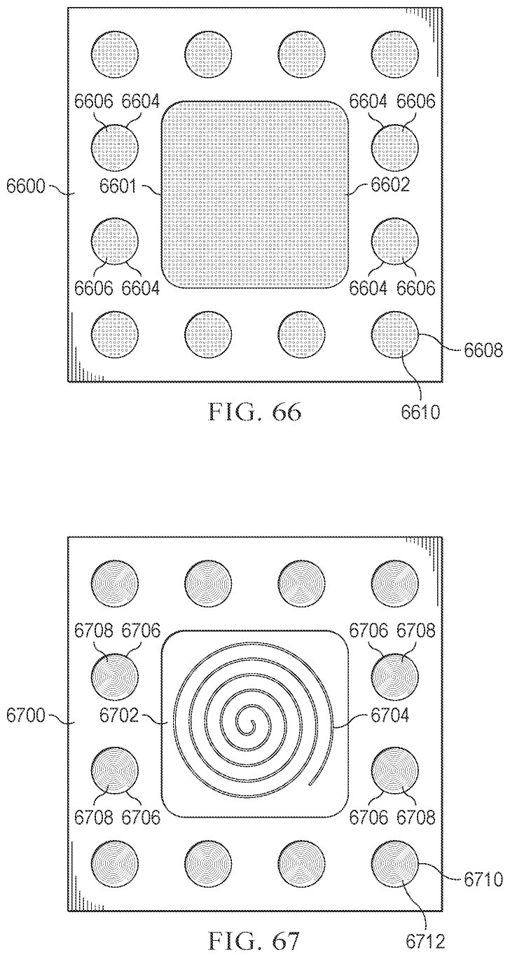

FIG. 67 shows a top-down view of a portion of an example fluid sensor device 6700, which includes a main reaction reservoir 6702, detection reservoirs 6706, and a reference reservoir 6710. The main reaction reservoir 6702 includes a thermally conductive member 6704, which may be a spiral shape, as shown. The detection reservoirs 6706 may include thermally conductive members 6708, each of which may be a spiral shape, as shown. The reference reservoir 6710 may include a thermally conductive member 6712, which may be a spiral shape, as shown. The thermally conductive members 6704, 6708, and 6712 may be dynamically controllable by a controller (e.g., the controller 5002 in FIG. 50) to emit heat. In some examples, the thermally conductive members 6704, 6708, and 6712 are metal members coated by an inert metal.

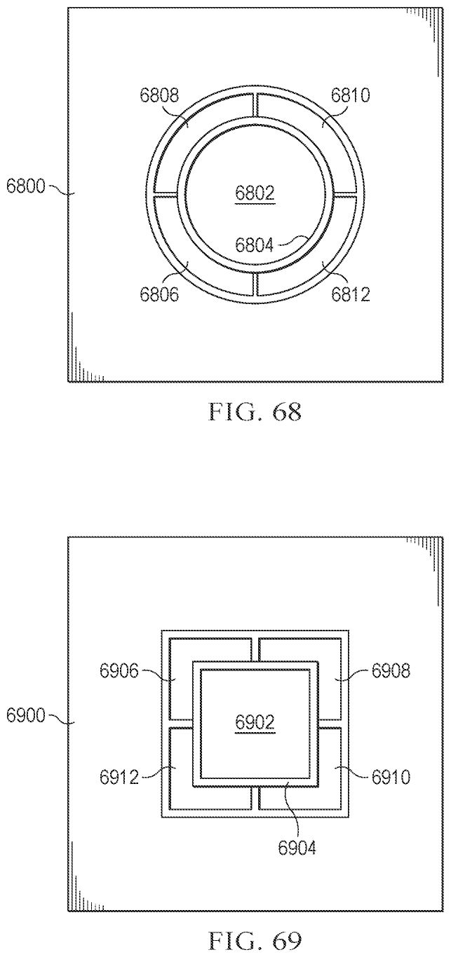

FIG. 68 is a top-down view of a portion of an example fluid sensor device 6800. The fluid sensor device 6800 includes a main reaction reservoir 6802, detection reservoirs 6806, 6808, and 6810, a reference reservoir 6812, and a channel 6804 circumscribing the main reaction reservoir 6802 and positioned in between the main reaction reservoir 6802 and the remaining reservoirs 6806, 6808, 6810, and 6812. The channel 6804 is configured to carry fluids of varying temperatures, including hot and cold fluids that can provide heat to adjacent reservoirs and remove heat from adjacent reservoirs. In examples, temperature-regulated fluids may be provided to and removed from the channel 6804 by way of cartridges, such as the example cartridge 6302 (FIG. 63), which could be configured with one or more channels to fluidically connect with the channel 6804.

FIG. 69 is a top-down view of a portion of an example fluid sensor device 6900. The fluid sensor device 6900 includes a main reaction reservoir 6902, detection reservoirs 6906, 6908, and 6912, a reference reservoir 6910, and a channel 6904 circumscribing the main reaction reservoir 6902 and positioned in between the main reaction reservoir 6902 and the remaining reservoirs 6906, 6908, 6910, and 6912. The channel 6904 is configured to carry fluids of varying temperatures, including hot and cold fluids that can provide heat to adjacent reservoirs and remove heat from adjacent reservoirs. In examples, temperature-regulated fluids may be provided to and removed from the channel 6904 by way of cartridges, such as the example cartridge 6302 (FIG. 63), which could be configured with one or more channels to fluidically connect with the channel 6904.

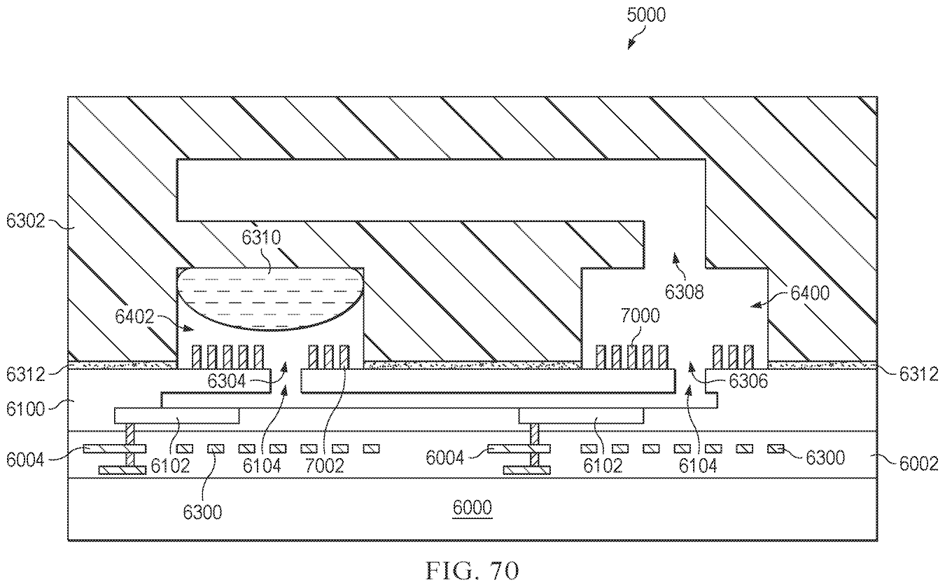

Other types of heating elements are contemplated and included in the scope of this disclosure. For example, FIG. 70 depicts an example fluid sensor device 5000 that is the same as that shown in FIG. 65, but with the addition of heating elements 7000 in the main reaction reservoir 6400 and heating elements 7002 in the detection reservoir 6402. The heating elements 7000, 7002 may be metal rods (e.g., heat exchangers) that are coated with an inert metal, for example. In some examples, the heating elements 7000, 7002 may be spiral shaped, as shown in FIG. 67. Other shapes and configurations of the heating elements 7000, 7002 are contemplated. The heating elements 7000, 7002 may receive heat provided by the radiant heating of the heating elements 6300. Heat emitted by the heating elements 6300 is provided toward the heating elements 7000, 7002, which, in turn, provide the heat into the reservoirs 6400, 6402 because the heating elements 7000, 7002 extend into the reservoirs 6400, 6402, respectively. The heating elements 7000, 7002 may extend to any desired depth in the reservoirs 6400, 6402.

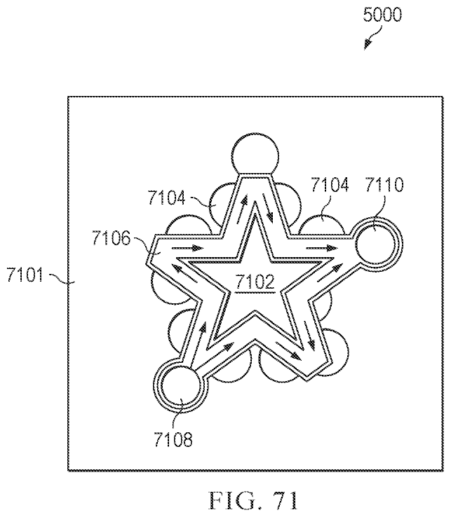

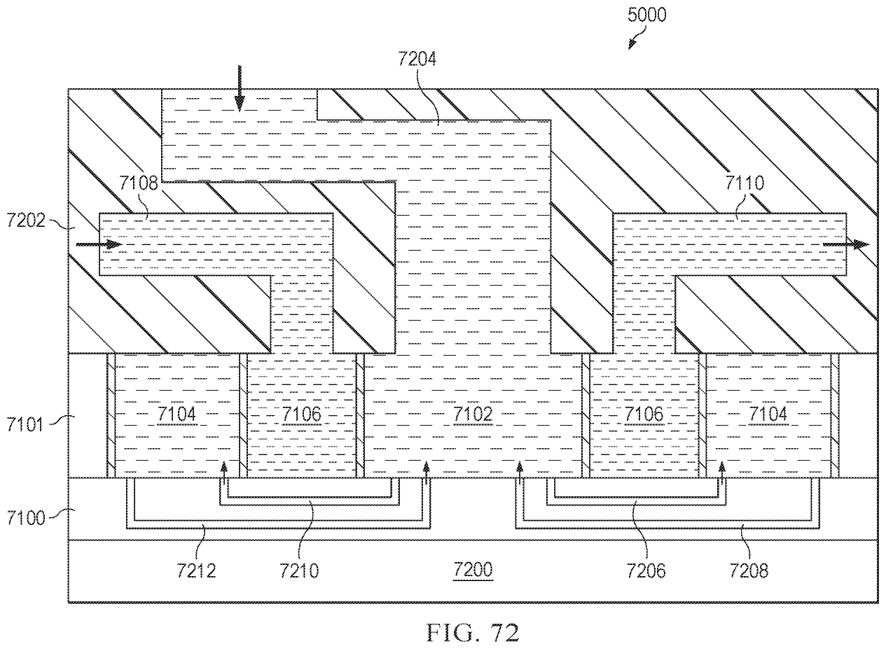

Still other types of heating elements are contemplated and included in the scope of this disclosure. FIG. 71 is a top-down view, and FIG. 72 is a cross-sectional view, of a portion of an example fluid sensor device 5000. The example fluid sensor device 5000 includes a BEOL 7101 that comprises a main reaction reservoir 7102 and multiple other reservoirs 7104 (e.g., detection reservoirs, reference reservoirs). BEOL 7101 also includes a channel 7106 with an inlet channel 7108 and an outlet channel 7110 circumscribes the main reaction reservoir 7102 and is positioned in between the main reaction reservoir 7102 and the other reservoirs 7104. In this example, the main reaction reservoir 7102 has a star shape, although any shape (e.g., a cloud shape) is included in the scope of this disclosure. Shapes for the main reaction reservoir 7102 that maximize surface area exposure to the channel 7106 (and, thus, result in more effective heating and cooling of the contents of the main reaction reservoir 7102) are desirable. Similarly, shapes for the other reservoirs 7104 that maximize surface area exposure to the channel 7106 (and, thus, result in more effective heating and cooling of the contents of the reservoirs 7104) are desirable. Fluid that is heated or cooled may be provided to the channel 7106 via the inlet channel 7108 and may be removed from the channel 7106 via the outlet channel 7110. The BEOL 7101 may be on a BEOL 7100 that includes microfluidic channels 7206, 7208, 7210, and 7212 (each of which may include a valve or other actuation mechanism that is controllable by a controller, such as the controller 5002 of FIG. 50). The BEOL 7101 may be on a semiconductor substrate 7200 (e.g., silicon, gallium nitride).

A cartridge 7202 may include the inlet channel 7108 and outlet channel 7110. The cartridge 7202 may also include a channel 7204. The inlet channel 7108 and outlet channel 7110 may be configured to vertically align with the channel 7106, and the channel 7204 may be configured to vertically align with the main reaction reservoir 7102. In this way, the cartridge 7202 provides heating and cooling fluid to and from the channel 7106, and the cartridge 7202 also provide biological samples to be tested into the main reaction reservoir 7102.

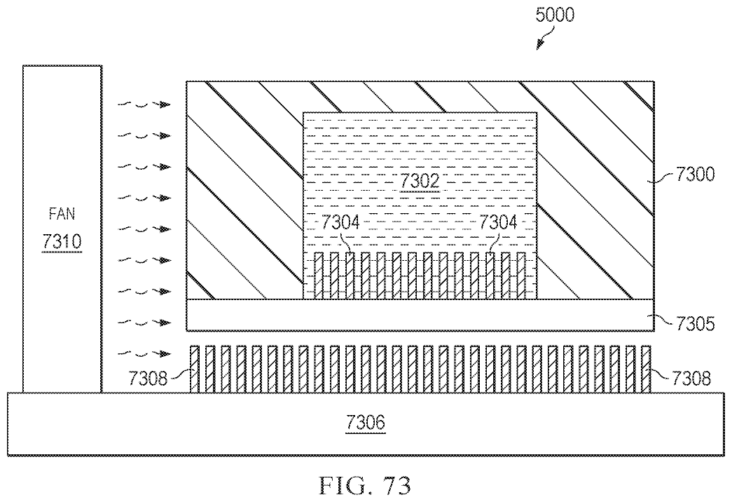

Still other types of heating elements are contemplated and included in the scope of this disclosure. FIG. 73 depicts an example testing instrument 7306 that includes a wireless heating element 7308, such as a metal coil, and a fan 7310. FIG. 73 also depicts a fluid sensor device 7300 that includes a reservoir 7302 comprising a wireless heating element 7304 on a semiconductor substrate 7305. The reservoir 7302 may be any type of reservoir described herein (e.g., a main reaction reservoir, a detection reservoir, a reference reservoir, etc.). The heating element 7304 may be any type of heating element described herein, such as a metal coil positioned inside the reservoir 7302. The instrument 7306 may be configured to provide a current through the heating element 7308 (e.g., metal coil), which forms an electromagnetic field that, in turn, induces a current in the heating element 7304. The current in the heating element 7304 warms the heating element 7304 and any biological samples in the reservoir 7302. In contrast, ceasing to provide a current into the heating element 7308 causes the biological samples in the reservoir 7302 to cool (e.g., by active cooling of fan 7310).

As described above, the rapid and large-scale replication of nucleic strands in the various reservoirs, with the exception of reference reservoirs, is desirable, so as to cause a significant difference in PH levels between the reservoir and the reference reservoir. A sufficiently large difference in pH levels indicates a positive test result. However, nucleic strand replication relies on the pH level of the biological sample in which the nucleic strand is found to be adequately high. If the pH level becomes too low, replication cannot continue. Thus, replication can hinder further replication. To prevent this phenomenon, fluid sensor devices described herein are configured to maintain the pH level at an adequately high level by providing electrical currents into the biological samples of the various reservoirs. The currents introduce OH-ions that counteract the protons that are introduced into the biological sample by nucleic strand replication and that are responsible for lowering pH levels. In this way, PH levels can be maintained at a desirable level (e.g., at a pH of 8), ideal for the desired nucleic acid amplification reaction.

When PH levels are controlled/maintained on purpose by applying currents as described herein, the resulting pH levels are no longer indicative of the presence of a particular detection target. Thus, the pH levels cannot be used to determine whether a particular pathogen is present in a particular reservoir. However, the amount of current supplied to a particular reservoir can be monitored and used as a proxy to determine the degree of change in PH levels of the contents of the reservoir. The amount of current supplied can be used to determine the pH level of the contents of a particular reservoir had current not been passed into the reservoir, and that pH level may be compared to the pH level of the reference reservoir (e.g., by controller 5002) to determine the presence of a particular detection target.

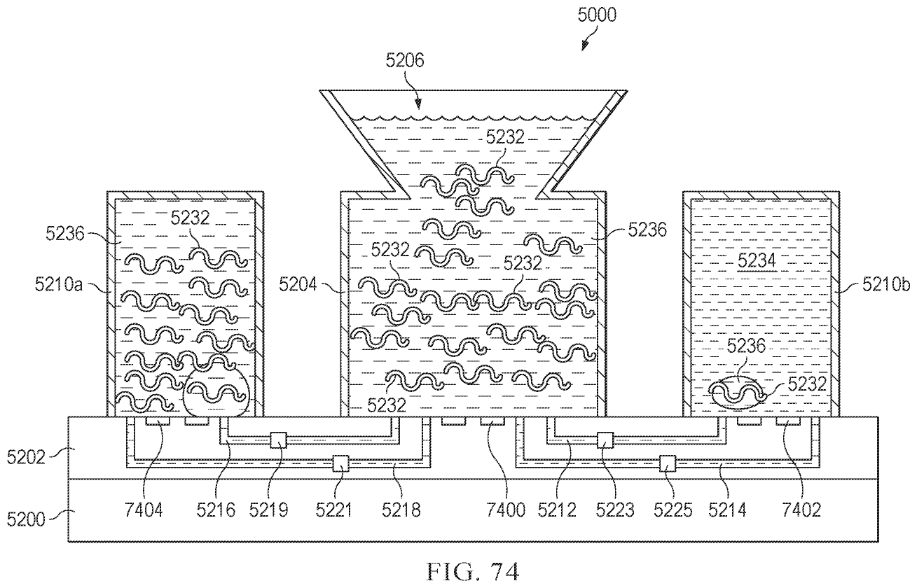

In examples, each reservoir that is to be pH-controlled in this manner may include a pH sensor and an electrode, with the controller (e.g., controller 5002 in FIG. 50) determining the pH level of the contents of the reservoir using the pH sensor and adjusting the pH level by controlling the electrode in the reservoir. FIG. 74 depicts an example fluid sensor device 5000 that includes an electrode 7400 exposed to an interior of the main reaction reservoir 5204, an electrode 7402 exposed to an interior of a first detection reservoir 5210a, and an electrode 7404 exposed to an interior of a second detection reservoir 5210b. The electrodes 7400, 7402, and 7404 may be anodes or cathodes, with their counterpart cathodes or anodes positioned an appropriate distance away from the electrodes 7400, 7402, and 7404. The electrodes 7400, 7402, and 7404 may be coupled to the controller (e.g., controller 5002 in FIG. 50) by metallization in the BEOL 5202. As the nucleic strands 5232 in the detection reservoir 5210 replicate, the controller uses the pH sensor 5230 to monitor the pH level of the contents of the detection reservoirs 5210a and 5210b, and when the pH level drops below a threshold, the controller uses the electrode 7404 to raise the pH level again, thereby creating a feedback loop. The controller can also measure the amount of current provided to the electrodes to maintain the pH level and use the measurement to determine whether a detection target is present in the detection reservoirs.

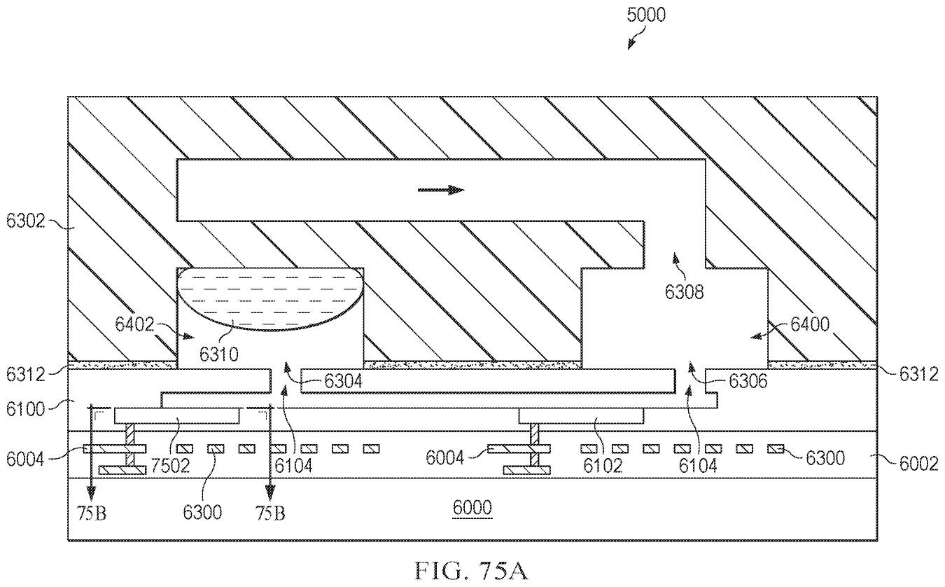

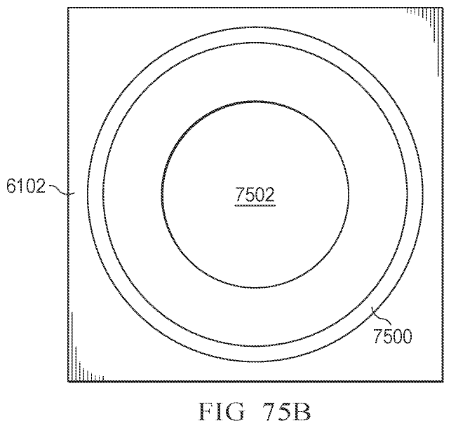

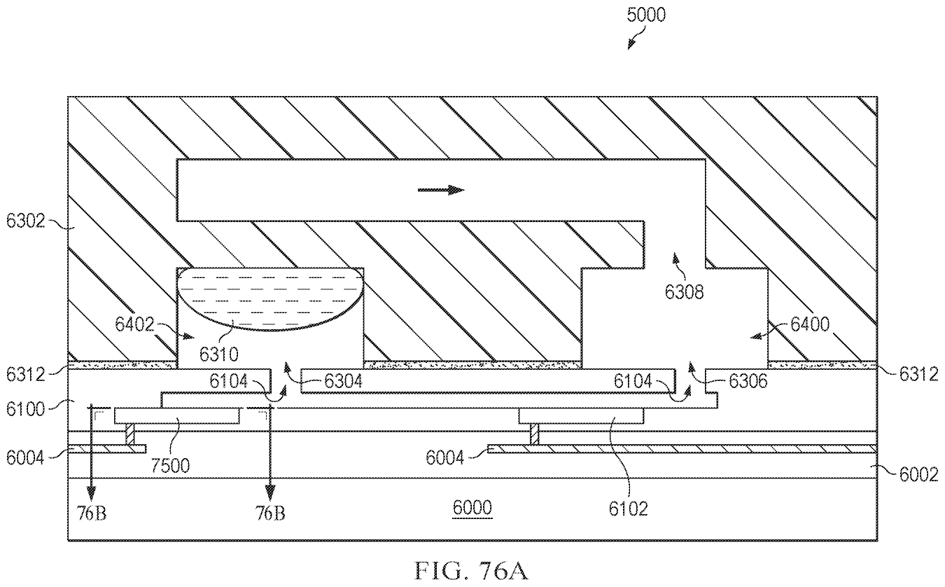

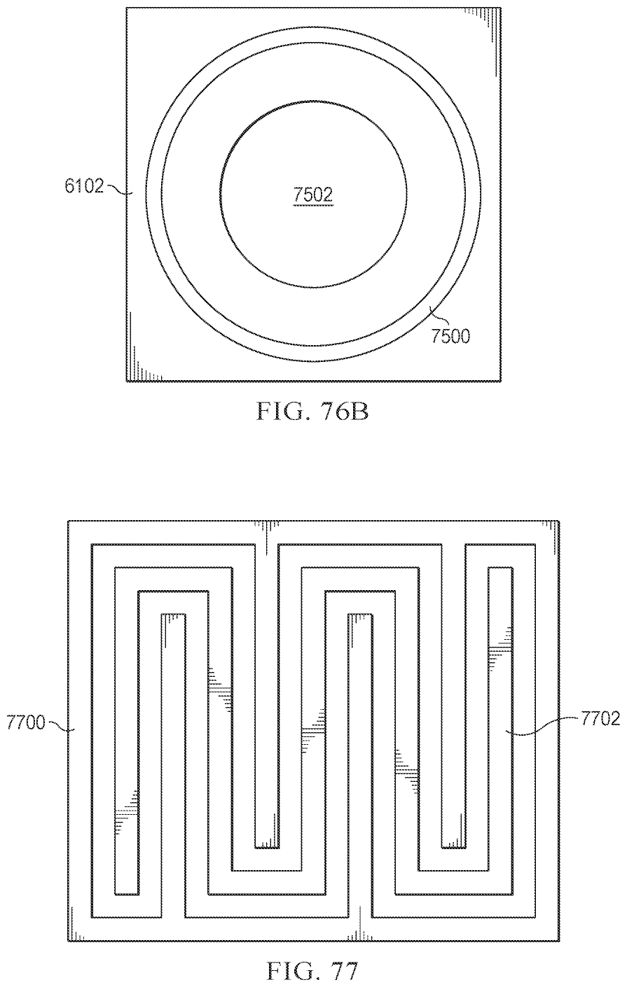

FIGS. 75A-75B, 76A-76B, and 77 depict example electrode configurations that may be useful to implement, for example, the structure of FIG. 74. The structure shown in FIGS. 75A-75B is the same as that shown in FIG. 65, except that the sensor 7502 is encircled by an electrode 7500. FIG. 75B shows a top-down view of the sensor and electrode combination, and the cross-sectional view of FIG. 75A shows the sensor 7502, but not the electrode 7500 encircling the sensor 7502. FIG. 76B is the same top-down view provided in FIG. 75B, but FIG. 76A also depicts a cross-sectional view that shows the electrode 7500 and not the sensor 7502.

Other electrode and sensor configurations are possible and included in the scope of this disclosure. For example, FIG. 77 is a top-down view of an electrode 7700 and a serpentine sensor 7702 interleaved with the electrode 7700. The electrode 7700 and sensor 7702 may be positioned within a BEOL and exposed to an interior of a reservoir (e.g., a main, detection, or reference reservoir).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

What is claimed is:

1. A packaged integrated circuit (IC) sensor comprising:
a semiconductor substrate;
a back end of line (BEOL) structure on the semiconductor substrate, the BEOL structure including multiple microfluidic channels, each microfluidic channel including a flow control device configured to selectively permit and restrict flow of fluids;
multiple fluid sensors including first and second fluid sensors in the BEOL structure;
a main reaction reservoir on the BEOL structure configured to store a reagent, in which the reagent is operable to replicate a nucleic strand in a biological sample to cause a pH change, and the first fluid sensor is exposed in the main reaction reservoir;
an auxiliary reservoir on the BEOL structure and coupled to the main reaction reservoir via a microfluid channel of the multiple microfluidic channels, in which the second fluid sensor is exposed in the auxiliary reaction reservoir; and
a controller coupled to the first and second fluid sensors.

2. The packaged IC sensor of claim 1, wherein the reagent is a first reagent, the multiple fluid sensors include a third fluid sensor, the auxiliary reaction reservoir is a first auxiliary reaction reservoir, and the packaged fluid sensor further comprises a second auxiliary reservoir on the BEOL structure coupled to the main reaction reservoir via a second microfluidic channel of the multiple microfluid channels, the second auxiliary reservoir is configured as a detection reservoir, the detection reservoir configured to store a second reagent operable to replicate genetic material of a detection target, and the third fluid sensor is exposed in the second auxiliary reservoir.

3. The packaged IC sensor of claim 2, wherein the detection reservoir is a first detection reservoir, the detection target is a first detection target, the multiple fluid sensors include a fourth fluid sensor, and the packaged IC sensor includes a third auxiliary reaction reservoir configured as a second detection reservoir on the BEOL structure coupled to the main reaction reservoir via a third microfluidic channel of the multiple microfluid channels, and the second detection reservoir is configured to store a third reagent operable to replicate genetic material of a second detection target, and the fourth fluid sensor is exposed in the second detection reservoir.

4. The packaged IC sensor of claim 3, wherein the first reagent includes the second and third reagents.

5. The packaged IC sensor of claim 2, wherein the main reaction reservoir is configured to receive the biological sample directly or via a cartridge, and the controller is configured to open a valve of the flow control device of the first microfluidic channel to transfer the biological sample to the detection reservoir after a reaction time has elapsed.

6. The packaged IC sensor of claim 1, wherein the controller is configured to close a valve of the flow control devices of the second microfluidic channel to prevent the biological sample from moving into the auxiliary reaction reservoir configured as a reference reservoir.

7. The packaged sensor of claim 1, wherein the controller is configured to provide an output based on a difference in a first signal provided by the first fluid sensor and a second signal provided by the second fluid sensor, the difference representing a pH difference.

8. The packaged sensor of claim 1, further comprising a heat exchanger thermally coupled to each of the main and first detection reservoirs.

9. The packaged sensor of claim 8, wherein the heat exchanger includes a metal member covered with an inert coating.

10. The packaged IC sensor of claim 1, wherein each of the multiple fluid sensors includes an ion-sensitive field-effect transistor (ISFET).

11. The packaged IC sensor of claim 1, wherein the flow control device includes at least one of a pump or a valve.

12. The packaged IC sensor of claim 1, further comprising a heating element configured to maintain the main reaction reservoir at a particular temperature.

13. The packaged IC sensor of claim 1, further comprising a cavity configured to carry fluids of differing temperatures, the fluids of differing temperatures to adjust a temperature of the biological sample stored in the main reaction reservoir.

14. The packaged IC sensor of claim 1, wherein the BEOL structure includes a heating element to apply heat to at least one of the main and reference reservoirs.

15. The packaged IC sensor of claim 14, wherein the heating element is configured to heat the at least one of the main and reference reservoirs by radiant heating.

16. The packaged IC sensor of claim 1, further comprising a cartridge to which the second reagent is coupled.

17. The packaged IC sensor of claim 1, further comprising a heating element configured to dynamically adjust a temperature of the biological sample.

18. The packaged IC sensor of claim 17, wherein the heating element includes a first conductive member inside the main reaction reservoir that is configured to be wirelessly energized by a second conductive member outside the main reaction reservoir.

19. The packaged IC sensor of claim 2, further comprising an electrode in the main reaction reservoir and in the detection reservoir, the electrode configured to provide electrical currents into the main reservoir and the detection reservoir to control pH levels of contents of the main reservoir and of the detection reservoir respectively.

20. The packaged IC sensor of claim 19, wherein the fluid sensor includes a pH sensor, and the electrode is configured to provide the electrical current into the main reaction reservoir responsive to a signal from the pH sensor.

21. The packaged IC sensor of claim 1, wherein the main and auxiliary reaction reservoir each includes a metal or a dielectric wall covered with an inert metal.

22. A method, comprising:
providing a fluid containing a biological sample to a main reaction reservoir of a packaged integrated circuit (IC) sensor, the biological sample including a nucleic strand, and the main reaction reservoir stores a first reagent;
allowing the fluid to flow from the main reaction reservoir to a first detection reservoir and a second detection reservoir of the packaged IC sensor, in which the first detection reservoir stores a second reagent to replicate nucleic strands of a first detection target, and the second detection reservoir stores a third reagent to replicate nucleic strands of a second detection target;
replicating the nucleic strand in the main reaction reservoir using the first reagent;
providing first and second portions of the replicated nucleic strands to the first and second detection reservoirs, respectively, by pumping;
replicating the first portion of the replicated nucleic strands in the first detection reservoir using the second reagent;
comparing pH levels of the first and second portions of the biological sample in the first and second detection reservoirs to a pH level of a reference reservoir of the packaged IC sensor; and
based on the comparisons, determining whether the biological sample contains the first detection target.

23. The method of claim 22, further comprising, after replicating the nucleic strand in the main reaction reservoir and before providing the first and second portions of the multiple nucleic strands to the first test and second detection reservoirs:
comparing pH levels of contents of the main and reference reservoirs and determining, based on the comparison, that the biological sample provided to the main reaction reservoir contains the first and second detection targets.

24. The method of claim 22, wherein replicating the nucleic strand in the main reaction reservoir comprises applying and removing heat from the nucleic strand.

25. The method of claim 22, wherein replicating the nucleic strand in the main reaction reservoir comprises passing a current through the main reaction reservoir using an electrode in the main reaction reservoir to increase a pH of the biological sample in the main reaction reservoir.

26. The method of claim 25, further comprising determining an amount of the current and, based on the amount of current, determining that the nucleic strand belongs to one of a group of targets.

27. A method comprising:
providing a fluid containing a biological sample to a main reaction reservoir of a packaged integrated circuit (IC) sensor, the biological sample including a nucleic strand, and the main reaction reservoir stores a first reagent;
allowing the fluid to flow from the main reaction reservoir to a reference reservoir;
replicating the nucleic strand in the main reaction reservoir using the first reagent;
determining a pH change in the main reaction reservoir;
responsive to the pH change exceeding a threshold, providing first and second portions of the replicated nucleic strands to the first and second detection reservoirs, respectively, by opening valves, in which the first detection reservoir stores a second reagent to replicate nucleic strands of a first detection target, and the second detection reservoir stores a third reagent to replicate nucleic strands of a second detection target;
replicating the first portion of the replicated nucleic strands in the first detection reservoir using the second reagent;
comparing pH levels of the first and second portions of the biological sample in the first and second detection reservoirs to a pH level of the reference reservoir; and
based on the comparisons, determining whether the biological sample contains the first detection target.

28. A method, comprising:
forming a semiconductor substrate;
forming a back end of line (BEOL) on the semiconductor substrate, the BEOL including a microfluidic channel, the microfluidic channel having first and second openings that extend through the BEOL and away from the semiconductor substrate; and
forming a fluidic structure on the BEOL having a first cavity and a second cavity, the first cavity being directly over the first opening, and the second cavity being directly over the second opening, wherein the first and second cavities are configured to replicate nucleic strands using the first and second reagents, respectively.

29. The method of claim 28, wherein forming the fluidic structure includes:
forming first and second walls on the BEOL, the first and second walls defining the first and second cavities, respectively; and
positioning an insulative material on the BEOL and contacting the first and second walls.

30. The method of claim 29, wherein the first and second walls are made of a metal or a dielectric material.

31. The method of claim 29, further comprising:
coupling a cartridge to the first and second walls and the insulative material, the cartridge including a third cavity in vertical alignment with the first cavity and a fourth cavity in vertical alignment with the second cavity, the cartridge further including a channel in fluidic communication with the fourth cavity.

32. The method of claim 28, wherein forming the fluidic structure includes coupling a cartridge having the first and second cavities to the BEOL.
